(19) United States
(12) Patent Application Publication
(10) Pub. No.: US 2004/0181783 A1
(43) Pub. Date: Sep. 16, 2004

(54) Transformation apparatus, transformation method, transformation programs, and computer readable recording medium having the transformation program stored therein

(76) Inventors: Morio Nagata, Kanagawa (JP); Ritsuko Nagata, Yokohama-shi (JP); Katsuomi Uota, Kanagawa (JP); Yoshinori Kajio, Kanagawa (JP)

Correspondence Address: BIRCH STEWART KOLASCH & BIRCH, PO BOX 747, FALLS CHURCH, VA, 22040-0747, US

(21) Appl. No.: 10/659,338

(22) Filed: Sep. 11, 2003

(30) Foreign Application Priority Data
Sep. 25, 2002 (JP) 2002-278362

(51) Int. Cl. G06F 9/45; G06F 9/46

(52) U.S. Cl. 717/137; 719/310

(57) ABSTRACT

The present invention aims to transform an existing program into a structure suitable to new technology software. An inputting unit 1100 inputs a COBOL program 100 and stores in a memory unit 1800. A dividing unit 1200 decomposes the COBOL program 100 into plural blocks of programs, and a syntax analyzing unit 1300 analyzes syntaxes of each of the decomposed programs. A program judging unit 1400 judges a role of each program, and a section judging unit 1500 judges contents and roles of sections within each program. After these operations, an extracting/transforming unit 3100 extracts/transforms data to generate a final program 300, and as a result, a transformation apparatus is provided, which automatically transforms the source code of the COBOL program 100 into the source code of the final program 300.

### TECHNICAL FIELD

The present invention relates to a program transformation apparatus and a method.

### BACKGROUND ART

Conventionally, there have been trials to transform a COBOL program for batch processing into a client/server modeled COBOL program using technique such as CORBA, COM almost by hand (for instance, refer to non-patent document 1 (NEC Solutions, Open COBOL Factory 21/ObjectPartner Pro, [retrieved on Jul. 12, 2002], Internet <URL: http://www.sw.nec.co.jp/cced/ocf21/objptnpro/seihin.html>)).

FIG. 78 is a diagram showing a conventional operation for transforming a series of COBOL program into a client/server modeled COBOL program using techniques such as CORBA, COM. This transformation result, which is the client/server modeled but is a conventional COBOL program, is not an object-oriented COBOL program.

In such a case, a COBOL program 100, which has been coded using a method of conventional COBOL language, is transformed into a client/server modeled program. First, a human understands the contents of source codes written in a series of the COBOL program 100. Then, the human has to decompose the COBOL program 100 into individual programs, each of which has certain contents. Further, an interface should be written by an interface definition language (IDL) for collaborating with the individual programs decomposed and CORBA or COM, which also requires manpower. The non-patent document 1 automates a part of the IDL composition.

In this way, the transformation process for generating source code of a final program 300 from the source code of the COBOL program 100 is not automated conventionally, or a part of the process is automated, but some part should be performed manually, so that it has been desired to have a transformation method which reduces manual operation. Namely, it has been desired to have an automated transformation apparatus and a method without manpower operation that makes the resource, namely, the COBOL program 100, which has been used in a mainframe apparatus 4000, applicable to the client/server system (distributed system).

Further, considering that recent status of request from information system is changing from centralized processing to distributed processing, it is further desired to obtain a method to reuse business logic, which has been composed by the COBOL program.

The present invention aims to transform an existing program into a new structure suitable for software of new technology.

### DISCLOSURE OF THE INVENTION

A transformation apparatus of the present invention includes:

a memory unit for storing a program for batch processing in a form of source code;

a section judging unit for dividing the source code of the program stored in the memory unit into at least one block of process, each block of process being identified as a section, and judging a role of the section as semantic information of each section; and

an extracting/transforming unit for extracting transformation information for source code transformation from the source code of the program stored in the memory unit based on the semantic information of each section judged by the section judging unit, and transforming the source code of the program into source code of a transformation result program including the source code of a transformation result program for a client and the source code of the transformation result program for a server based on the transformation information extracted.

The extracting/transforming unit transforms the source codes of the two transformation result programs into source codes of an object-oriented program.

The extracting/transforming unit creates plural templates of the object-oriented program, which correspond to plural classes having a predetermined data structure and procedure, extracts plural pieces of information including the predetermined data structure and procedure from the source codes of the two transformation result programs, and transforms the source codes of the two transformation result programs into the source codes of plural object-oriented programs by applying each of the plural pieces of information extracted to a corresponding part of the plural templates.

A transformation apparatus of the present invention includes:

a memory unit for storing a program for batch processing in a form of source code;

a section judging unit for dividing the source code of the program stored in the memory unit into at least one block of process, each block of process being identified as a section, and judging a role of each section as semantic information of each section, and the transformation apparatus creates plural templates of an object-oriented programs, which correspond to plural classes, each of which having a predetermined data structure and procedure, extracts plural pieces information including the predetermined data structure and procedure from the source code of the program for batch processing stored in the memory unit based on the semantic information of each section judged by the section judging unit, and transforms the source code of the program stored in the memory unit by applying each of the plural pieces of information extracted to a corresponding part of the plural templates.

The transformation apparatus further includes a program judging unit for judging a role of the source code of the program stored in the memory unit as semantic information of the program, and

the extracting/transforming unit extracts transformation information for transforming the source code of the program from the source code of the program based on the semantic information of the program judged by the program judging unit and the semantic information of each section judged by the section judging unit.

The transformation apparatus further includes a syntax analyzing unit for analyzing syntax of the program stored in the memory unit, and

the section judging unit judges the semantic information of each section included in the program, the syntax of which is analyzed by the syntax analyzing unit.

The transformation apparatus transforms source code of a COBOL program for batch processing.

A transformation method of the present invention includes:

storing a program for batch processing in a form of source code;

dividing the source code of the program stored into at least one block of process, each block of process being identified as a section, and judging a role of each section as semantic information of each section; and

extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

A transformation program of the present invention makes a computer perform processes of:

storing a program for batch processing in a form of source code;

dividing the source code of the program stored into at least one block of process, each block of process being identified as a section, and judging a role of each section as semantic information of each section; and

extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

A computer readable recording medium storing a transformation program of the present invention makes a computer perform processes of:

storing a program for batch processing in a form of source code;

dividing the source code of the program stored into at least one block of process, each block of process being identified as a section, and judging a role of each section as semantic information of each section; and

extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

A transformation apparatus of the present invention includes:

a first transformation unit for inputting program source code of a procedural off-line batch processing and transforming the program source code into a program for on-line real-time processing; and

a second transformation unit for further transforming the program for on-line real-time processing into a Web program which works in client/server environment.

The first transformation unit inputs the program source code for the off-line batch processing, naming rules of data, and coding rules of procedures and transforms the program source code into two kinds of class programs including a client side class and a server side class for the on-line real-time processing; and

the second transformation unit inputs the two kinds of class programs and generates source program of an object-oriented program.

The second transformation unit transforms the client side class into three kinds of class programs including a model class, a view class, and a controller class and transforms the server side class into two kinds of class programs including a session class and an entity class.

The first transformation unit includes preprocessing of meaning assignment for referring to definition of data in the source code of the program, judging definition of a master file and definition of a transaction file, detecting a role of the program and roles of components of the program among a series of processes, and appending labels which show the roles of the program and the roles of the components of the program among a series of processes.

The first transformation unit executes a transformation 1 program, the second transformation unit executes a transformation 2 program,

the programs for the off-line batch processing is classified to plural categories,

the transformation 1 program and the transformation 2 program are generated corresponding to each of the plural categories of the program for the off-line batch processing, and

the first transformation unit and the second transformation unit respectively execute the transformation 1 program and the transformation 2 program generated corresponding to the each of the plural categories of the program for the off-line batch processing.

A transformation method of the present invention includes:

inputting program source code of a procedural off-line batch processing;

transforming the program source code into a program for on-line real-time processing; and

transforming the program for on-line real-time processing into a Web program which works in client/server environment.

### BRIEF EXPLANATION OF THE DRAWINGS

FIG. 1 shows an example of a program transformation method.

FIG. 2 shows a diagram in which off-line batch processing is transformed into on-line real-time processing.

FIG. 3 shows a diagram in which off-line batch processing is transformed into on-line real-time processing.

FIG. 4 shows an internal configuration of a transformation apparatus A 1000.

FIG. 5 shows an operation for obtaining an intermediate program 200 from a COBOL program 100.

FIG. 6 shows an example of the COBOL program 100.

FIG. 7 shows a flowchart for dividing the COBOL program 100.

FIG. 8 shows a flowchart for checking a role of each program.

FIG. 9 shows a configuration of a section of an input checking program 102.

FIG. 10 shows a flowchart for checking a role of each section.

FIG. 11 shows a configuration of sections of a matching program 107.

FIG. 12 shows a flowchart for judging a role of each section.

FIG. 13 shows a mapping diagram of the input checking program 102 and a result output program 109 and an interface class 210.

FIG. 14 shows a mapping diagram of the matching program 107 and a sort program 104 and a file class 220.

FIG. 15 shows a detail of extraction/transformation of a program.

FIG. 16 shows a detail of extraction/transformation of a program.

FIG. 17 shows a part of the input checking program 102.

FIG. 18 shows a part of the interface class 210.

FIG. 19 shows a part of the input checking program 102.

FIG. 20 shows a part of the interface class 210.

FIG. 21 shows the input checking program 102.

FIG. 22 shows the interface class 210.

FIG. 23 shows the interface class 210.

FIG. 24 shows the result output program 109.

FIG. 25 shows the result output program 109.

FIG. 26 shows a detail of extraction/transformation of a program.

FIG. 27 shows a detail of extraction/transformation of a program.

FIG. 28 shows a detail of extraction/transformation of a program.

FIG. 29 shows the matching program 107.

FIG. 30 shows the matching program 107.

FIG. 31 shows the matching program 107.

FIG. 32 shows the sort program 104.

FIG. 33 shows a program of the file class 220.

FIG. 34 shows a program of the file class 220.

FIG. 35 shows an internal configuration of a transformation apparatus B 2000.

FIG. 36 shows a diagram in which on-line real-time processing is transformed into another on-line real-time processing that is more object-oriented.

FIG. 37 shows a mapping diagram of the interface class 210 and three classes.

FIG. 38 shows a detail of extraction/transformation of a program.

FIG. 39 shows a detail of extraction/transformation of a program.

FIG. 40 shows a detail of extraction/transformation of a program.

FIG. 41 shows a program of a view class 310.

FIG. 42 shows a program of the view class 310.

FIG. 43 shows a program of a controller class 320.

FIG. 44 shows a program of a model class 330.

FIG. 45 shows a program of the model class 330.

FIG. 46 shows a mapping diagram of a file class 220 and two classes.

FIG. 47 shows a detail of extraction/transformation of the program.

FIG. 48 shows a detail of extraction/transformation of the program.

FIG. 49 shows a program of a session class 340.

FIG. 50 shows a program of the session class 340.

FIG. 51 shows a program of an entity class 350.

FIG. 52 shows a program of the entity class 350.

FIG. 53 shows a program of the entity class 350.

FIG. 54 shows another example of the program transformation method.

FIG. 55 shows an internal configuration of a transformation apparatus C 3000.

FIG. 56 shows basic configuration of three computers for the transformation apparatus A, the transformation apparatus B, and the transformation apparatus C.

FIG. 57 shows a transformation method of an experimental example and a conventional transformation method.

FIG. 58 shows transformation of processing system from on-line batch processing into on-line real-time processing according to the experimental example.

FIG. 59 shows correspondence of two-step transformation with a program, which has been examined using a sample according to the experimental example.

FIG. 60 shows a correspondence with a client side class 210 according to the experimental example.

FIG. 61 shows a correspondence with a server side class 220 according to the experimental example.

FIG. 62 shows decomposition into View, Controller, Model classes 310, 320, and 330 according to the experimental example.

FIG. 63 shows decomposition into Session and Entity classes 340 and 350 according to the experimental example.

FIG. 64 shows summarization processing of a current summarization/output program 901 according to the experimental example.

FIG. 65 shows summarization processing of a summarization/output program 901a, which has been transformed as the on-line real-time method according to the experimental example.

FIG. 66 is a flow showing a summarization processing of the current summarization/output program 901 according to the experimental example.

FIG. 67 is a flow showing a summarization processing of the summarization/output program 901a, which has been transformed as the on-line real-time method according to the experimental example.

FIG. 68 is a diagram showing transformation of the source code of the summarization/output program 901 into the source code of the summarization/output program 901a by removing break check according to the experimental example.

FIG. 69 shows a transformation strategy of a record format change program 902 according to the experimental example.

FIG. 70 shows a transformation of procedure from the current record format change program 902 to a record format change program 902a transformed according to the experimental example.

FIG. 71 shows a diagram showing transformation of the source code of the record format change program 902 into the source code of the record format change program 902a by removing repeating instruction according to the experimental example.

FIG. 72 shows a process of a current output instruction data generation program 903a according to the experimental example.

FIG. 73 shows a process of an output instruction data generation program 903a transformed according to the experimental example.

FIG. 74 shows a transformation of procedure from the current output instruction data generation program 903 to the output instruction data generation 903a transformed according to the experimental example.

FIG. 75 shows a separation of procedure of the summarization processing of the on-line real-time method (the summarization/output program 901a transformed) shown in FIG. 67 to a C/S classes 210 and 220 according to the experimental example.

FIG. 76 shows a separation of the C/S classes 210 and 220 shown in FIG. 75 into five summarization processing 310, 320, 330, 340, and 350 according to the experimental example.

FIG. 77 shows a changing rate of the number of lines caused by changing from the batch processing to the on-line real-time processing according to the experimental example.

FIG. 78 shows a conventional method.

### PREFERRED EMBODIMENTS FOR CARRYING OUT THE INVENTION

Embodiment 1.

In the present embodiment, an apparatus and a method will be explained, which transform source code of existing resource, namely, a COBOL program 100 into source code of an intermediate program 200, and further to source code of a final program 300.

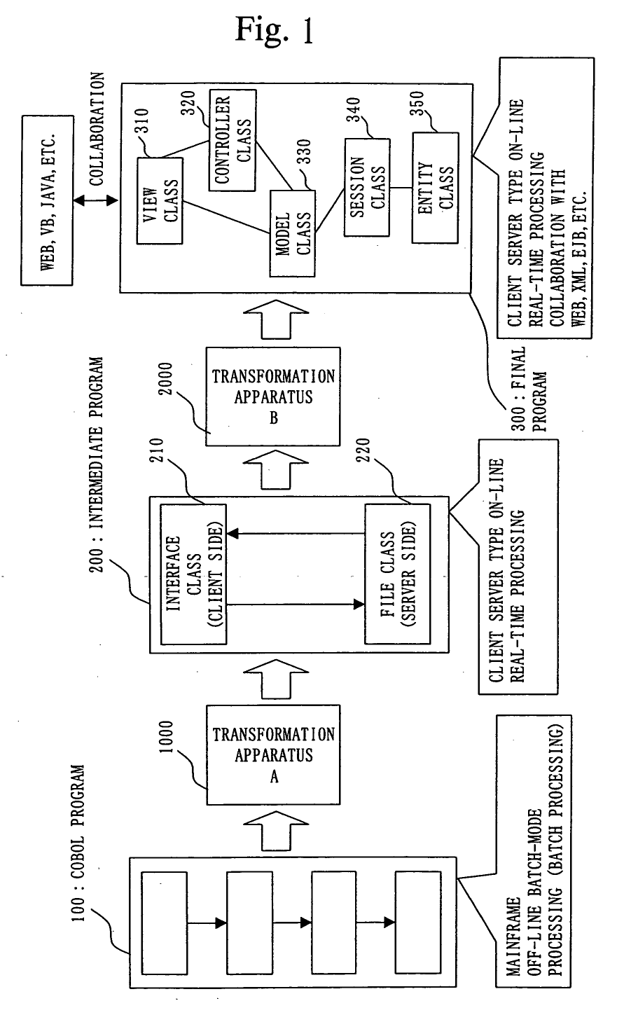

FIG. 1 shows an example of a program transformation method according to the embodiment. A COBOL program 100 is a program written by COBOL language that runs in an environment of centralized processing, off-line processing, and gathered processing (batch processing) in mainframe. The source code of this program is transformed into source code of an intermediate program 200 using a transformation apparatus A 1000.

The intermediate program 200 is an object-oriented program that runs in environment of distributed processing, on-line processing, and on-line real-time processing in the client/server system. The intermediate program 200 includes an interface class 210 and a file class 220. The interface class 210 is a program to be processed by client and is an example of transformation result program for the client. The file class 220 is a program to be processed by server and is an example of transformation result program for the server. In this way, by separating the COBOL program 100 into the interface class 210 and the file class 220, it is possible to utilize the COBOL program 100, which operates on the mainframe, in a system that cooperates the client and the server connected with network.

An object means a one, having data (properties) and procedures (methods) associated, which represents an existence in the object domain of the outside world. A class means abstracted definition of a group of the objects.

The source code of the intermediate program 200 is further transformed into source code of a final program 300 by a transformation apparatus B 2000. The final program 300 is an example of the object-oriented program that can cooperate with WEB, VB, or Java (registered trademark), etc. The final program 300 is more object-oriented than the intermediate program 200. Further, the final program 300 is a program including a view class 310, a controller class 320, a model class 330, a session class 340, and an entity class 350.

As described, by transforming the source code of the existing COBOL program 100 into the source code of the object-oriented program, it is possible to run the transformed program on a distribution system constructed on the network such as the Internet. Accordingly, the existing program can be effectively utilized.

First, a method by which the transformation apparatus A 1000 transforms the source code of the COBOL program 100 into the source code of the intermediate program 200 will be explained.

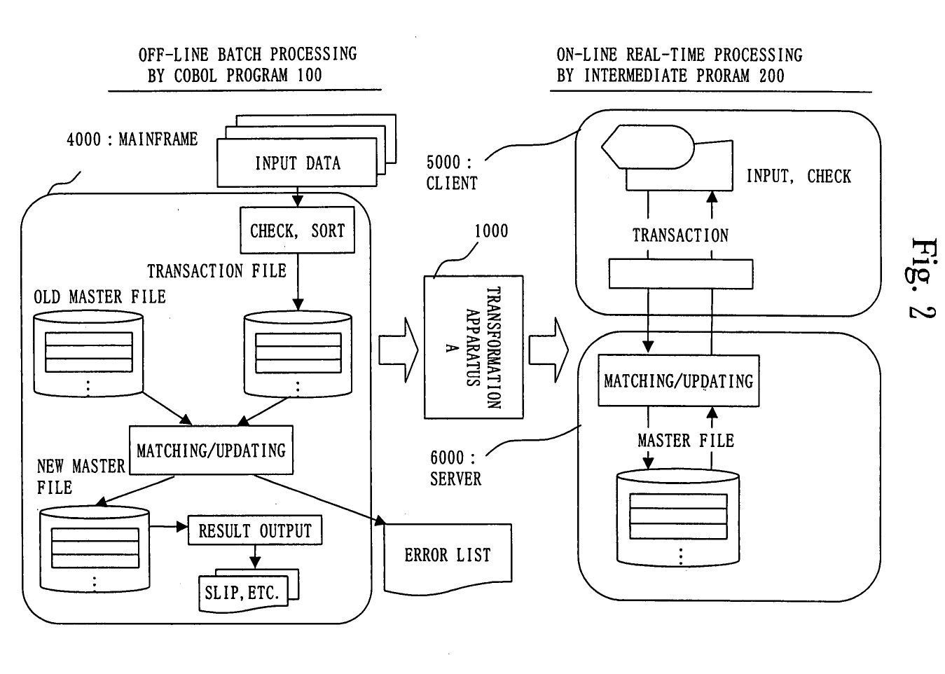

FIG. 2 shows an example of transformation by the transformation apparatus A 1000 from off-line batch processing by the COBOL program 100 to on-line real-time processing by the intermediate program 200.

In the batch processing of the left side, the mainframe checks plural pieces of input data, sorts them, generates a transaction file, and then, performs matching and updating an old master file, outputs a new master file, and outputs an error list, if necessary. The transformation apparatus A 1000, in this way, transforms the source code of the program so that the off-line batch processing by the COBOL program 100 is changed so as to become suitable to the on-line real-time processing by the client/server system. Namely, the client side inputs data, checks the input data, and sends the input data to the server as the transaction. The server matches the transaction sent by the client with the master file, updates the master file, and transfers the result to the client.

In this way, the transformation apparatus A 1000 transforms the source code of the COBOL program 100 into the source code of the intermediate program 200, which enables the on-line real-time processing.

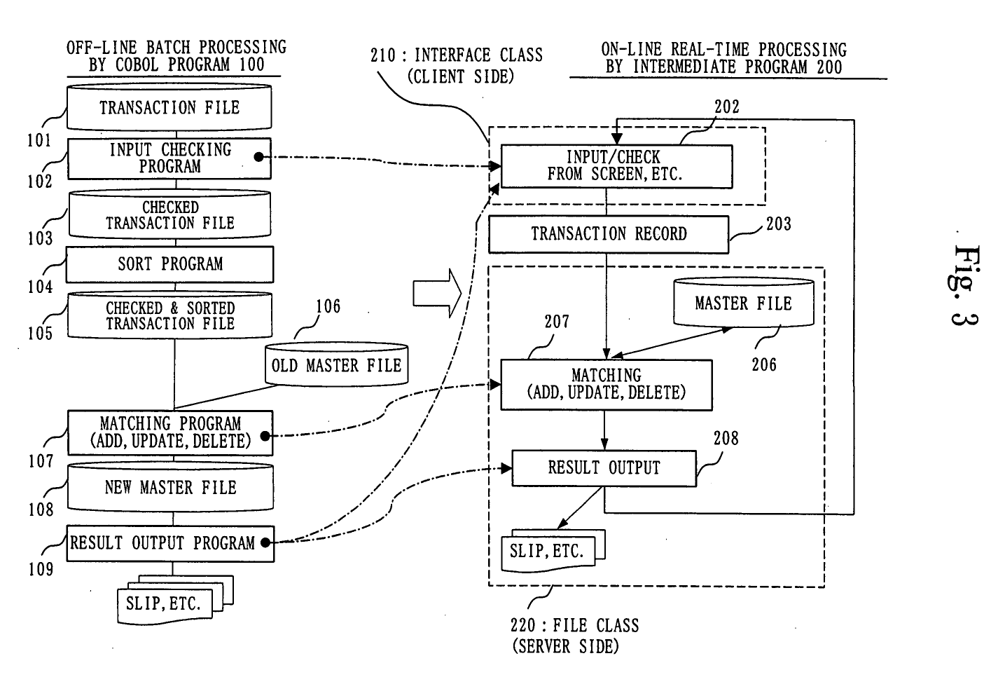

Next, the method will be explained in detail by referring to FIG. 3, in which the on-line real-time processing is made possible by transforming the COBOL program 100, which performs the off-line batch processing of the transaction such as adding, updating, and deleting the data by the COBOL program, into the intermediate program 200.

The left side of FIG. 3 shows the off-line batch processing by the COBOL program 100, and the right side shows the on-line real-time processing by the intermediate program 200.

First, an input checking program 102 inputs and checks records of a transaction file 101, and generates a checked transaction file 103. The source code of the input checking program 102, which describes the contents of the above processing, is transformed by the transformation apparatus A 1000 into the source code of a program of the interface class 210.

The records of the checked transaction file 103 generated by the batch processing shown in the left side correspond to transaction record 203 shown in the right side.

Next, in the batch processing of the left side, the checked transaction file 103 is sorted by a sort program 104 and a checked and sorted transaction file 105 is generated. The sort processing is unnecessary for the processing of the right side. Because the processing shown in the right side is not batch processing, but is on-line real-time processing, so that the transaction record 203 directly becomes the record to be matched.

Next, in the batch processing of the left side, the checked and sorted transaction file 105 and an old master file 106 are matched by a matching program 107. As a result, a new master file 108 is obtained. Corresponding to this processing, in the on-line real-time processing of the right side, matching processing is performed (207) using the transaction record 203 and a master file 206. This matching processing is described in a file class 220 and performed by the server.

Finally, in the batch processing of the left side, a result output program 109 outputs the result of the matching processing. Corresponding to this processing, the on-line real-time processing shown in the right side outputs the result to the server (208).

Next, the transformation apparatus A 1000, which transforms the source code of the program for the batch processing shown in the left side into the program for the on-line real-time processing shown in the right side, will be explained.

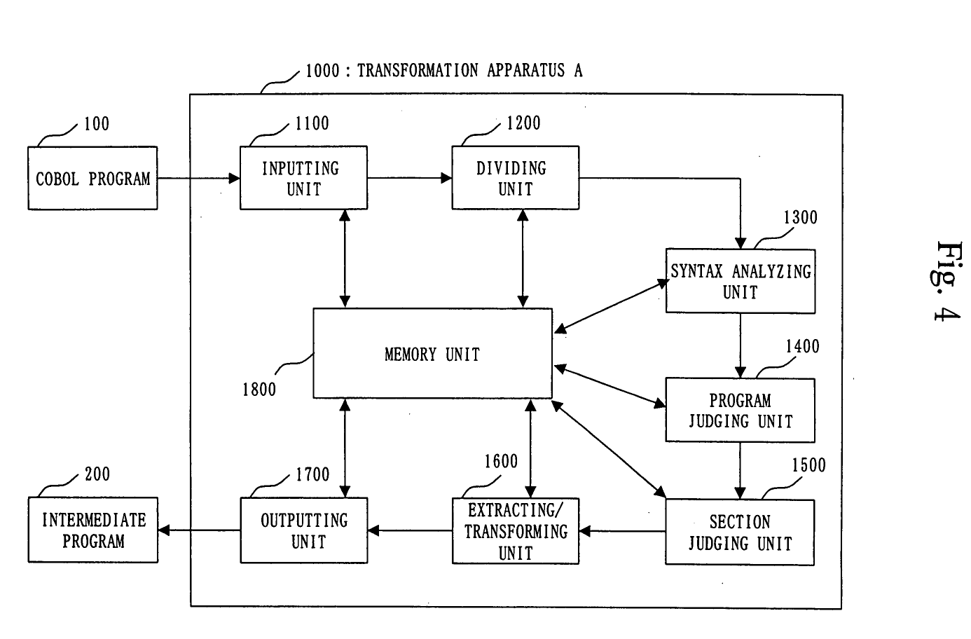

FIG. 4 shows an internal configuration and operation of the transformation apparatus A 1000 that transforms the source code of the COBOL program 100 into the source code of the intermediate program 200.

The transformation apparatus A 1000 includes an inputting unit 1100 for inputting the COBOL program 100 to be transformed, a dividing unit 1200 for dividing the program input by the inputting unit 1100 into multiple programs, a syntax analyzing unit 1300 for syntax analyzing each of the divided programs, a program judging unit 1400 for judging the contents of each program based on the syntax analyzed programs, a section judging unit 1500 for judging the contents of multiple sections within the each program judged by the program judging unit 1400, an extracting/transforming unit 1600 for extracting data necessary to transform the COBOL program 100 into the intermediate program 200 using the section judged by the section judging unit 1500 and for transforming the extracted data into the intermediate program 200, an outputting unit 1700 for outputting the transformed intermediate program 200, and a memory unit 1800 for storing the program, etc. input by the inputting unit 1100. The memory unit 1800 does not need to locate inside the transformation apparatus A 1000, but the memory unit 1800 can be an outside memory unit.

Next, the operation for transforming the source code of the COBOL program 100 into the source code of the intermediate program 200 using each of the internal configurations shown in FIG. 4 will be explained.

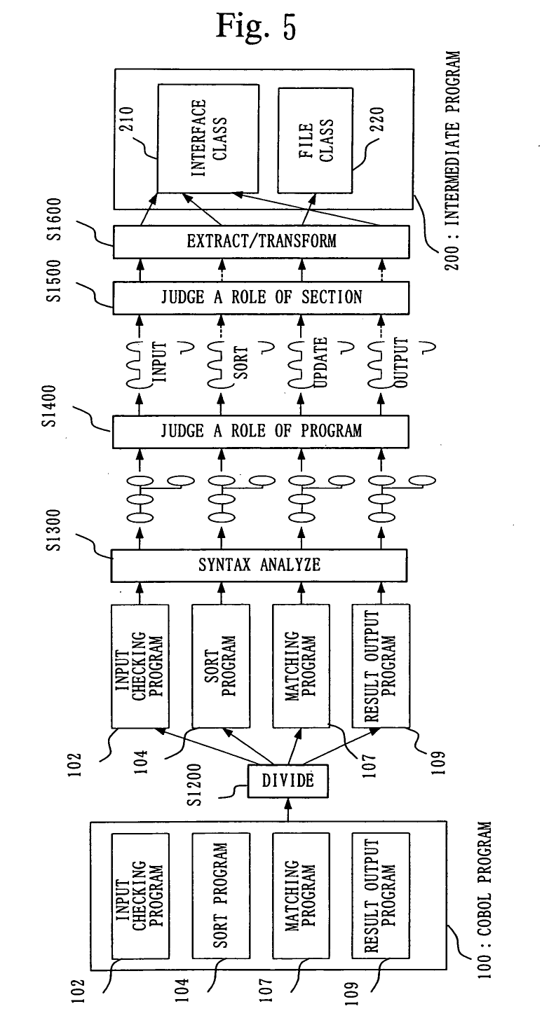

FIG. 5 shows the operation which proceeds from the left side to the right side; that is, which transforms the COBOL program 100 input by the left side and obtains the intermediate program 200 shown in the right side.

As has been discussed, the COBOL program 100 includes the input checking program 102 for inputting the transaction file 101 and checking the contents of the input, the sort program 104 for sorting the checked transaction record, the matching program 107 for matching the checked and sorted transaction file 105 with the old master file 106, and the result output program 109 for outputting the matched result. However, any one of the input checking program 102, the sort program 104, the matching program 107, and the result output program 109 can be omitted.

The inputting unit 1100 inputs the COBOL program 100.

Next, the dividing unit 1200 divides the input program, which unifies four programs, into four respective programs (S1200). If the COBOL program 100, however, is a single unified program, the dividing unit 1200 does not process anything.

Next, the syntax analyzing unit 1300 analyzes each syntax written in the four divided programs (S1300).

Then, the program judging unit 1400 judges a role of each program based on the syntax analysis performed by the syntax analyzing unit 1300 (S1400). As a result of the judgment, it is judged that the programs perform their roles, respectively; namely, the input checking program 102 inputs and checks the data, the sort program 104 sorts multiple records, the matching program 107 matches with the master file, and the result output program 109 outputs the matched result.

Next, the section judging unit 1500 judges a role of the section of each program judged by the program judging unit 1400 (S1500). Here, the section means each processing of one or multiple groups of processing divided from the program.

The extracting/transforming unit 1600 extracts data that is necessary for transforming the source code of the COBOL program 100 into the source code of the intermediate program 200 based on the role of each section judged by the section judging unit 1500, and transforms the extracted data so as to adapt to the intermediate program 200.

As a result, the intermediate program 200 including the interface class 210 and the file class 220 is generated and output by the outputting unit 1700.

Next, the operation of each unit of the transformation apparatus A 1000 will be explained.

First, the operation of the dividing unit 1200 will be discussed.

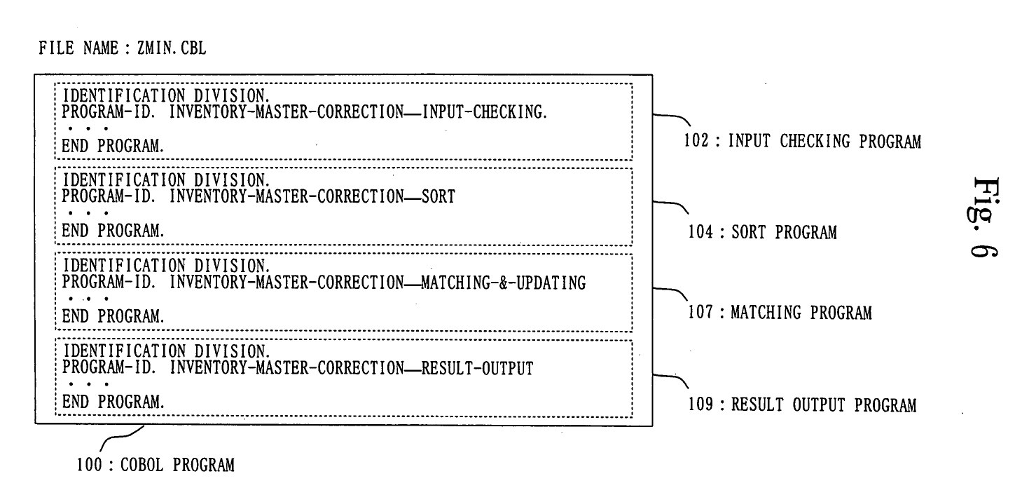

FIG. 6 shows one example of the COBOL program 100 input by the inputting unit 1100. Here, as described above, the COBOL program 100 is composed of four unified programs. The final line of each program includes “END PROGRAM.”

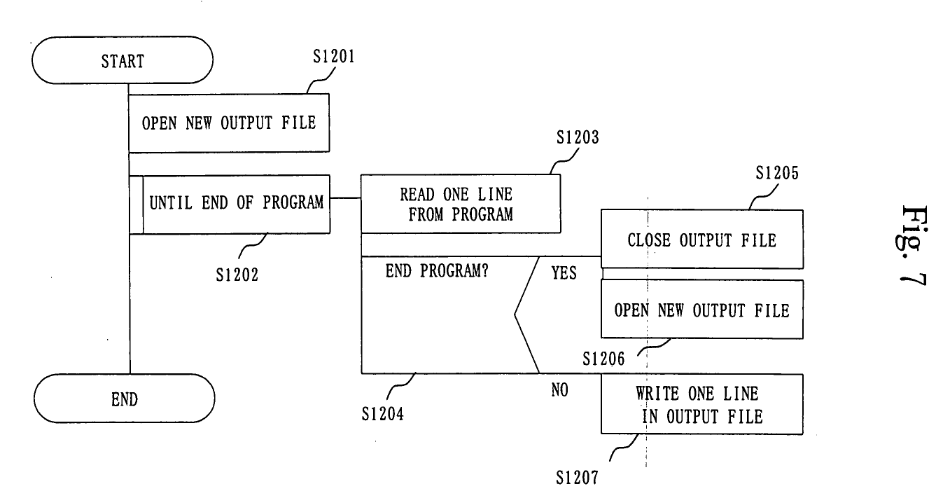

FIG. 7 shows a flowchart for dividing the COBOL program 100 shown in FIG. 6 into multiple unified programs. This flowchart is drawn by PAD (PROGRAM ANALYSIS DIAGRAM).

Here, it is judged as one program from a heading “IDENTIFICATION DIVISION.” written in the program shown in FIG. 6 to the next heading “END PROGRAM.”, and the programs are respectively stored in separate output files.

Namely, first, a new output file is opened (S1201), and the following procedure is repeated until the program ends (S1202).

One line of the program is read (S1203), it is checked if the line includes “END PROGRAM.” or not (S1204).

If “END PROGRAM.” is not included, the read one line is written in the output file (S1207).

If “END PROGRAM.” is included, it is judged the line is the final line of a certain unified program, the output file is closed (S1205), and a new output file is opened (S1206).

By repeating this process, for instance, the COBOL program 100 shown in FIG. 6 is divided into four programs (the input checking program 102, the sort program 104, the matching program 107, and the result output program 109).

In FIG. 7, the program is divided by checking if the heading “END PROGRAM.” is included, however, the program can be divided into multiple unified programs based on respective file names using the input file names.

It is not always necessary to provide the dividing unit 1200, and the syntax analyzing unit 1300 can perform syntax analysis directly based on the input program.

Next, the syntax analysis of the four programs divided by the dividing unit 1200 will be explained. The syntax analyzing unit 1300 performs syntax analysis of the divided programs, respectively. As a result, a parse tree can be obtained, which represents a hierarchical structure of each program.

To each node of the parse tree, syntactic and semantic information for instructions in the program is added. This operation of creating the parse tree is performed by the program judging unit 1400. Here, the node means a stored series of words that forms a minimum semantic unit in the program identified by the beginning of the instruction and the end of the instruction.

The program judging unit 1400 judges a role of each program such as checking input or matching based on a naming rule of each program and appends the judged role to each program as semantic information.

Here, the naming rule of program will be explained.

For names for programs, files, and data items within the program, the naming rules are previously defined according to coding conditions of each of the company. A program name includes a common name for a series of processing and names for identifying one of inputting, sorting, updating, and result outputting. Affixes are appended to file names, by which a role of each file can be identified.

To data item names, affixes are also appended as well as the file names to identify a role of the data item if it is data item of the file.

It is possible to add semantic information to each program based on these naming rules within the program.

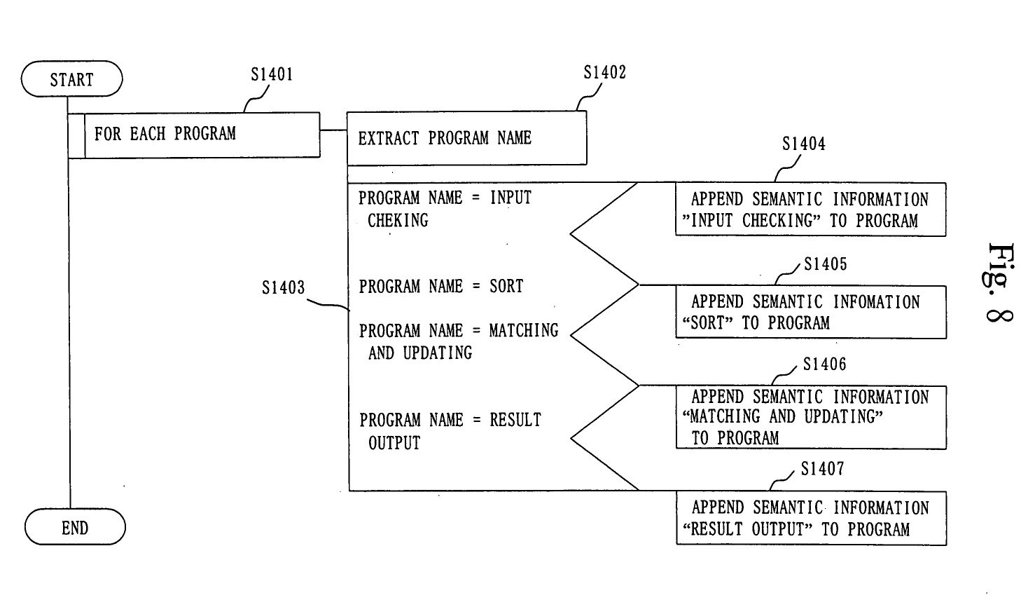

FIG. 8 shows a flowchart in which the program judging unit 1400 judges a role of each program based on the program names. This flow is performed by the program judging unit 1400.

First, the program judging unit 1400 extracts the program name (S1402) from each of the program, which has been syntax analyzed by the syntax analyzing unit 1300 (S1401).

If the program name is input checking, “input checking” is appended to the program as the semantic information (S1404).

If the program name is sort, “sort” is appended as the semantic information (S1405).

If the program name is matching and updating, “matching and updating” is appended to the program as the semantic information (S1406).

If the program name is result output, “result output” is appended to the program as the semantic information (S1407).

Next, a process, in which the section judging unit 1500 extracts each node of the parse tree of each program one by one to append the semantic information to the node, will be explained.

Each program is, as discussed above, structured by sections, each of which is a series of processing within the program.

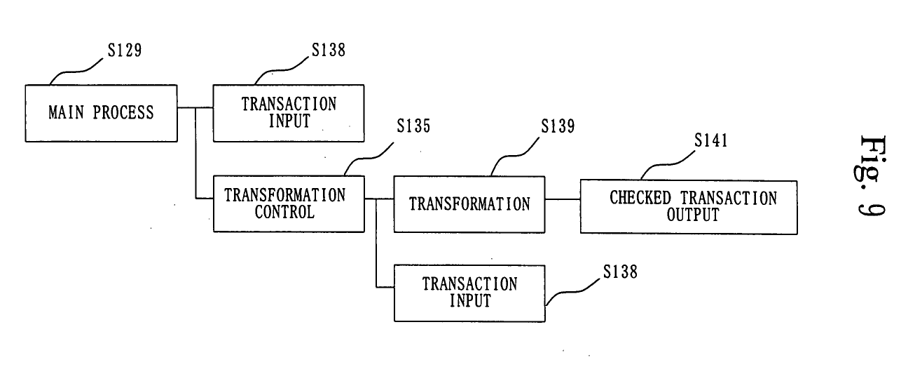

FIG. 9 shows a structure of each section of the input checking program 102. Each process enclosed by a rectangle corresponds to each section. In FIG. 9, the left section calls the right section.

A main process (S129) calls a transaction inputting process (S138) and a transformation controlling process (S135). The transaction inputting process is a process for reading records from the transaction file 101, and the transformation controlling process is a controlling process for repeating each process (transformation process, transaction inputting process) called by the transformation controlling process.

The repeating process performed by the transformation controlling process (S135) is performed by calling the transformation process (S139) and the transaction inputting process (S138). After the transformation process is performed, the section for the checked transaction outputting process (S141) performs a process for writing the checked transaction record in the file. The transformation process at S139 checks the transaction record and transfers the correct record to the outputting side.

In this way, the section judging unit 1500 judges a role of each section by the structure of the sections of the input checking program 102 shown in FIG. 9.

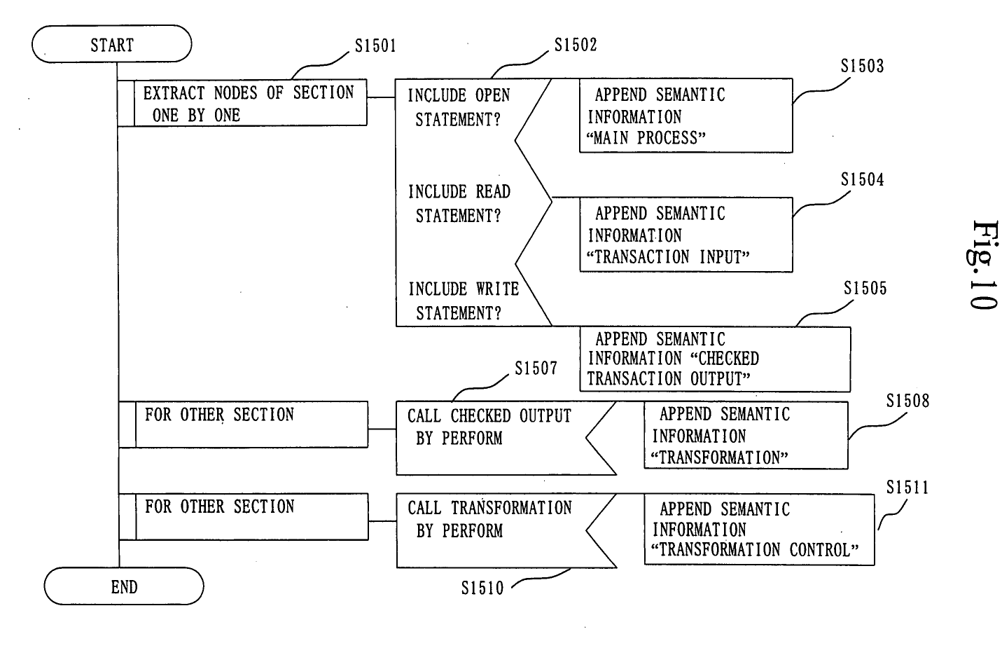

FIG. 10 shows a flowchart for judging a role of each section shown in FIG. 9 by the section judging unit 1500.

First, the section judging unit 1500 extracts nodes of the section one by one (S1501) and checks if OPEN statement, READ statement, or WRITE statement is included (S1502).

The section judging unit 1500 appends the semantic information “main process” to the section as the role of the section when the node corresponding to the section of the parse tree includes OPEN statement (S1503). The semantic information “transaction inputting” is appended as the role of the section when READ statement is included (S1504). The semantic information “checked transaction outputting” is appended as the role of the section when WRITE statement is included (S1505).

Next, the section judging unit 1500 checks if another section reads the checked output using PERFORM statement (S1507), and the semantic information “transformation process” is appended as the role of the section when the checked output is called (S1508).

The section judging unit 1500 checks if another section calls the transformation process using PERFORM statement (S1510), and the semantic information “transformation process controlling” is appended as the role of the section when the transformation process is called (S1511). In this way, the semantic information can be automatically appended as the role of each section.

In the following, a process in which the section judging unit 1500 judges the section and appends the semantic information to the matching program 107 will be explained.

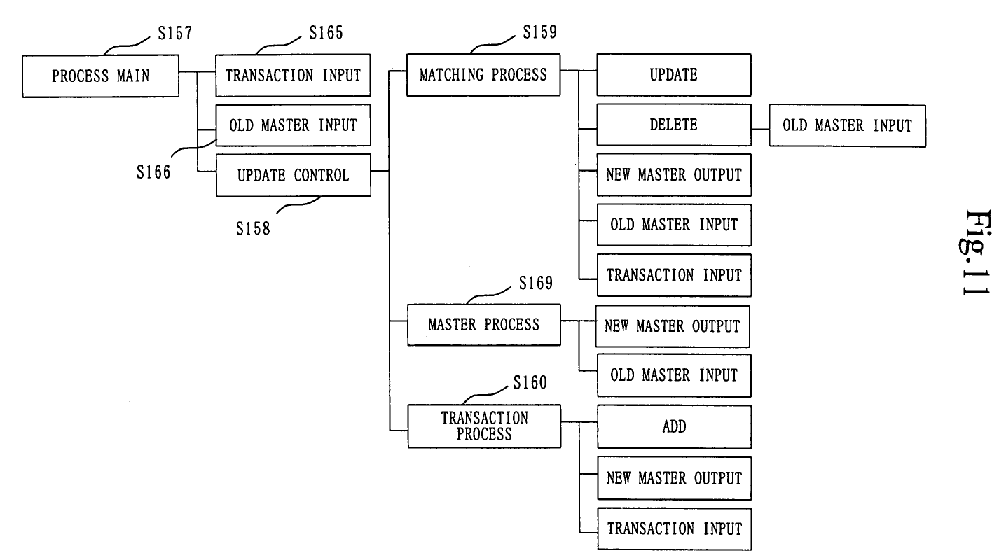

FIG. 11 shows a structure of sections of the matching program 107. As well as FIG. 9, a process enclosed by a rectangle represents a section, and the left process calls the right process. The main process (S157) inputs a transaction (S165), inputs an old master file (S166), and repeats an updating process by an update control based on the data. Namely, the update control performs a matching process of a transaction key and a master key (S159) and repeats the matching process (S159) based on a master process (S169) for preparing a next master record and a transaction process (S160) for preparing a next transaction record. The result is output to a new master file. In this way, since the matching program 107 has the structure of sections shown in FIG. 11, the section judging unit 1500 judges the role of each section from the structure of sections.

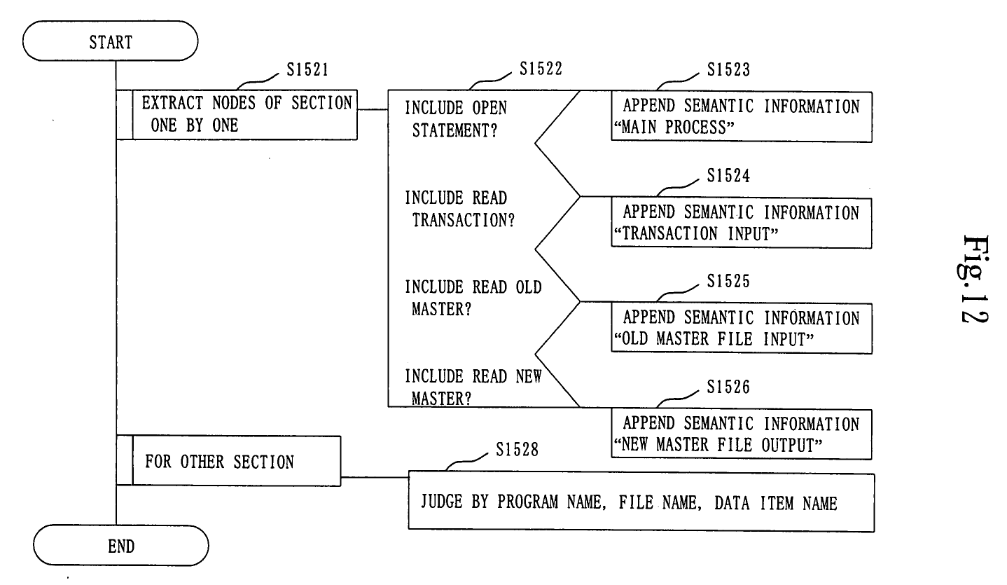

FIG. 12 shows a flowchart for judging the role of each section shown in FIG. 10 by the section judging unit 1500.

First, the section judging unit 1500 extracts the node of the parse tree corresponding to the section one by one (S1521) and checks if OPEN statement, READ statement of the transaction, READ statement of the old master file, or READ statement of the new master file is included (S1522). When OPEN statement is included, the semantic information “main process” is appended as the role of the section (S1523). When READ statement of the transaction is included, the semantic information “transaction input” is appended to the section (S1524). When READ statement of the old master file is included, the semantic information “old master file input” is appended to the section (S1525). When READ statement of the new master file is included, the semantic information “new master file output” is appended to the section (S1526).

Further, regarding to other sections, it is possible for the section judging unit 1500 to judge which record definition means either of the transaction file, the new master file, the old master file using the program name, the file name, and the data item name according to the naming rule within the program, which has been discussed above (S1528).

After the section judging unit 1500 judges the sections of the input checking program 102 and the matching program 107, the extracting/transforming unit 1600 extracts and transforms data necessary to generate the intermediate program 200 based on the judgement for each of the sections. In the following, an extraction/transformation process performed by the extracting/transforming unit 1600 will be explained.

First, it is necessary to create a method of each class in the intermediate program 200 as preprocessing. Here, the method means a concrete processing method (means).

The extracting/transforming unit 1600 creates two structures of the interface class 210 and the file class 220, which form the intermediate program 200, and appends the file name information to each class.

Further, in each of the two classes, methods which will be discussed in the following paragraphs are created and the contents of the methods are kept empty. The semantic information is appended to each method, so that each method can be identified when it is extracted or transformed later.

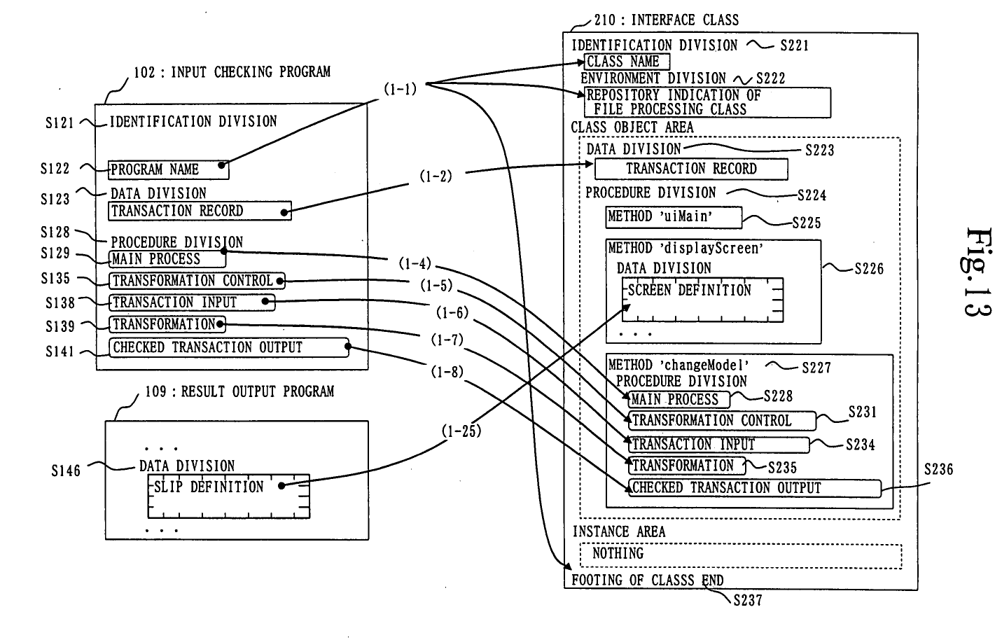

FIG. 13 is a mapping diagram of the input checking program 102 and the result output program 109 and the interface class 210.

FIG. 14 is a mapping diagram of the matching program 107 and the sort program 104 and the file class 220.

As shown in FIG. 13, the extracting/transforming unit 1600 previously creates a screen display inputting method (method: displayScreen), a UI main method (method: uiMain), and an input checking method (method: changeModel) in the interface class 210.

The extracting/transforming unit 1600 previously creates a matching and updating method (method: updateRecord) in the file class 220.

After the preprocessing, as shown in FIG. 13, the extracting/transforming unit 1600 performs an extraction/transformation process for extracting/transforming data from the input checking program 102 and the result output program 109 to generate the interface class 210 as a transformation result program for the client 5000. Further, as shown in FIG. 14, the extracting/transforming unit 1600 extracts and transforms the data from the matching program 107 and the sort program 104 and generates the file class 220 as a transformation result for the server 6000.

In the following, the extraction/transformation process performed by the extracting/transforming unit 1600 will be explained.

Extraction/Transformation Process From the Input Checking Program 102 and the Result Output Program 109 to the Interface Class 210

As shown in FIG. 13, the extracting/transforming unit 1600 makes a correspondence to create the interface class 210 from the input checking program 102 and the result output program 109.

The extracting/transforming unit 1600 extracts logic of the input checking from the input checking program 102 and makes correspondence with the interface class 210. Further, the extracting/transforming unit 1600 extracts a slip definition from the result output program 109 and makes correspondence with the interface class 210.

The extracting/transforming unit 1600 performs the extraction/transformation process based on the correspondence of three logic, which will be discussed below.

First, the input checking program 102 includes the logic for reading records from the transaction file 101; however, in the interface class 210, the logic has to be changed to that data has to be input from the screen and stored in a record format. Namely, the logic for reading records from the transaction file 101 becomes unnecessary. Accordingly, the logic for reading records from the transaction file 101, which is included in the input checking program 102, is ignored from the first correspondence.

Secondly, the input checking program 102 includes logic for checking data read from each record, and this logic has to be inherited to the interface class 210.

Thirdly, the input checking program 102 includes logic for writing the records in the transaction file 103 if the data is correct; however, this logic has to be changed into another logic for transferring the record to the file class 220 if the data is correct. Namely, if the data is correct, the logic for writing in the checked transaction file 103 becomes unnecessary. Accordingly, the definition part of the checked transaction file 103, which exists in the input checking program 102, and the logic for writing in the checked transaction file 103 are ignored from the third correspondence, and another logic is added for checking the record and transferring the record to the method of the file class 220 if the record is correct.

Further, the processing method is changed from the batch processing to the on-line real-time processing, so that the repeating logic for preparing the next record, which exists in the input checking program 102, is ignored.

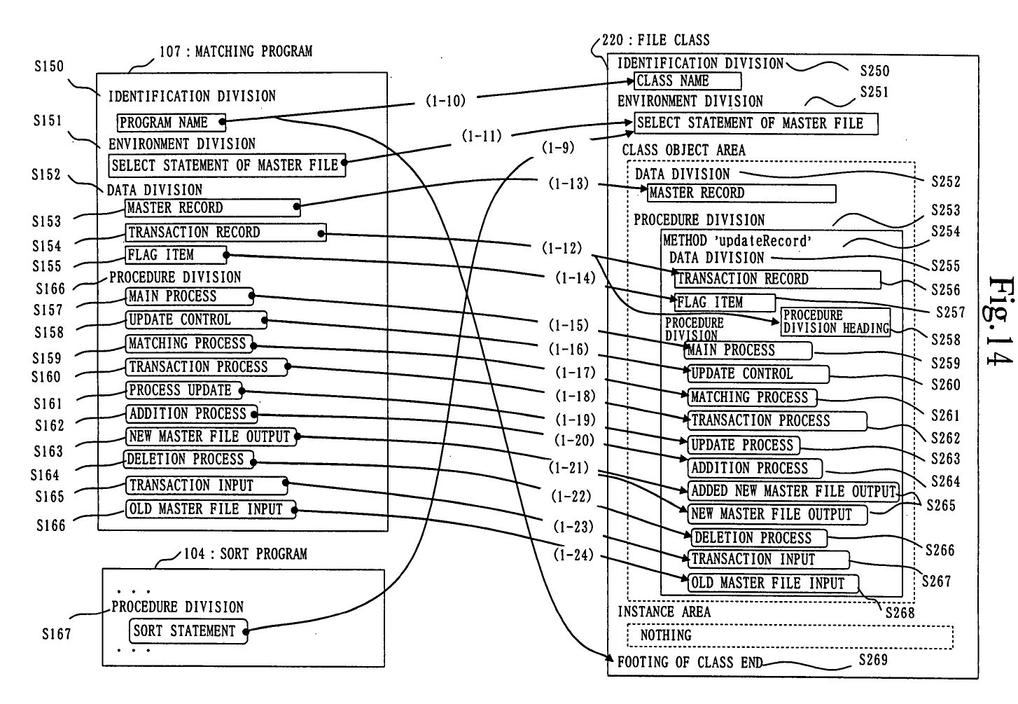

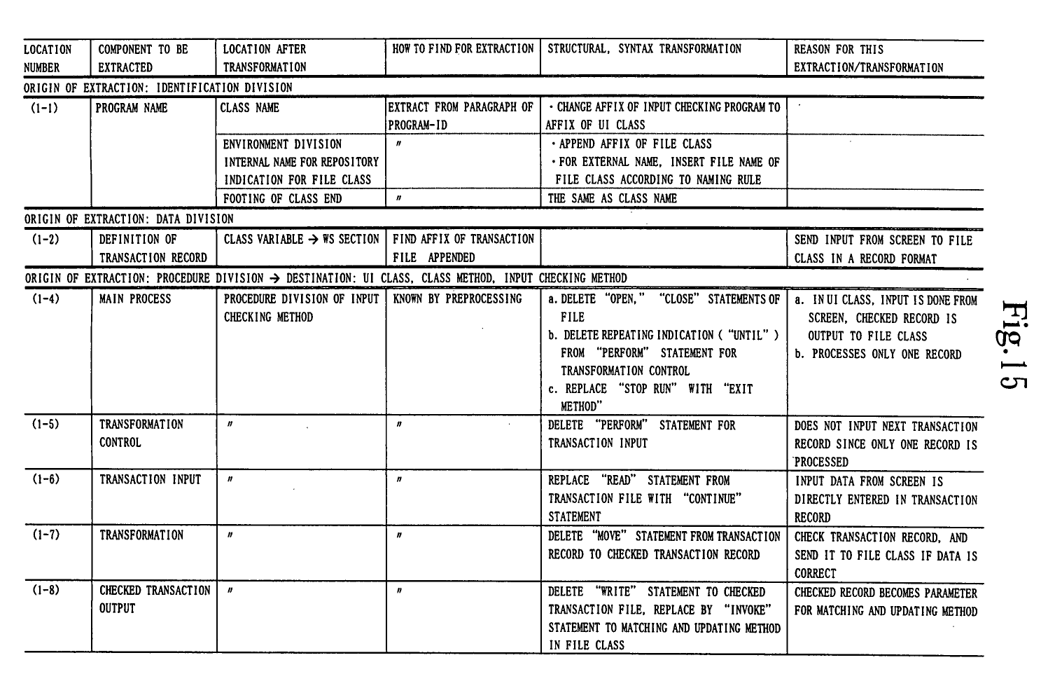

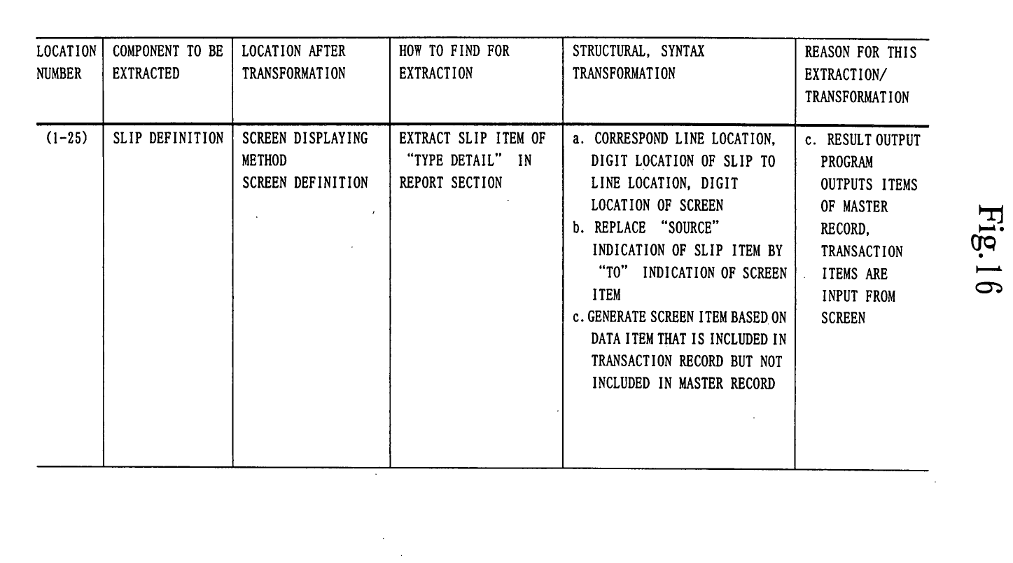

FIGS. 15 and 16 show a detail of the extraction/transformation of the program based on these correspondences. FIG. 15 explains a detail of the extraction/transformation from the input checking program 102 to the program of the interface class 210. FIG. 16 explains the extraction and the transformation from the result output program 109 to the program of the interface class 210. Location numbers shown in FIGS. 15 and 16 correspond to the correspondence numbers shown in FIGS. 13 and 14. Namely, when the program name written in the identification division of the input checking program 102 is extracted and transformed to the class name in the identification division of the interface class 210, repository indication to the file class 220 of the environment division, and the footing of class end, details of these operations are shown in the location number (1-1) of FIG. 15.

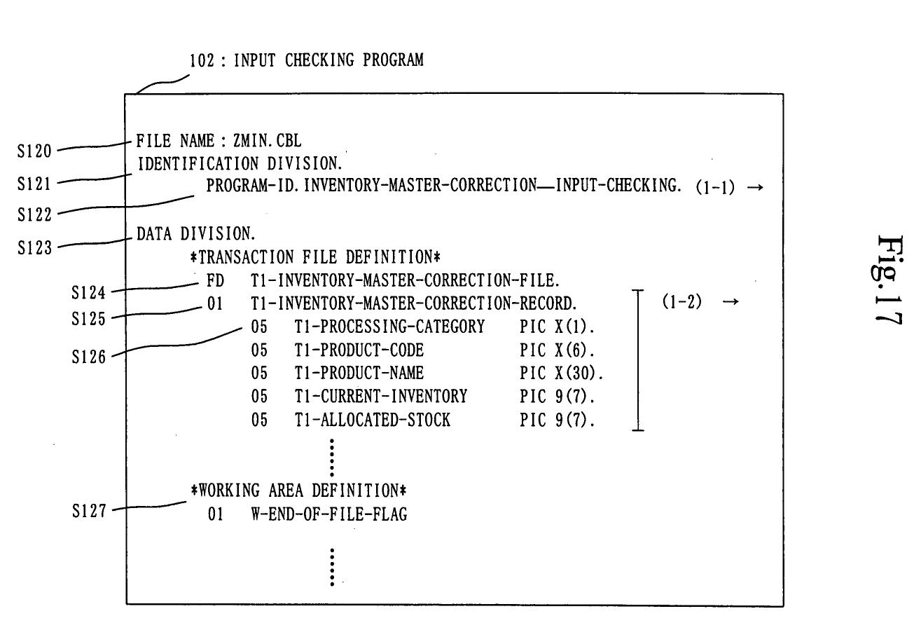

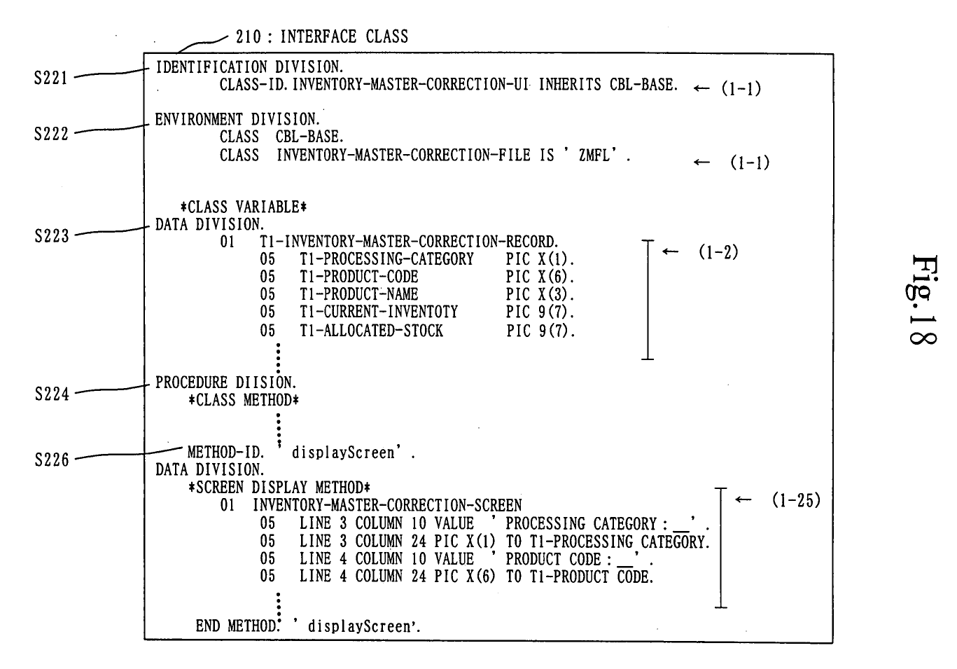

The details of the extraction/transformation will be explained referring to FIGS. 17 and 18.

FIG. 17 shows a part of the input checking program 102.

FIG. 18 shows a part of the interface class 210.

A step shown by the location number (1-1) of FIG. 17 is extracted and transformed into a step (1-1) of FIG. 18.

For more concrete explanation, “inventory master correction-input check” is extracted from the line of PROGRAM-ID (S1122) in the identification division (S121) of FIG. 17 and transformed into a class ID 1 “inventory master correction U1” in the identification division (S221) of the interface class 210 of FIG. 18.

An affix of the file class name is appended to “inventory master correction” extracted from the input checking program 102, as an internal name indicating repository for the file class 220 written in the environment division (S222) within the interface class 210, and a file name of the file class 220 is inserted as an external name according to the naming rules within the coding regulations of each company.

The heading showing the end of the class will be discussed later.

Next, a class variable of the interface class 210 is extracted and transformed according to the transaction file definition of the data division (S123) of the input checking program 102 shown in FIG. 17. Concretely, the class variable is extracted from the location number (1-2) shown in FIG. 17 and transformed into the location number (1-2) in the data division (S223) shown in FIG. 18. In this way, the record with the affix of the transaction file of the input checking program 102 is written as the class variable of the interface class 210, and the input from the screen can be sent to the file class 220 in a form of record.

Next, the extraction/transformation process for creating the input checking method from a procedure division of the input checking program 102 will be explained.

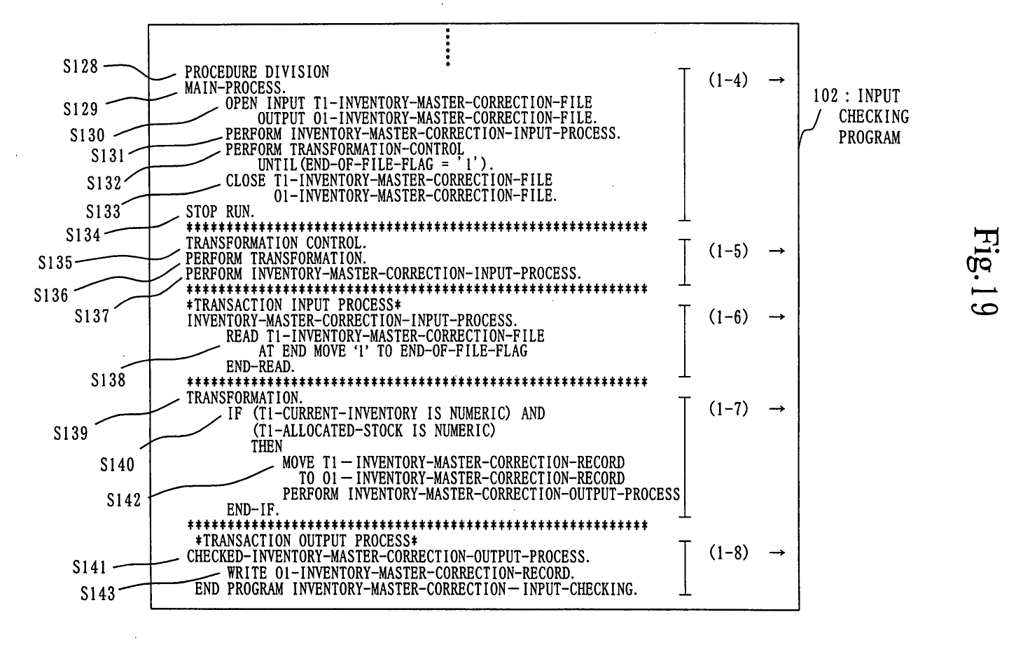

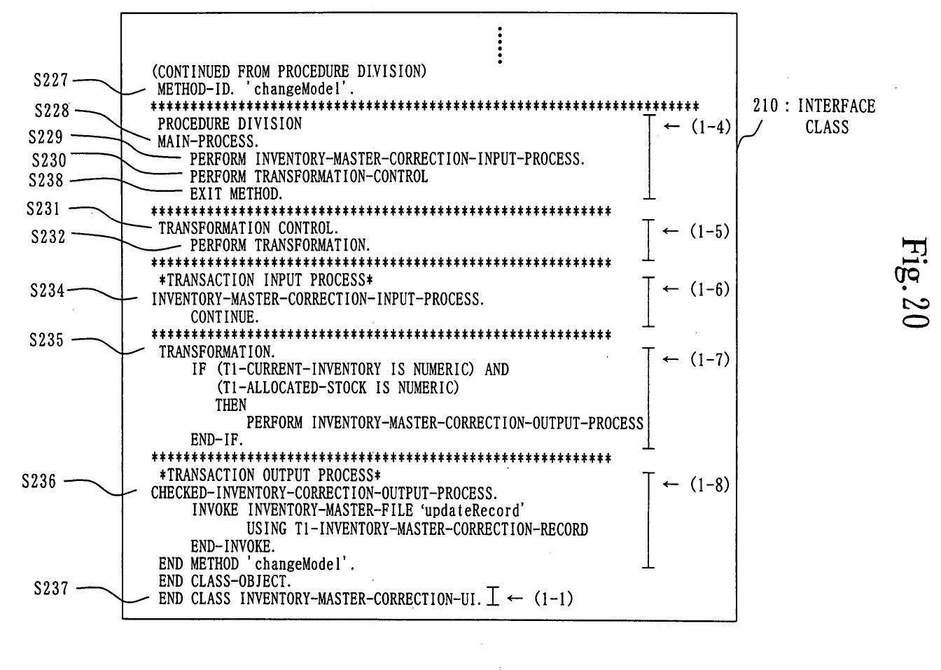

FIG. 19 shows a procedure division of the input checking program 102. FIG. 20 shows the procedure division and the footing of class end of the input checking method.

As shown in FIG. 13, the procedure division (S128) of the input checking program 102 is transformed into the procedure division of the input checking method “changeModel” (S227). Details of each transformation is written in FIG. 15 from the location number (1-4) to (1-8), and the transformation, that is, an actual concrete extraction/transformation will be explained referring to FIGS. 19 and 20.

The main processing section (S130 through S134) written in the main process (S129) of the procedure division (S128) in FIG. 19 is extracted, and the transformation process will be explained for creating the contents of processing of the main process (S228) of the input checking method shown in FIG. 20 from the extracted component. A way to identify the main processing part at the time of extraction is the same as discussed above, and the explanation is omitted here.

As for the actual transformation of the structure and syntaxes, first, OPEN statement (S130) of the file and CLOSE statement (S133) of the file shown in FIG. 19 are ignored. Further, from PERFORM statement (S132) of the transformation control, the loop instruction (UNTIL instruction) is ignored. The reason for ignoring OPEN statement and CLOSE statement of the file is that it is unnecessary since the input to the interface class 210 is performed from the screen, and the checked record is output to the file class 220. Further, the reason for ignoring the loop instruction is that the intermediate program processes only one record (on-line real-time processing).

Next, STOP RUN. (S134) is transformed into EXIT METHOD. that is necessary for the syntax of the intermediate program. This is shown in FIG. 20 by S238.

Next, the transformation of the process shown by the location number (1-5) will be explained.

In FIG. 19, the concrete contents (S136, S137) written in the transformation control (S135) are extracted, and PERFORM statement (S137) of the transaction input is deleted. This is because there is no need to input a next transaction record, since the intermediate program processes only one record. As a result, only S231 and S232 are extracted to FIG. 20.

In the following, the extraction/transformation of the location number (1-6) will be explained.

READ statement of the transaction file shown by S138 in FIG. 19 is ignored and replaced with CONTINUE statement that means not to process anything. Since, in the intermediate program, the input data from the screen is immediately entered in the transaction record, READ statement becomes unnecessary. As a result, the transaction input process is transformed into a part shown by S234 in FIG. 20.

Next, the extraction/transformation performed at the transformation of the location number (1-7) will be explained.

Among the transformation shown by S139 in FIG. 19, MOVE statement of S142, that is, the statement for moving the record from the transaction record to the checked transaction record is ignored. This is because in the intermediate program, the transaction record is checked and if the data is correct, the data is directly transferred to the file class 220. As a result, only a part shown by S235 in FIG. 20 is extracted for the transformation.

Next, the extraction/transformation performed at the location number (1-8) will be explained.

Here, the extraction/transformation of the transaction output process shown by S141 in FIG. 19 is performed. Concretely, WRITE statement (S143) in the checked transaction file is replaced with INVOKE statement to the matching and updating method of the file class 220. This is because in the intermediate program, the checked record becomes a parameter to the matching and updating method of the file class 220. The result of the above extraction/transformation is shown by S236 in FIG. 20.

S237 shows a step after the transformation at the extraction/transformation of the footing of class end corresponding to the location number (1-1).

As described above, the extracting/transforming unit 1600 automatically extracts/transforms the source code of the interface class 210 which forms the intermediate program 200 from the source code of the input checking program 102 written in the COBOL program 100.

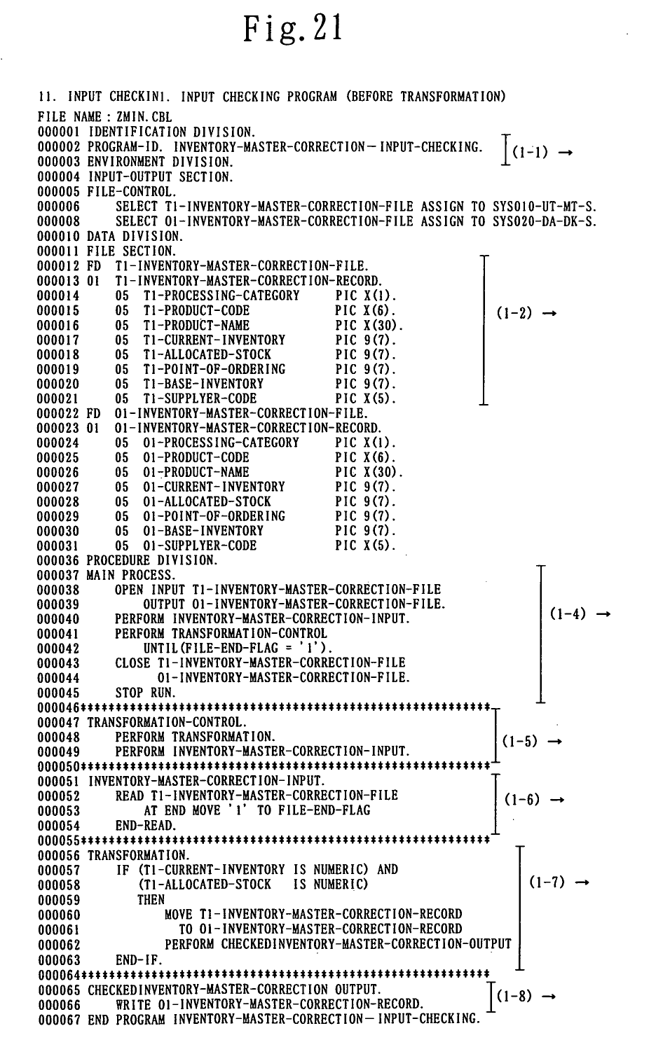

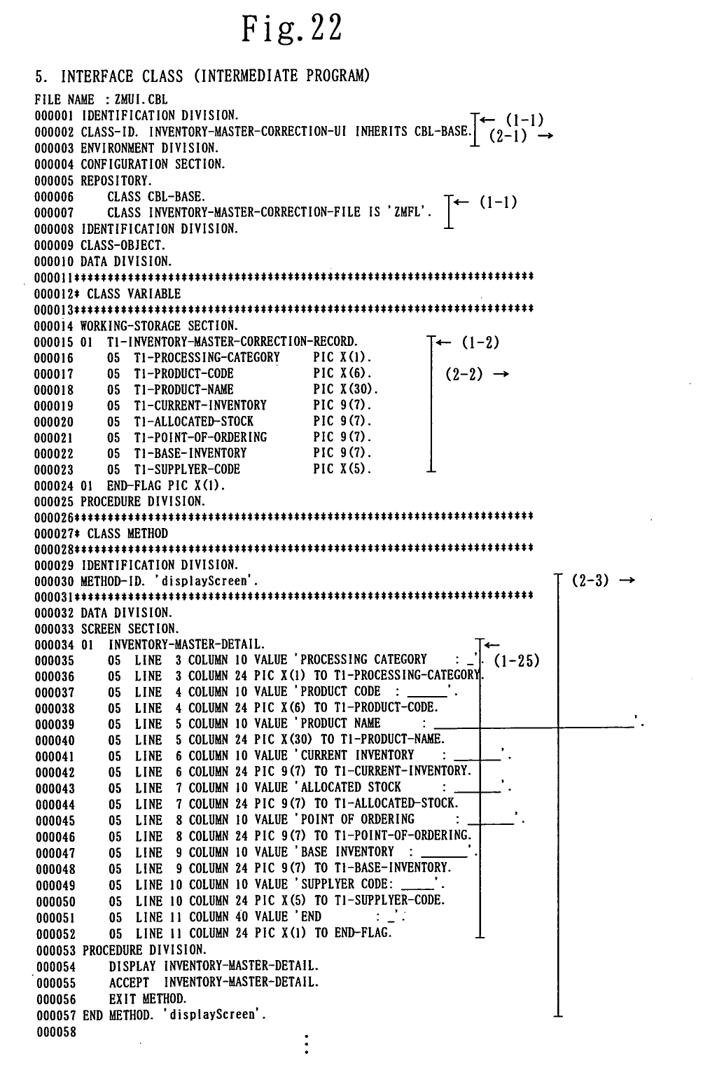

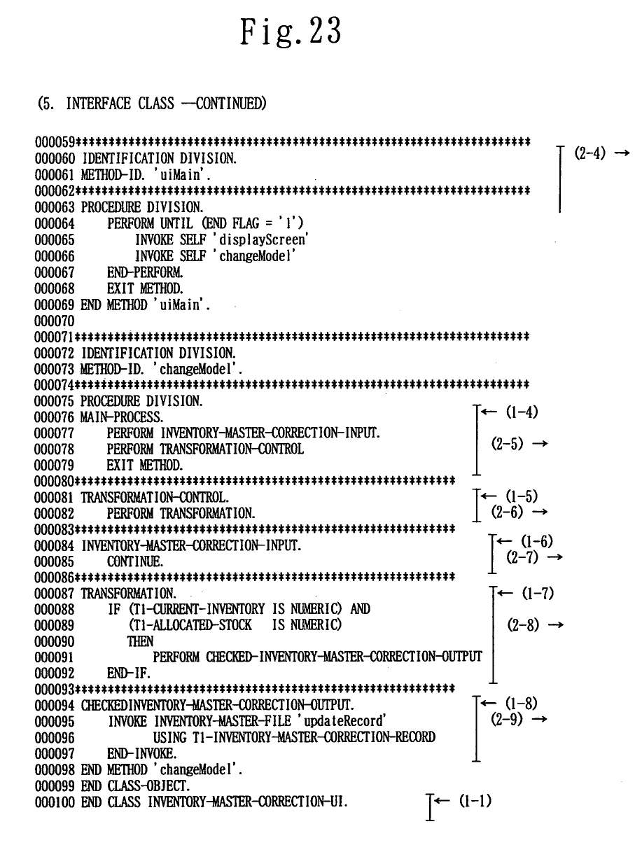

FIG. 21 shows actual source code of the input checking program 102. Further, FIGS. 22 and 23 show source code of the interface class 210 extracted/transformed by the extracting/transforming unit 1600 from the source code of the input checking program 102. Namely, the source code from a step 1 (000001), the first line in FIG. 22, up to a step 100 (000100), the final line in FIG. 23, are the source code of the interface class 210 that are extracted/transformed.

In the program shown in FIGS. 21, 22, and 23, each location number explains how the transformation is performed, and it is not necessary to write each location number in the real program. And the location numbers, which have not been explained above, will be discussed later.

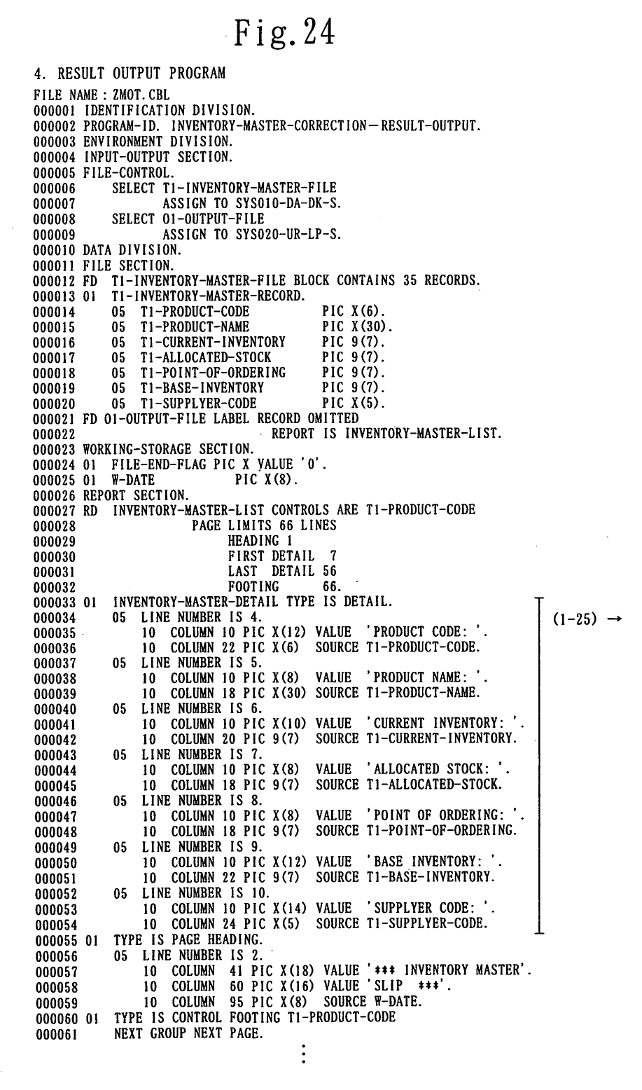

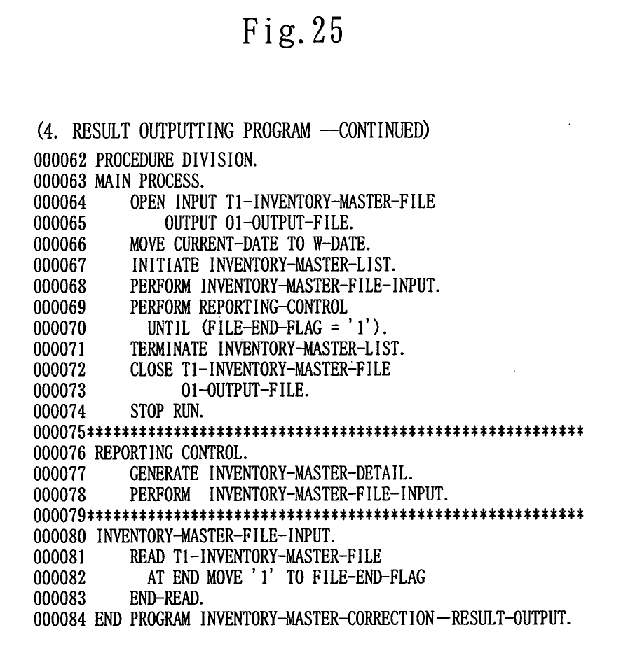

Next, the concrete operation of the extraction/transformation from the result output program 109 to the interface class 210 shown in FIG. 16 will be explained. FIGS. 24 and 25 show a program of the result output program 109. The source code from step 1 (000001), the first line in FIG. 24, up to step 84 (000084), the final line in FIG. 25, is the source code of the result output program 109.

Slip definition is extracted from the location number (1-25) written in the result output program 109 and transformed into screen definition of the screen displaying method shown by the location number (1-25) in FIG. 18. In this case, the line location and the digit location of the slip have to correspond to the line location and the digit location of the screen.

The check item “SOURCE indication” shown by the location number (1-25) in the result output program 109 has to be replaced with the screen item “TO indication” shown by the location number (1-25) in FIG. 18.

Further, screen items are generated for data items, which are included in the transaction record but not in the master record, based on such data items. This is because in the screen displaying method of the interface class 210, the items for the transaction are input from the screen, while the result output program 109 outputs items of the master record.

In the following, the extraction/transformation process, in which the extracting/transforming unit 1600 extracts information to be transformed from the matching program 107 and the sort program 104 into the file class 220, will be explained referring to FIG. 14.

Extraction/Transformation Process From the Matching Program 107 and the Sort Program 104 Into the File Class 220

Next, an operation for extracting/transforming the file class 220 of the intermediate program based on the matching program 107 and the sort program 104 will be explained. As discussed above, FIG. 14 shows correspondence between the matching program 107 and the sort program 104, shown in the left side, from which necessary data is extracted and the file class 220, shown in the right side, to be generated after the extracted necessary data is transformed.

Basic strategy of the correspondence for generating the intermediate program 200 from the matching program 107 and the sort program 104 will be described.

First, logic for the matching and updating is extracted from the matching program 107. And information of a record key is extracted from the sort program 104.

The logic for matching and updating is transformed based on the following three correspondences.

First, in the matching program 107, the record is read from the checked sorted transaction file 105, and in the file class 220, this logic should be transformed to that the transaction record is received as a parameter for the procedure.

Secondly, in the matching program 107, the logic is that the master record and the record of the checked and sorted transaction file 105 are matched, and the file class 220 also needs this logic.

Thirdly, while in the matching program 107, as a result of matching, if the data is correct, a new master record is updated according to the processing category and written in a new master file, in the file class 220, such process should be transformed as that if the data is correct, the master record is updated according to the processing category and the master file is overwritten.

Based on the above first through third correspondences, the extracting/transforming unit 1600 ignores the logic for reading the record from the transaction file, which is performed in the matching program 107, and defines the transaction record as the parameter.

Further, the logic is transformed so that the extracting/transforming unit 1600 ignores either one of the definitions of the master file (in this example, the new master file is ignored), which are used in the matching program 107, and reading/writing from/in the master file should be performed only on the other file, which is not ignored.

Further, the extracting/transforming unit 1600 organizes the master file as an indexed file.

The extracting/transforming unit 1600 makes the instruction to write the master record as addition (WRITE), update (REWRITE), and deletion (DELETE).

Since the file class 220 processes only one record of both the transaction record and the master record, the extracting/transforming unit 1600 ignores the loop logic for preparing the next record.

Based on the above strategy, the extracting/transforming unit 1600 extracts and transforms necessary information from the matching program 107 and the sort program 104 before the transformation, and automatically generates the source code of the file class 220.

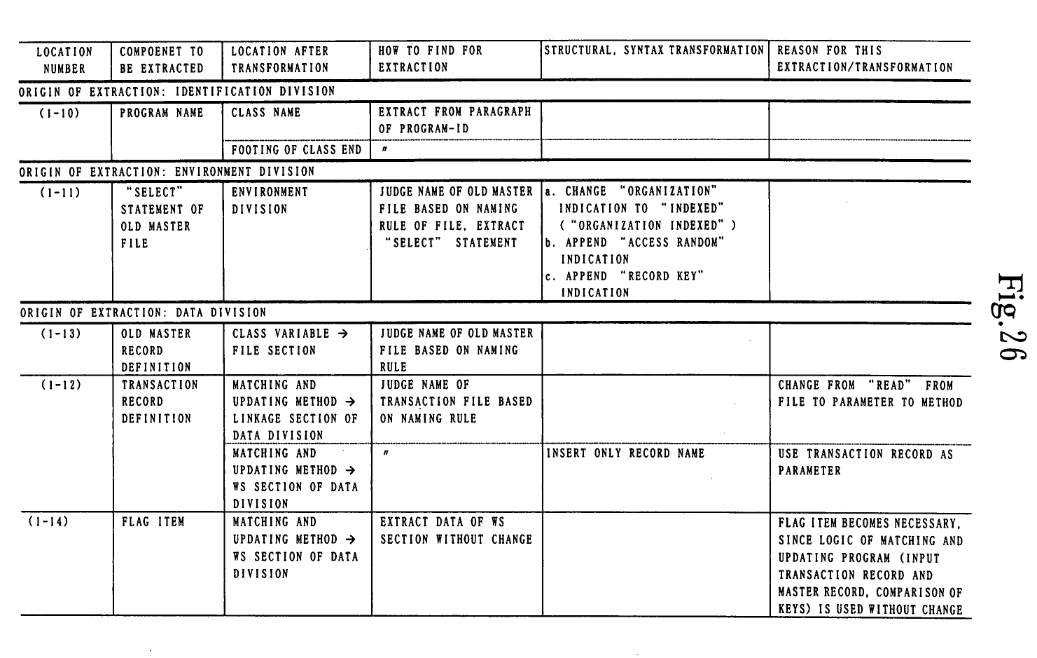

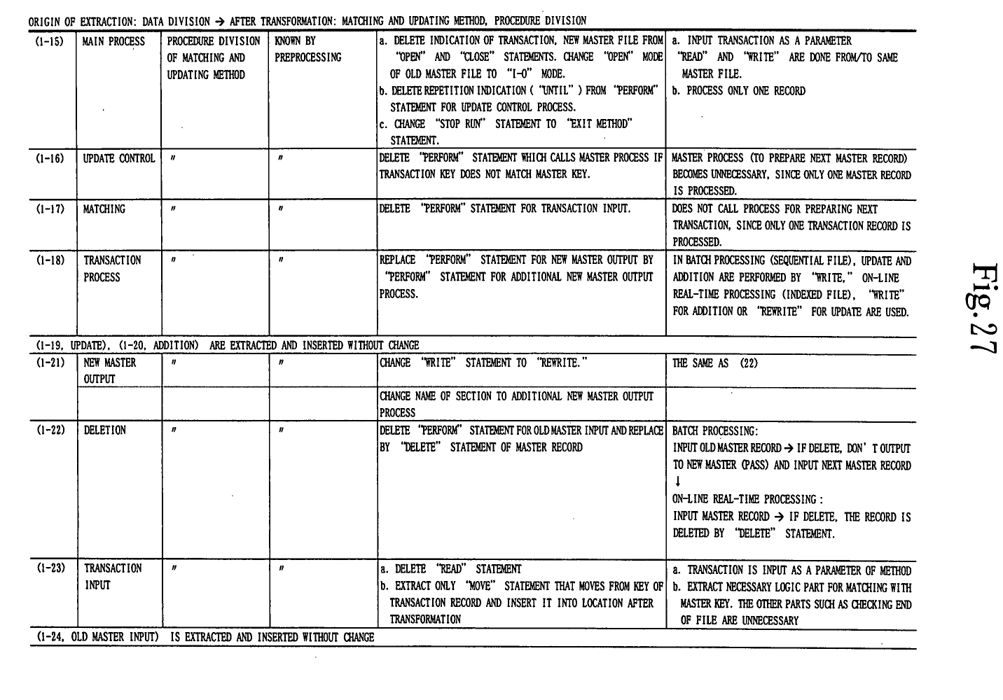

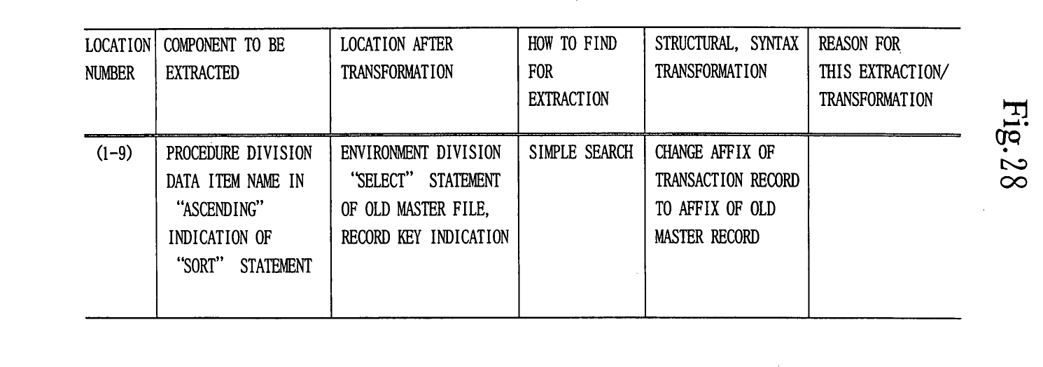

Details of the above extraction/transformation by the extracting/transforming unit 1600 are shown in FIGS. 26 through 28. FIGS. 26 and 27 show details of the extraction/transformation of the data from the matching program 107 to the file class 220. FIG. 28 shows the extraction/transformation of the data from the sort program 104 to the file class 220. The location numbers shown in FIGS. 26 through 28 are the same as the location numbers shown in the correspondence in FIG. 14. In this way, the extracting/transforming unit 1600 automatically extracts/transforms necessary information to generate the file class 220.

The extracting/transforming unit 1600 newly generates and adds components, which are not in the COBOL program 100, but will be required in the intermediate program 200. Namely, the following three components are added to the interface class 210. The first component is a flag item for checking if the input from the screen is finished. The second component is a main procedure for calling the screen displaying method and the input checking method. The third component is a displaying and input receiving instruction within the screen displaying method.

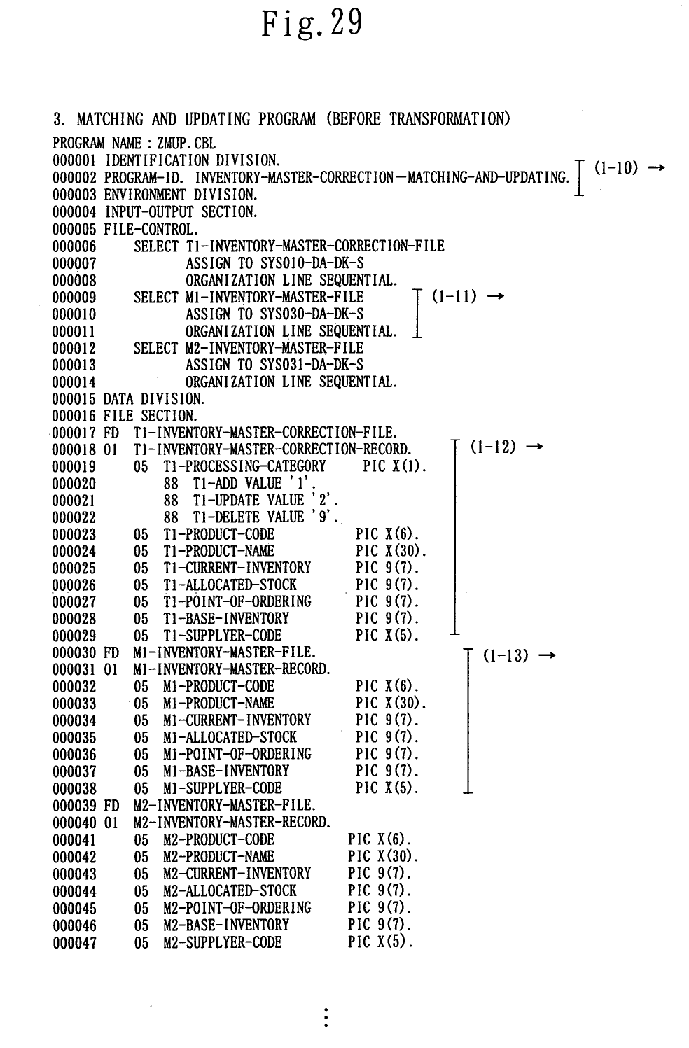

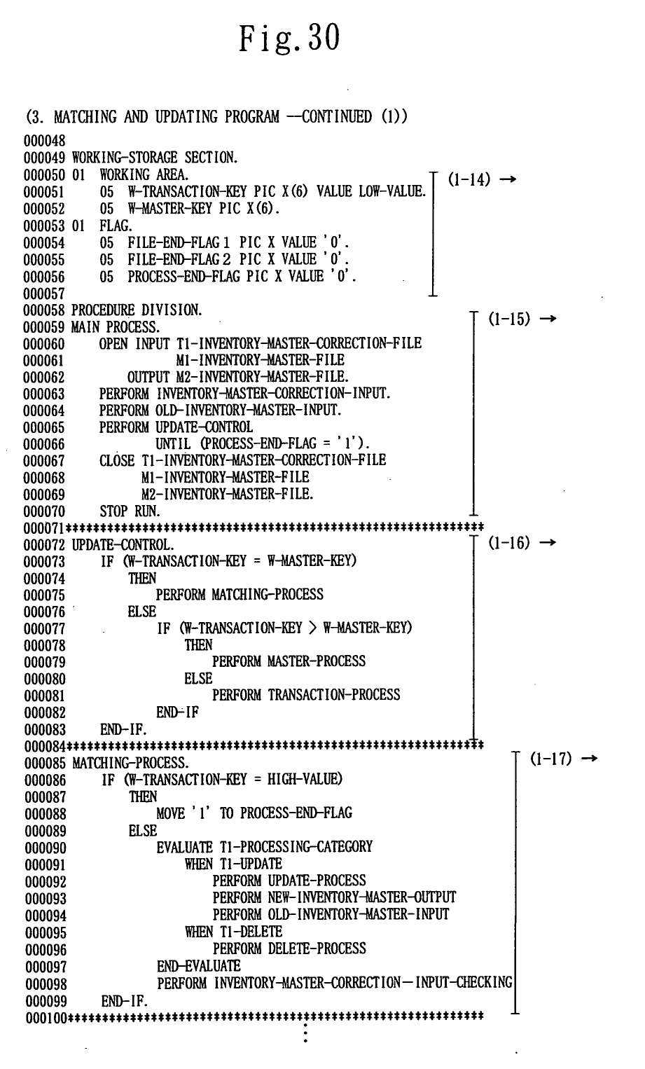

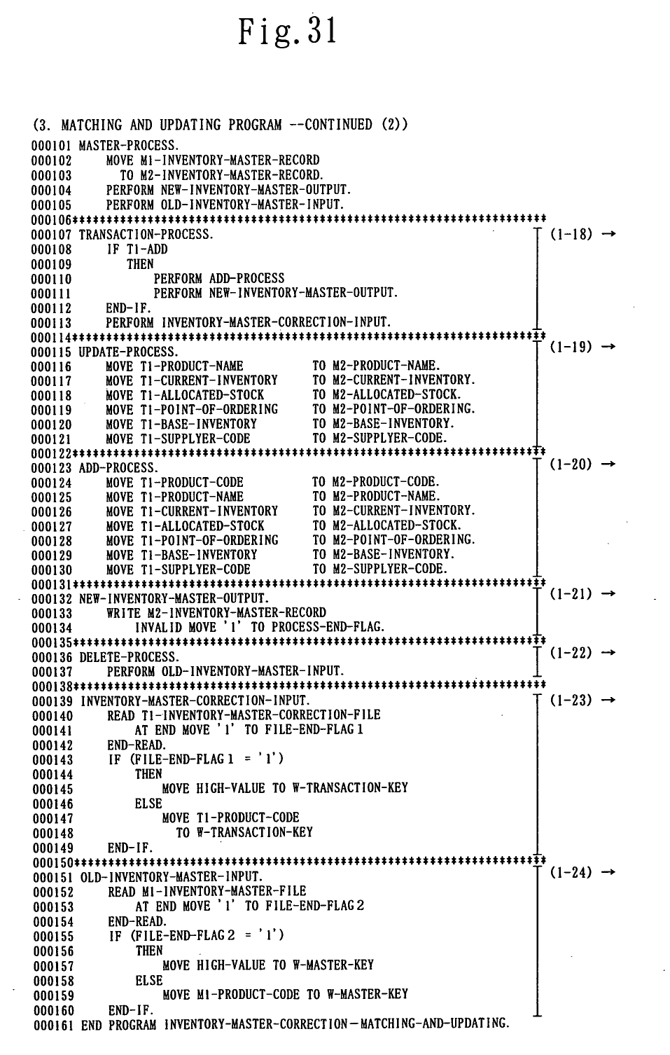

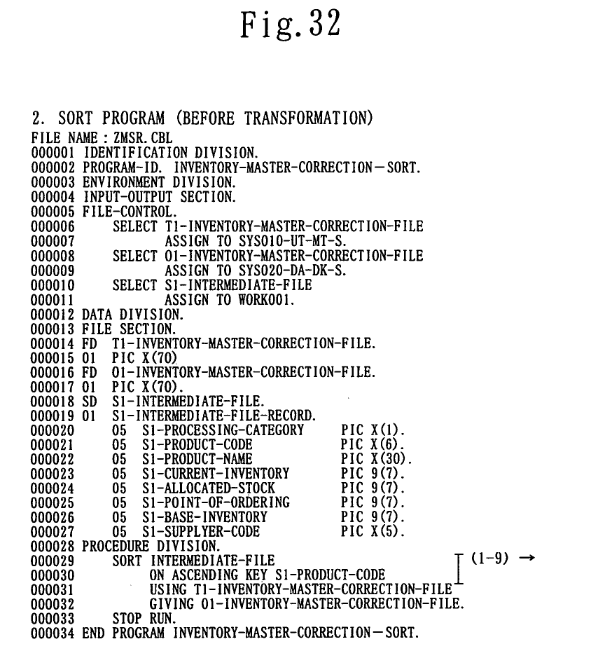

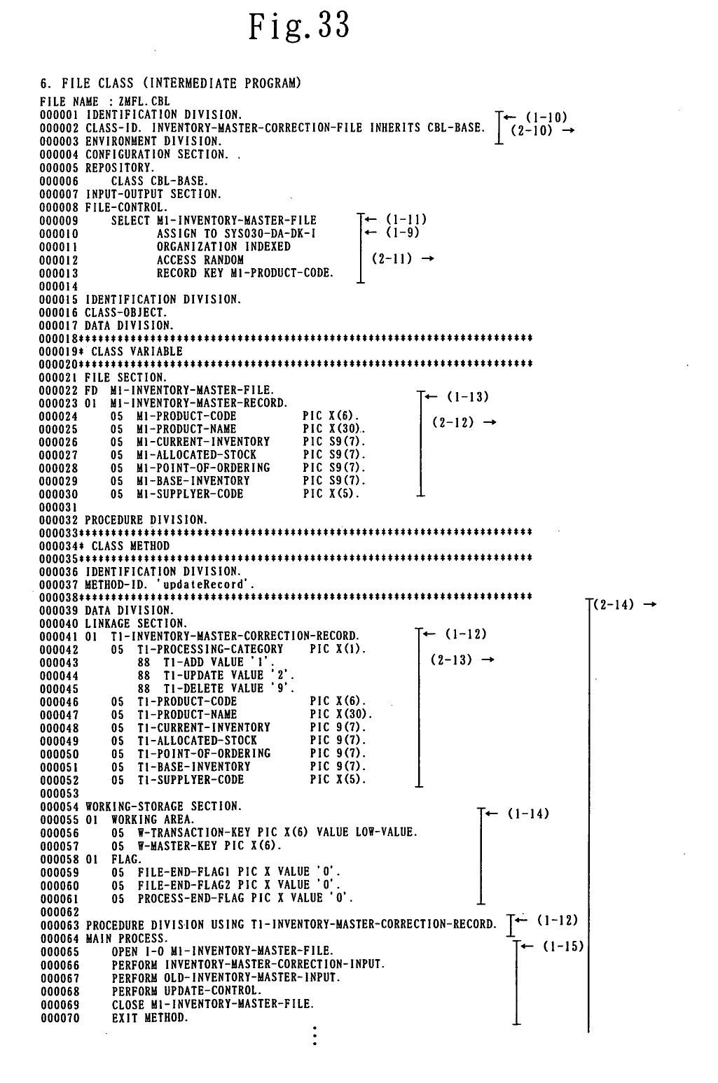

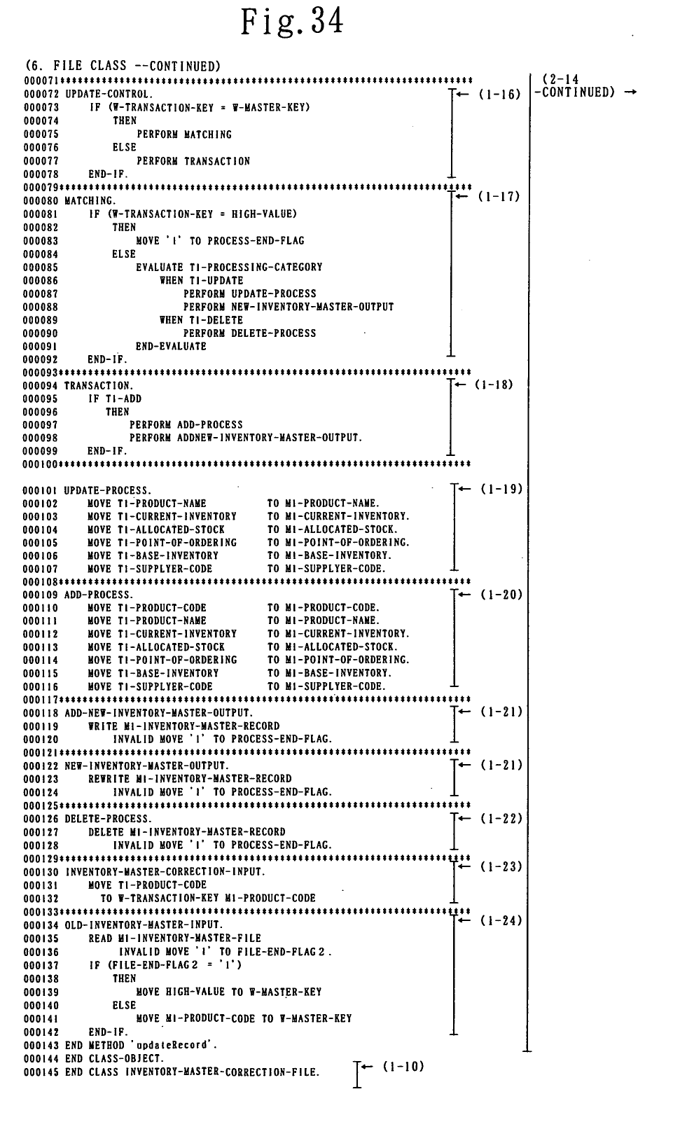

FIGS. 29 through 31 show the source code of the matching program 107 which has been explained above. And FIG. 32 shows the source code of the sort program 104. Further, FIGS. 33 and 34 show the program of the file class 220.

The location information in the program is written to clarify the correspondence among FIGS. 14, 26, 27, and 28; however, it is not necessary to write the location information in the actual program.

The transformation apparatus A 1000 of the present embodiment is enabled to automatically transform the source code of the COBOL program 100 being suitable to the batch processing into the source code of the intermediate program 200 being suitable to the distributed processing. Accordingly, the program resource can be exploited also in the distributed processing, so that the program resource is effectively utilized.

Further, according to the present embodiment, the business logic in the program, which has been coded conventionally, can be reused.

Further, since the transformation of the program is automatically performed by the transformation apparatus A 1000, manpower operation is not required, so that the manpower can be reduced.

Further, in an organization such as a company, in case of switching the system from the batch processing to the distributed processing, the program used for the batch processing can be effectively used also in the distributed processing, so that necessity to newly develop the program can be minimized, the manpower operation can be reduced, and a time for developing the system can be shortened and a cost for developing the system can be reduced.

Further, by transforming the procedural program into the object-oriented program, the interface between the programs can be clarified.

Further, since the specification change inside the object does not affect to the external program by transforming the procedural program into the object-oriented program, the reuse of the source code is facilitated.

Next, the transformation apparatus B 2000 will be explained, which generates the final program 300 from the intermediate program 200 shown in FIG. 1. Using the transformation apparatus B 2000, it becomes possible to transform the intermediate program 200 into the final program 300, which is more object-oriented, including classes specified for individual roles.

First, an internal configuration of the transformation apparatus B 2000, which transforms the intermediate program 200 into the final program 300, will be explained.

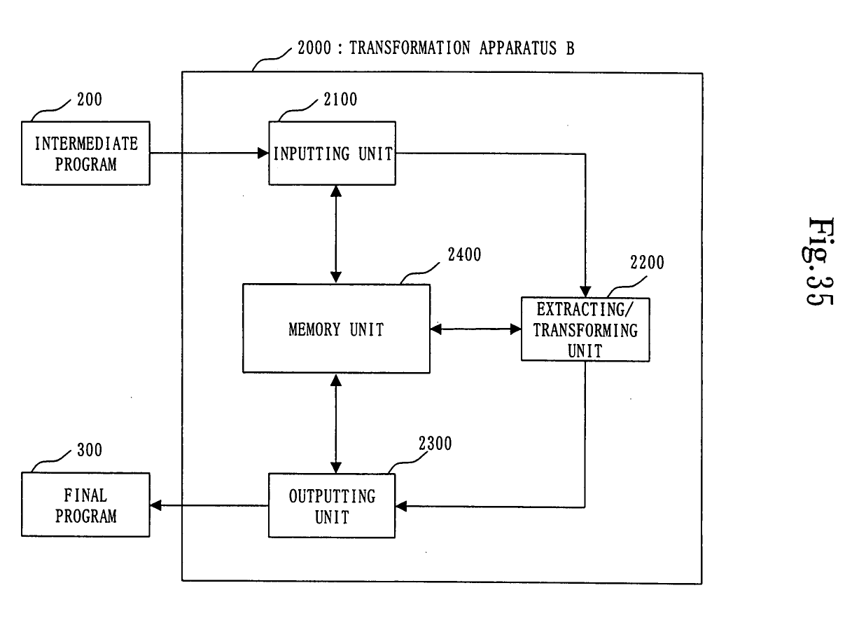

FIG. 35 shows the internal configuration of the transformation apparatus B 2000.

The inputting unit 2100 inputs the intermediate program 200 which has been transformed by the transformation apparatus A 1000.

Next, the extracting/transforming unit 2200 extracts and transforms necessary information from the intermediate program 200 which has been input by the inputting unit 2100. The outputting unit 2300 outputs the program extracted/transformed by the extracting/transforming unit 2200 as the final program 300. The inputting unit 2100, the extracting/transforming unit 2200, and the outputting unit 2300 can store the information in the memory unit 2400, if necessary. The memory unit 2400 does not need to be inside the transformation apparatus B 2000, but can be an outside storage device.

Next, a transformation flow of each data processing will be explained, in which the transformation apparatus B 2000 transforms the intermediate program 200 into the final program 300.

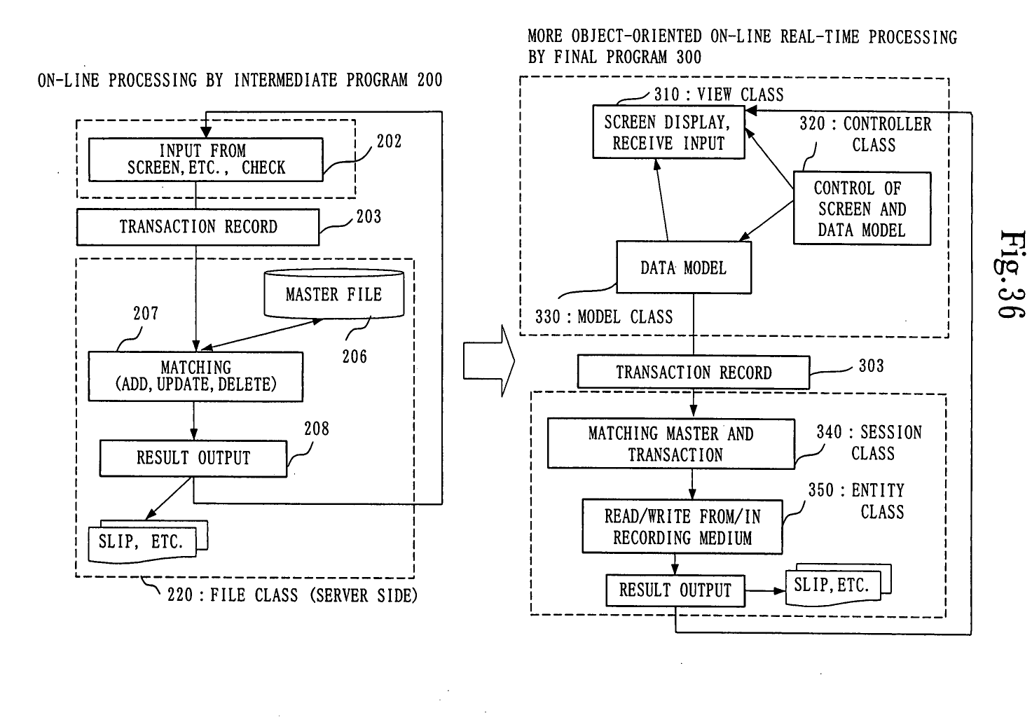

FIG. 36 shows how the data processing method is transformed by the transformation apparatus B 2000.

The left side of the figure shows the on-line real-time processing performed by the intermediate program 200. The right side of the figure shows the on-line real-time processing performed by the final program 300, which is more object-oriented than the intermediate program 200.

The intermediate program 200 that performs the processing of the left side includes the interface class 210 and the file class 220. A flow of the data shown in the left side has been explained in case of FIG. 3, so that it is omitted here.

The final program 300 shown in the right side is composed of five classes. Concretely, three classes of the view class 310, the controller class 320, and the model class 330 are generated from the interface class 210. Further, two classes of the session class 340 and the entity class 350 are generated from the file class 220.

The view class 310, the controller class 320, and the model class 330 are classes of a client 5000. Among these, the view class 310 displays on the screen and receives the input. The model class 330 manages models (attributes, etc.) of the data. The controller class 320 controls the screen managed by the view class 310 and the data models managed by the model class 330.

The session class 340 and the entity class 350 are classes of a server 6000. The session class 340 matches the master record and the transaction record. The entity class 350 manages writing the result of the matching performed by the session class 340 in the recording medium.

Based on the control performed by these classes, the transaction record 303 is transferred to the server 6000 from the client 5000, which enables a more object-oriented on-line real-time processing.

Next, the operation of the extracting/transforming unit 2200 for generating the final program 300 will be explained.

First, the extracting/transforming unit 2200 generates components which will be previously incorporated into the final program 300. The generated components are stored in a template of five object-oriented programs correspondingly to the five classes shown in FIG. 36. Further, file name information is added to the template corresponding to each class.

Further, the extracting/transforming unit 2200 creates a method necessary for each class and keeps its contents empty. At this time, semantic information is appended to each method so as to specify each method for a later extraction/transformation process. Concretely, an initialization method and a screen displaying method are created for the view class 310. An initialization method and a UI main method are created for the controller class 320. An initialization method, an input checking method, and a screen data receiving method are created for the model class 330. An initialization method and a transaction checking method are created for the session class 340. An initialization method, a master file checking method, and a matching and updating method are created for the entity class 350.

Next, as for an operation in which the extracting/transforming unit 2200 extracts/transforms necessary information from the intermediate program 200 to generate the final program 300, first, the operation for extracting/transforming the view class 310, the controller class 320, and the model class 330 from the interface class 210 will be explained, and then the operation for extracting/transforming the session class 340 and the entity class 350 from the file class 220 will be explained.

Correspondence of the Interface Class 210 with Three Classes

First, correspondence of the interface class 210 with three classes will be explained.

The extracting/transforming unit 2200 assigns roles of screen displaying and inputting, which are a part of roles of the interface class 210, to the view class 310. Next, the extracting/transforming unit 2200 assigns a role of input checking to the model class 330. Then, the extracting/transforming unit 2200 further assigns a role of controlling operation to the controller class 320 for calling each of the roles that are assigned to these two classes.

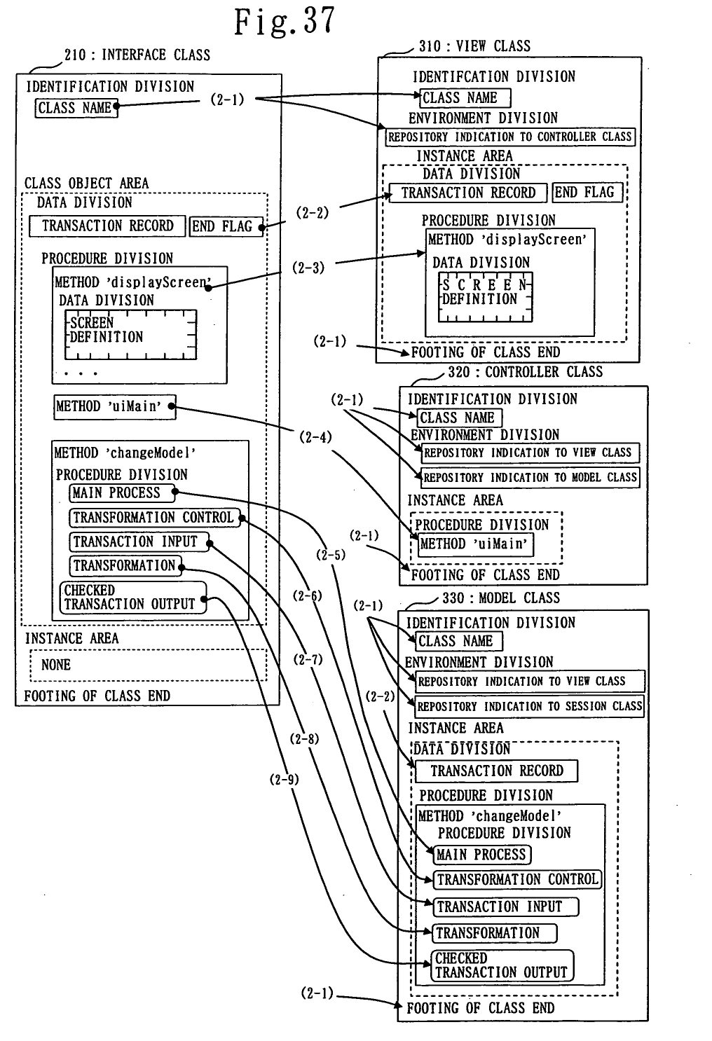

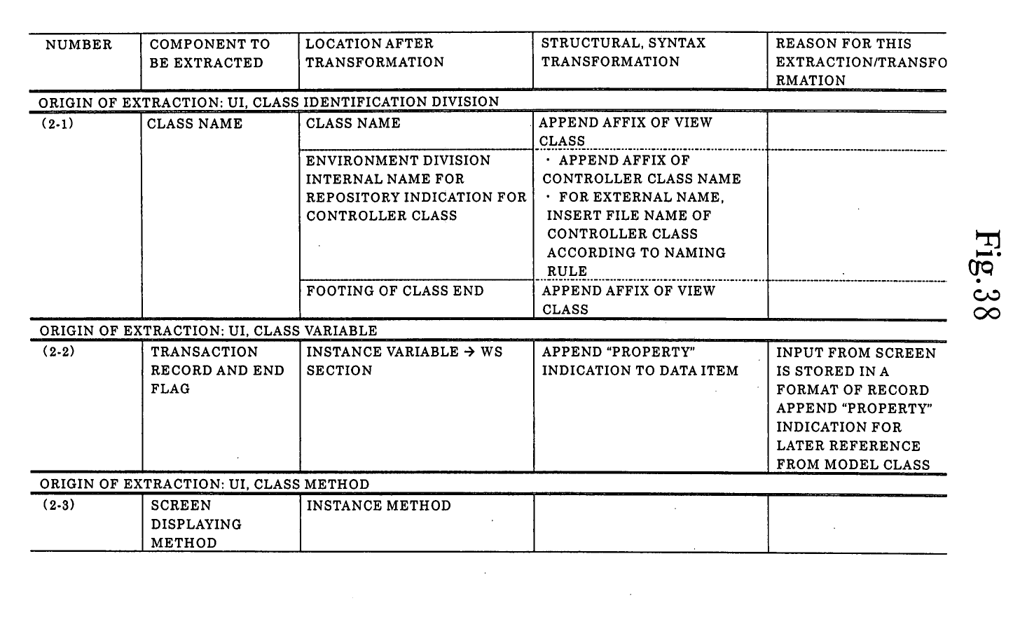

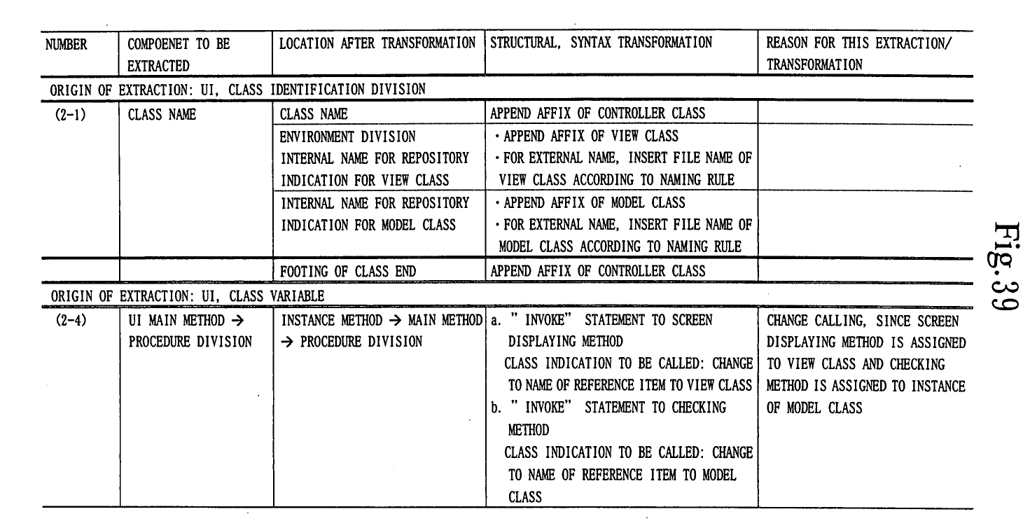

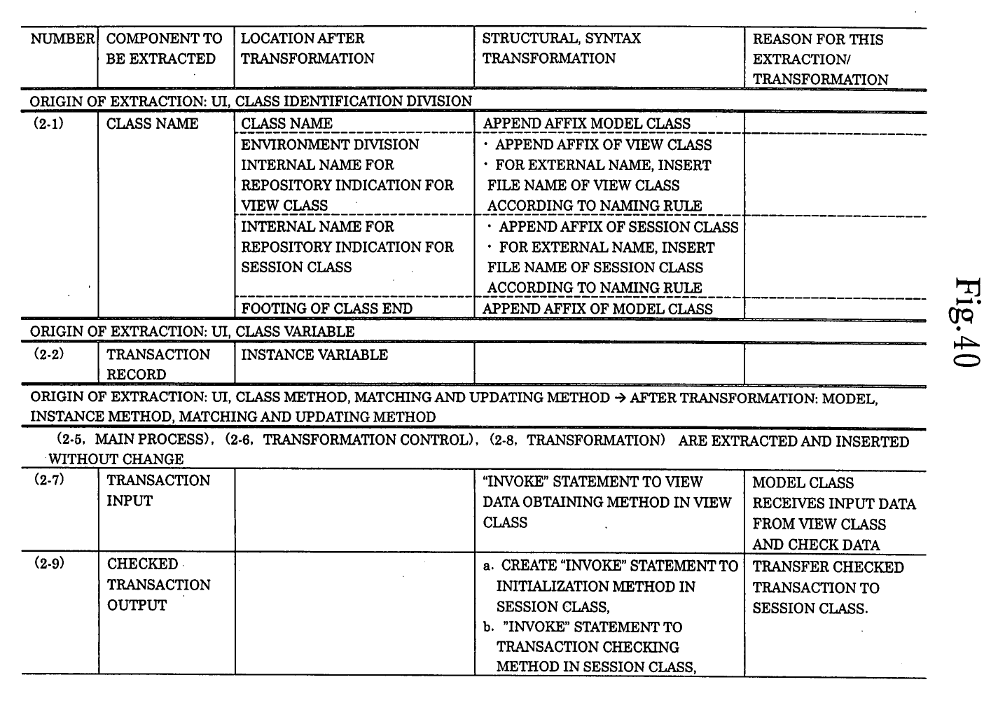

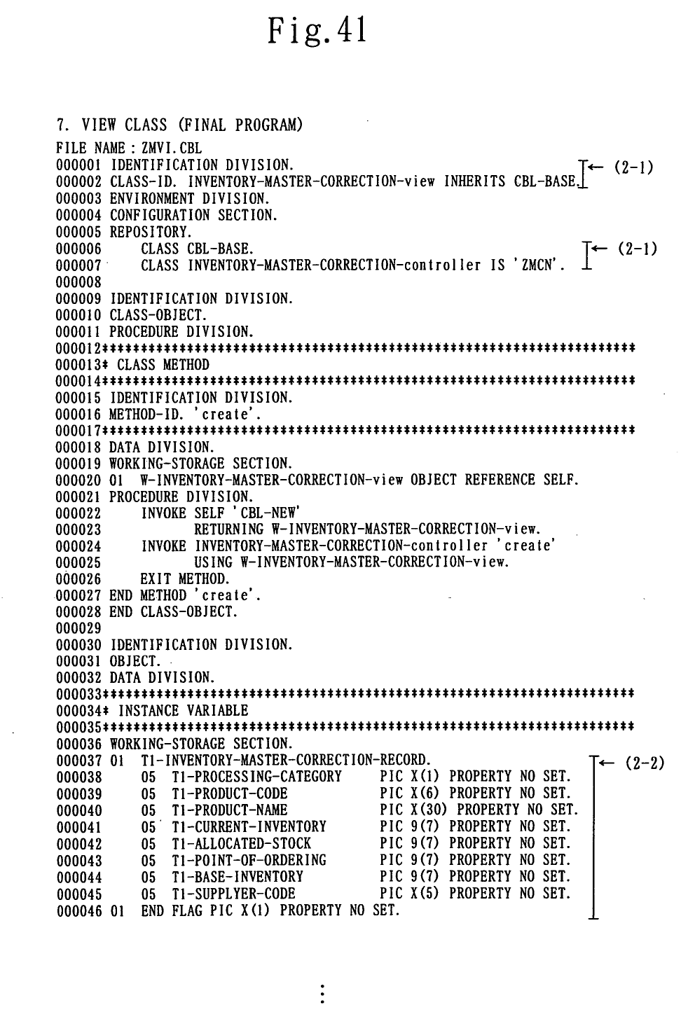

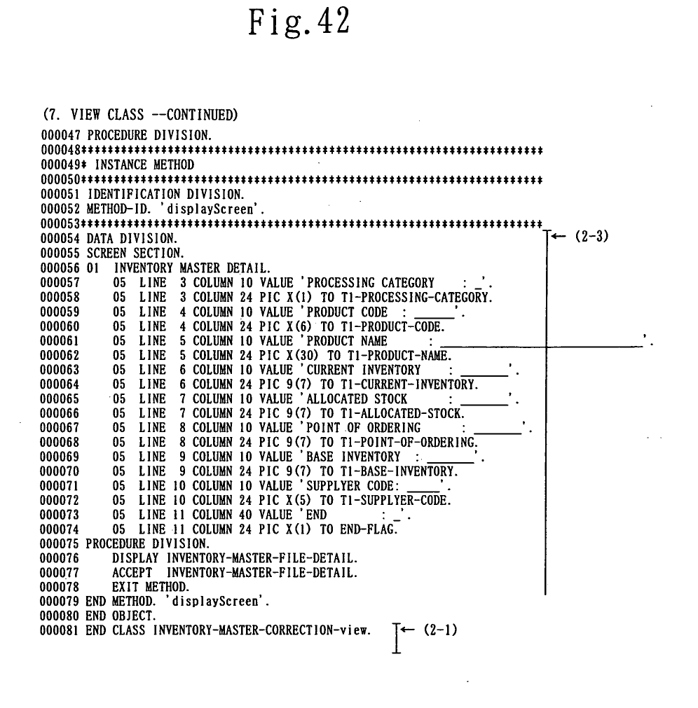

FIG. 37 shows the above-described correspondence between the interface class 210 and the three classes. Further, FIGS. 38 through 40 show concrete extraction/transformation method to each class. Here, the location number shown in FIGS. 38 through 40 corresponds to the location number of FIG. 37. FIG. 38 shows a concrete extraction/transformation method from the program of the interface class 210 to the program of the view class 310. FIG. 39 shows a concrete extraction/transformation method from the interface class 210 to the controller class 320. FIG. 40 shows a concrete extraction/transformation method from the interface class 210 to the model class 330. FIGS. 41 and 42 show concrete source code of the program of the view class 310 that is automatically generated based on the extraction/transformation method by the extracting/transforming unit 2200. The location numbers are written to make correspondence between the source code of the program before the transformation and the source code of the program after the transformation, so that there is no need to include these numbers in a real program. The interface class 210 before the transformation is clearly shown in FIGS. 22 and 23, and the correspondence are made between the location numbers (2-1), (2-2), and (2-3) written in the program of the interface class 210 and the location numbers (2-1), (2-2), and (2-3) shown in the program of the view class 310.

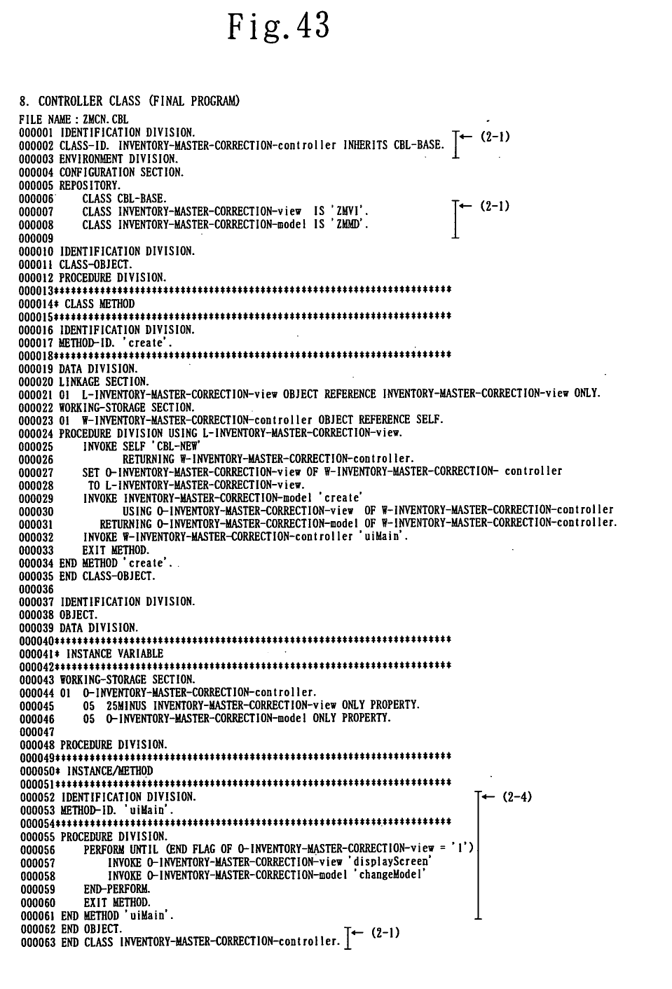

FIG. 43 shows the source code of the program of the controller class 320 which is automatically generated by the extracting/transforming unit 2200 based on the extraction/transformation method shown in FIG. 39. The correspondence is made by the location numbers (2-1) and (2-2) shown in the source code of the two programs between the interface class 210 and the controller class 320.

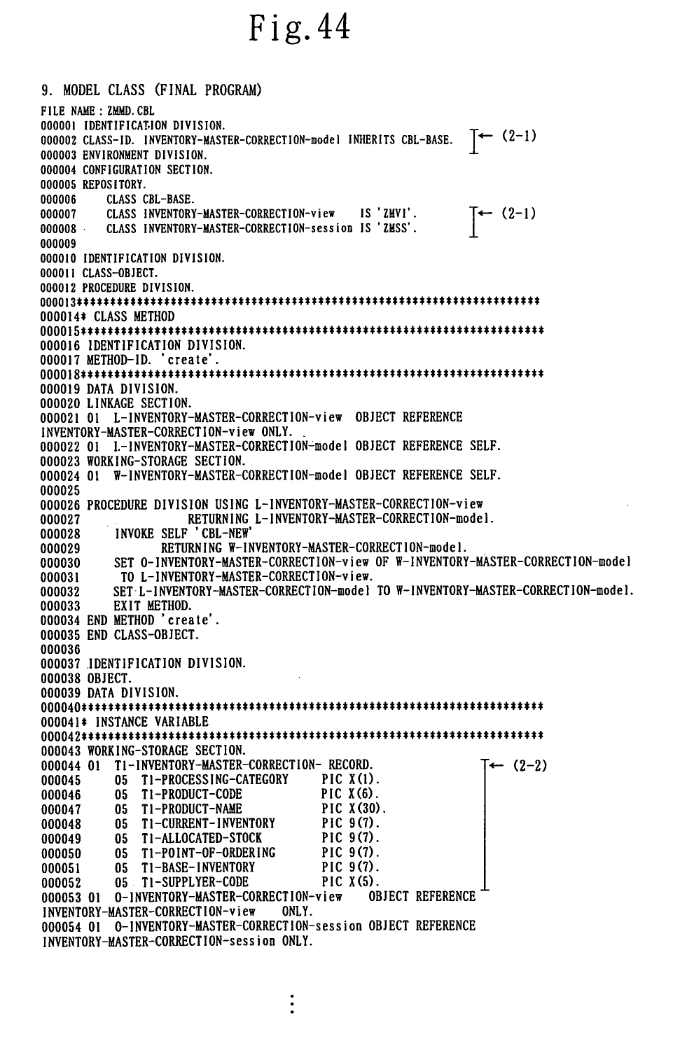

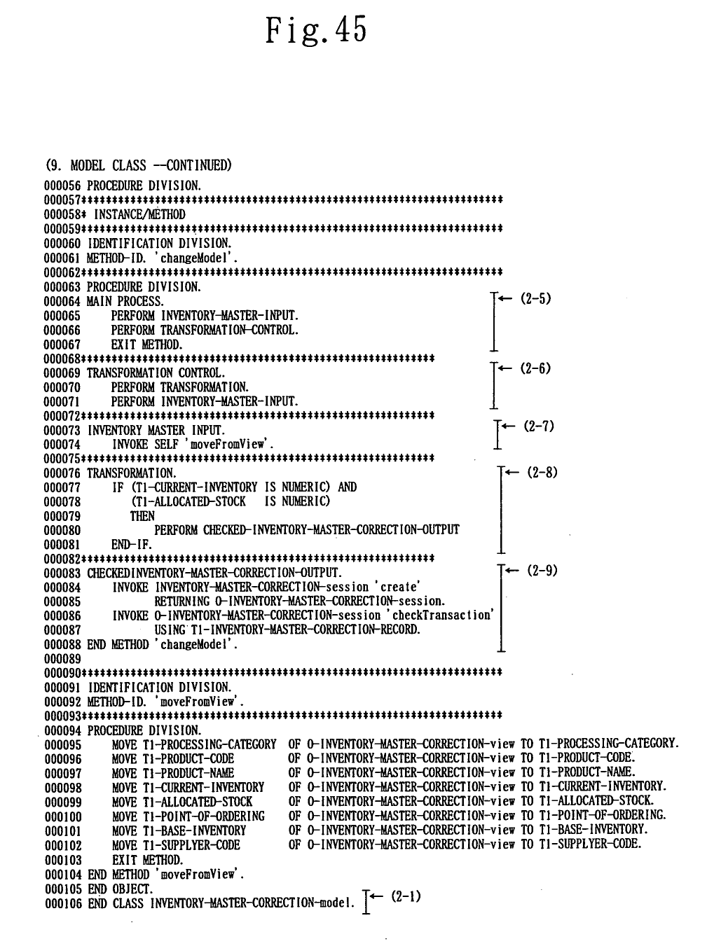

FIGS. 44 and 45 show the source code of the model class 330 which is automatically generated by the extracting/transforming unit 2200 based on the extraction/transformation method shown in FIG. 40. The correspondence is made by the location numbers (2-1), (2-2), (2-5), (2-6), (2-7), (2-8), and (2-9) between the interface class 210 and the model class 330.

Correspondence of the File Class 220 with the Two Classes

Next, the correspondence of the file class 220 with the two classes (340, 350) will be explained. The extracting/transforming unit 2200 assigns roles of the file class 220 to two classes of the session class 340 and the entity class 350 as follows. The file class 220 has logic for checking if the master file includes the transaction record in case of updating/deleting the master file and for checking if the master file includes no transaction record in case of adding to the master file. The extracting/transforming unit 2200 assigns this logic to the session class 340. Further, the extracting/transforming unit 2200 assigns logic for adding, updating, or deleting the transaction record to/from the master file to the entity class 350 according to the processing category of the transaction record.

By these correspondences, the source code of the program of the file class 220 is transformed into the source code of the program of the session class 340 and the source code of the program of the entity class 350 by the transformation apparatus B 2000.

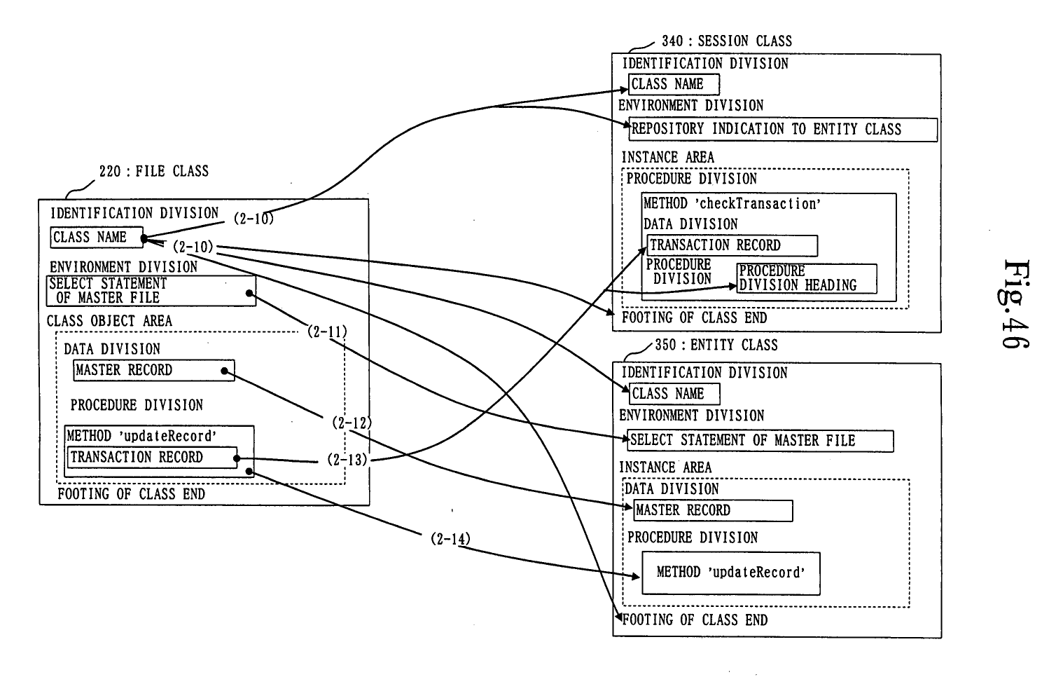

FIG. 46 shows the above correspondence of the file class 220 with the session class 340 and the entity class 350 performed by the extracting/transforming unit 2200.

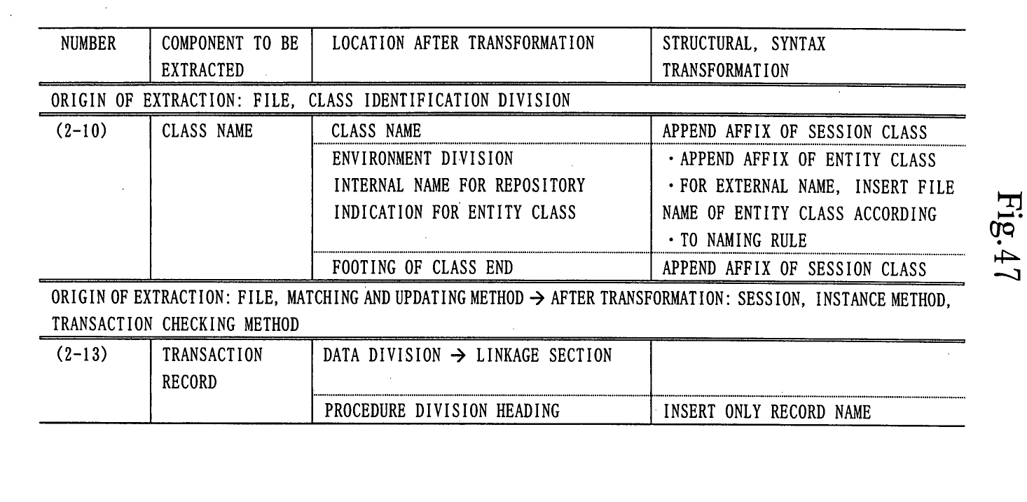

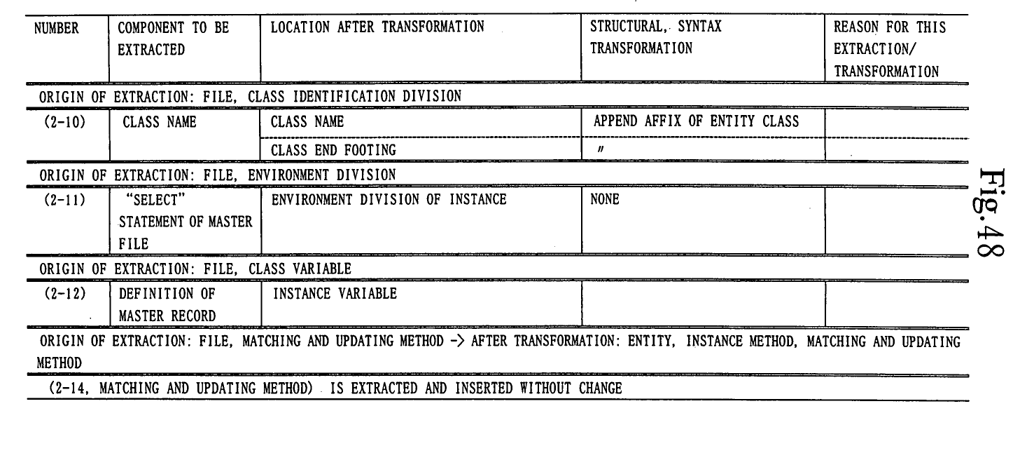

FIG. 47 shows a concrete extraction/transformation method for transforming the program of the file class 220 to the program of the session class 340. Further, FIG. 48 shows a concrete extraction/transformation method for transforming the program of the file class 220 to the program of the entity class 350.

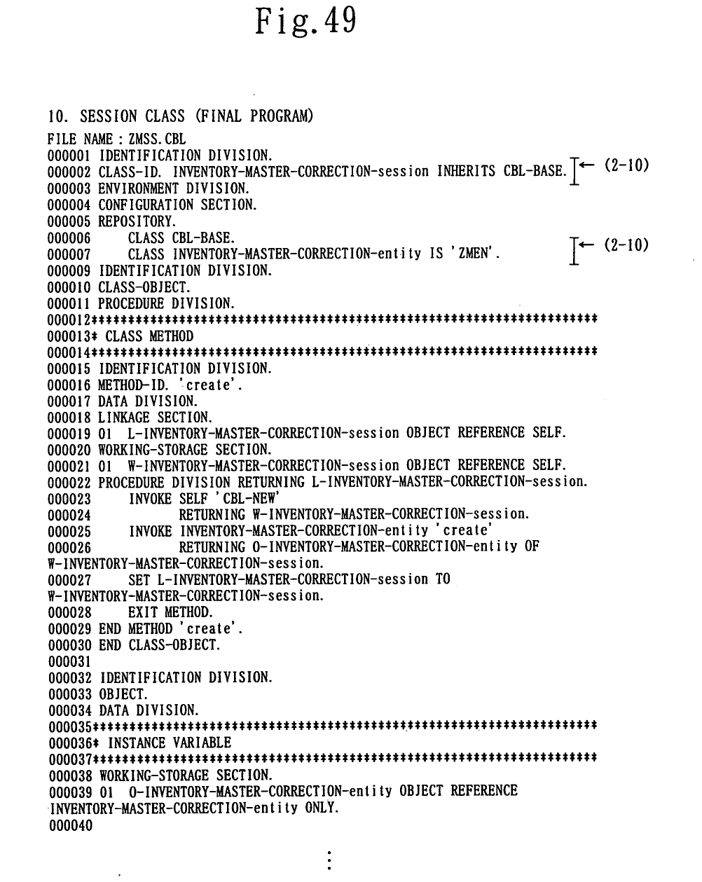

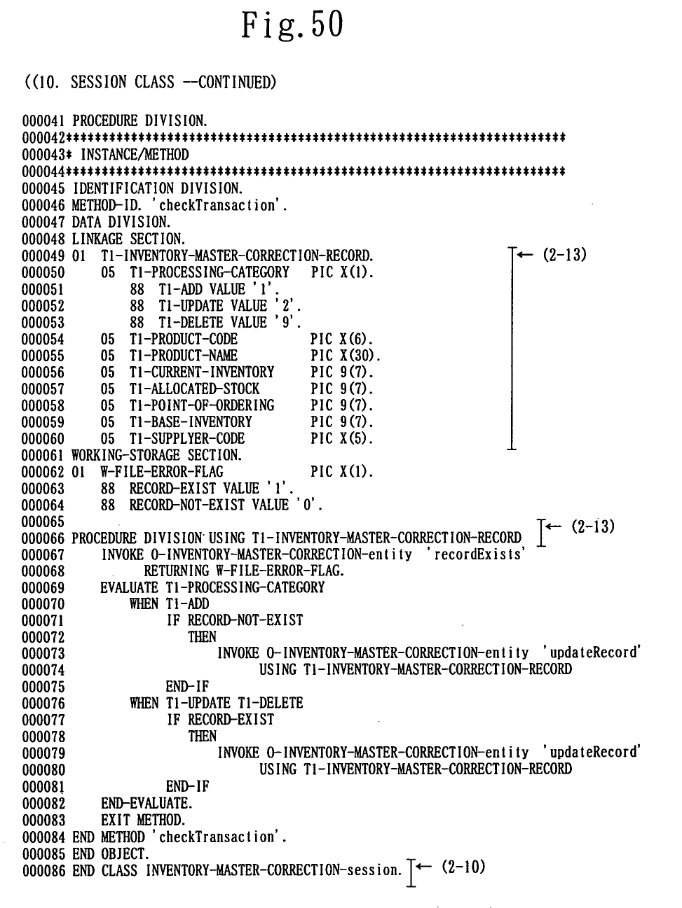

The extracting/transforming unit 2200 extracts necessary data from the program of the file class 220 based on the extraction/transformation method shown in FIG. 47 and automatically transforms to the program of the session class 340 using the extracted data. FIGS. 49 and 50 show the program of the session class 340 which is automatically transformed.

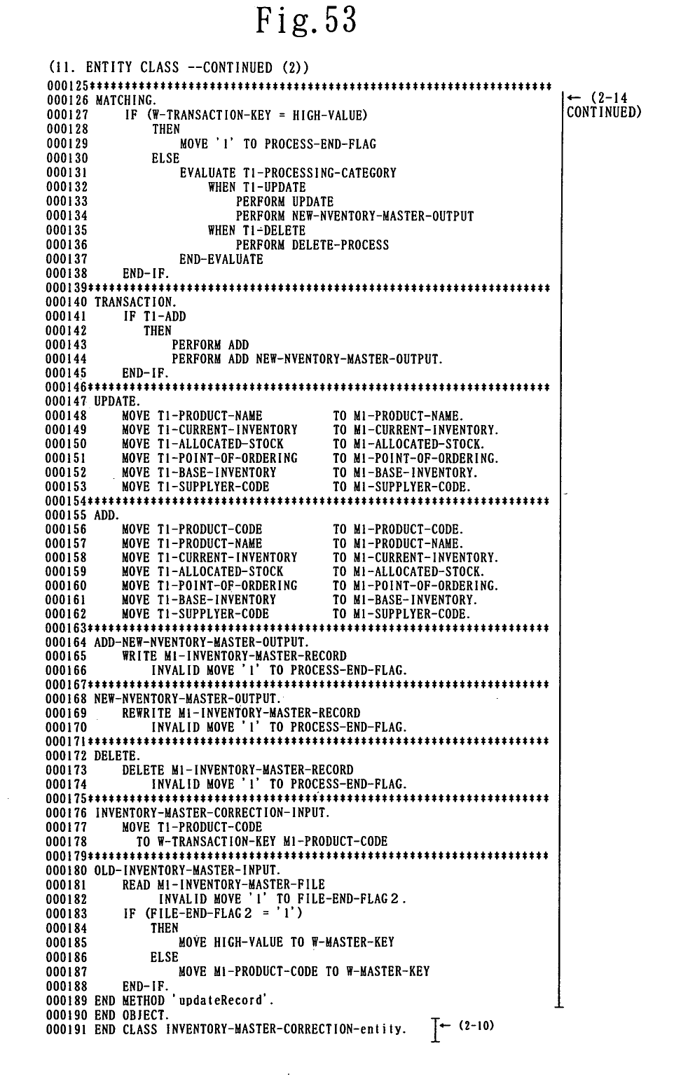

Further, the extracting/transforming unit 2200 extracts necessary data from the program of the file class 220 based on the extraction/transformation method shown in FIG. 48 and automatically transforms to the program of the entity class 350 using the extracted data. FIGS. 51 through 53 show the program of the entity class 350 which is automatically transformed.

The above generated five classes of the final program 300 include components which are not included in the intermediate program 200. Accordingly, these components have to be newly created. Additional components to each class, which have to be newly created, will be explained.

The extracting/transforming unit 2200 creates the additional components.

First, the operation in which the extracting/transforming unit 2200 adds new items to the view class 310 will be explained referring to FIG. 41.

Initialization Method

As for the contents of the initialization method, steps for creating a self instance and for calling the initialization method for the controller class are added.

Concretely, WORKING-STORAGE SECTION is provided in a data division of the method, and steps are added for referring to the self instance (steps 19 through 20). A procedure division of the method is provided with steps for creating the self instances (steps 22 through 23) and steps for calling the initialization method of the controller class (steps 24 through 25) using the self instance as a parameter.

Next, the operation in which the extracting/transforming unit 2200 adds new items to the controller class 320 will be explained referring to FIG. 43.

Initialization Method

As for the contents of the initialization method, steps for creating a self instance and for connecting a view instance as the parameter and the self instance are added. Further, steps for calling the initialization method of the model class 330 and for connecting a model instance as a return value and the self instance are added.

Concretely, LINKAGE SECTION is provided in a data division of the method, and steps for referring to the view instance as the parameter are added (steps 20 through 21). Further, WORKING-STORAGE SECTION is provided, and steps for referring to the self instance are added (steps 22 through 23). To a procedure division of the method, a step for declaring to receive the view instance as a parameter (step 24), steps for creating the self instance (steps 25 through 26), steps for connecting the view instance as the parameter and the self instance (steps 27 through 28), steps for calling the initialization method of the model class 330 and connecting the model instance as the return value and the self instance (steps 29 through 31), and a step for calling a UI main method of the controller class 320 (step 32) are added.

Next, the operation in which the extracting/transforming unit 2200 adds new items to the model class 330 will be explained referring to FIGS. 44 and 45.

Initialization Method

As for the contents of the initialization method, steps for creating a self instance and for connecting a view instance as the parameter and the self instance are added.

Concretely, LINKAGE SECTION is provided in a data division of the method, and steps for referring to the view instance as the parameter and referring to the self instance as the return value are added (steps 20 through 22). Further, WORKING-STORAGE SECTION is provided, and steps for referring to the self instance are added (steps 23 through 24). To a procedure division of the method, steps for declaring to receive the view instance as a parameter and returning the self instance as a returning value (steps 26 through 27), steps for creating the self instance (steps 28 through 29), steps for connecting the view instance as the parameter and the self instance (steps 30 through 31), and a step for setting the self instance as the returning value (step 32) are added.

Next, the operation in which the extracting/transforming unit 2200 adds new items to the session class 340 will be explained referring to FIGS. 49 and 50.

Initialization Method

As for contents of the initialization method, steps for creating a self instance, for calling the initialization method of the entity class 350 and connecting an entity instance as a return value and the self instance, and for setting the self instance as the return value are added.

Concretely, LINKAGE SECTION is provided in a data division of the method, and steps for referring to the self instance as the return value are added (steps 18 through 19). Further, WORKING-STORAGE SECTION is provided, and steps for referring to the self instance are added (steps 20 through 21). To a procedure division of the method, a step for declaring to return the self instance as the return value (step 22), steps for creating the self instance (steps 23 through 24), steps for calling the initialization method of the entity class and connecting the entity instance as the return value and the self instance (steps 25 through 26), and a step for setting the self instance as the return value (step 27) are added.

Transaction Checking Method

To the transaction checking method, steps for calling the master record checking method of the entity class 350 and if the checked result is correct, steps for calling a matching and updating method of the entity class 350 are added.

Concretely, WORKING-STORAGE SECTION is provided in a data division of the method, and steps for storing a return value from the master record checking method of the entity class 350 are added (steps 61 through 64). To a procedure division of the method, steps for calling the master record checking method of the entity class 350 (steps 67 through 68), and if the result of the calling is correct, steps for calling the matching and updating method of the entity class 350 (steps 69 through 82) are added.

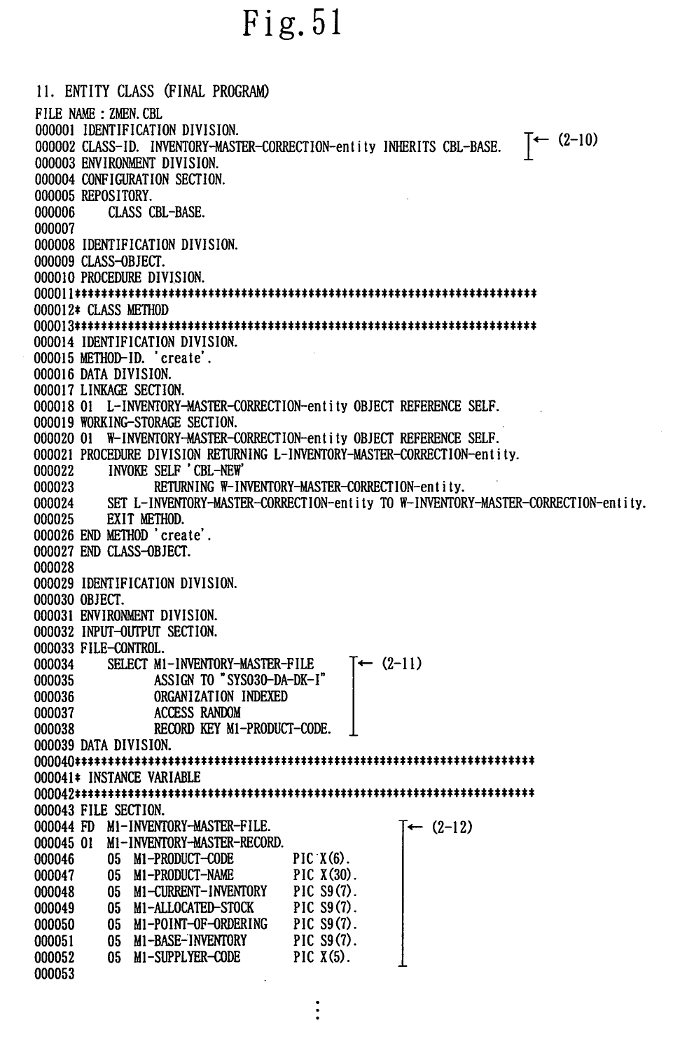

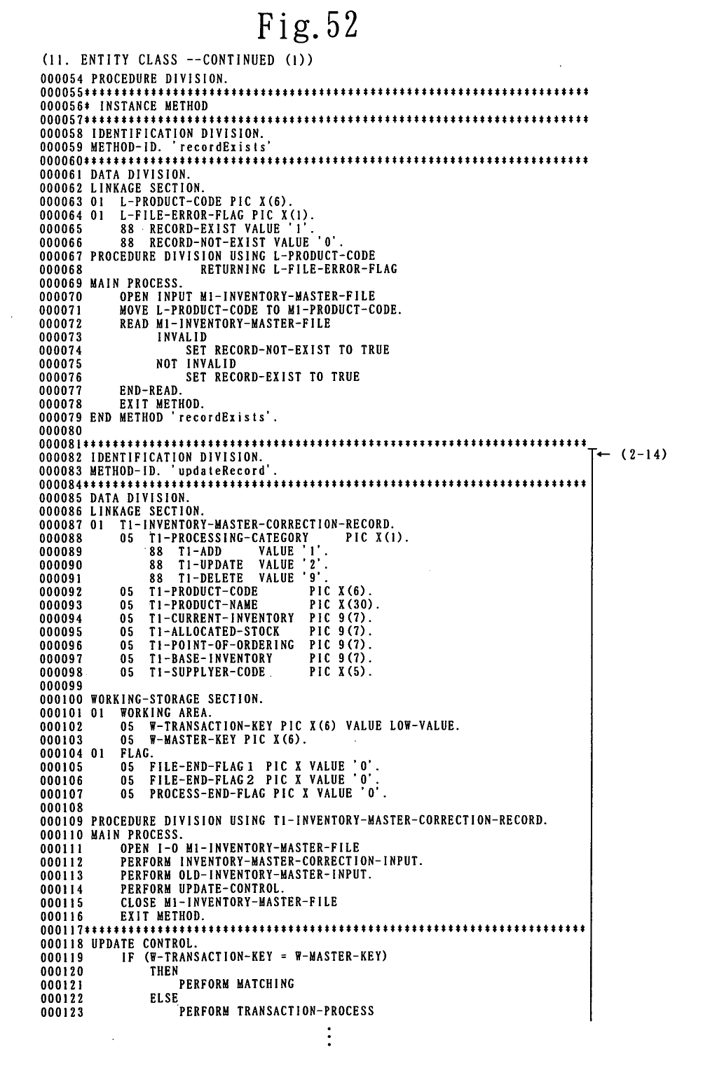

Finally, new items that the extracting/transforming unit 2200 adds new items to the program of the entity class 350 will be explained referring to FIGS. 51 and 52.

Initialization Method

As for the contents of the initialization method, steps for creating a self instance and returning the self instance as a return value are added.

Concretely, LINKAGE SECTION is provided in a data division of the method, and steps for referring to the self instance as the return value are added (steps 17 through 18). Further, WORKING-STORAGE SECTION is provided, and steps for referring to the self instance are added (steps 19 through 20). To a procedure division of the method, a step for declaring to return the self instance as the return value (step 21), steps for generating a self instance (steps 22 through 23), and a step for setting the self instance as the return value (step 24) are added.

Master Record Checking Method

As for the master record checking method, steps for receiving a record key as a parameter, reading the master file using the key, storing the result in a master record flag, and returning the master record flag as the return value are added.

Concretely, LINKAGE SECTION is provided in the data division of the method, and steps for storing the record key as the parameter and storing the master record flag (steps 62 through 66) are added. To a procedure division of the method, steps for receiving the record key as the parameter and declaring to return the master record flag as the return value (steps 67 through 68), steps for preparing to read the master file (steps 70 through 71), and steps for reading the master file and setting the result as the return value (steps 72 through 77) are added.

In this way, by automatically transforming the source code of the intermediate program 200 to the source code of the final program 300, the transformation apparatus B 2000 can create a more object-oriented program. Since the program is transformed into the more object-oriented one, it becomes possible to create a program in which change of the specification inside the object does not affect to the outside, and reuse of the source code can be easily performed. Accordingly, the program resource, which has been created in the past, can be utilized more effectively in the distributed processing.

Further, this method can collaborate with WEB or XML, so that it can be said a more suitable programming structure to the modern society than the intermediate program 200. Consequently, by using the final program 300, which is automatically transformed from the existing program without manpower operation, the existing program can be reused as an application program suitable to the infrastructure of the currently dominant distributed processing.

Embodiment 2.

In the following, the second embodiment will be explained. In the present embodiment, steps for generating the intermediate program 200 are not provided as in the first embodiment, and the source code of the final program 300 is directly extracted/transformed from the source code of the COBOL program 100.

FIG. 54 shows a conceptual drawing of the present embodiment.

In this embodiment, the transformation apparatus C 3000 directly transforms the source code of the COBOL program 100 to the source code of the final program 300. In this way, by directly performing the final program transformation, without steps for generating the intermediate program 200, a program suitable to the distributed processing which can collaborate with WEB or XML, can be easily obtained from the centralized processing program in a short time.

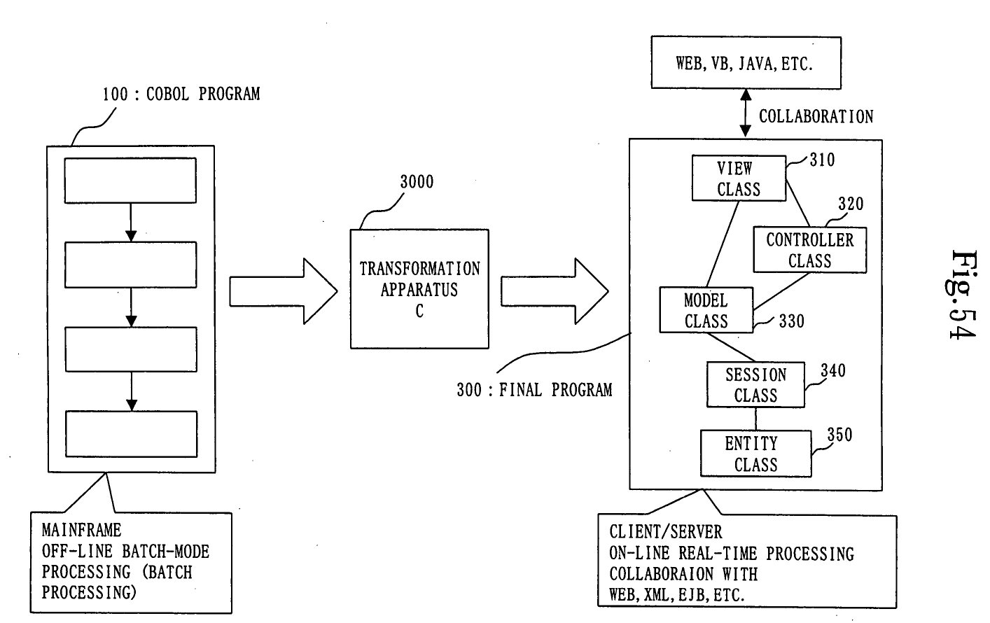

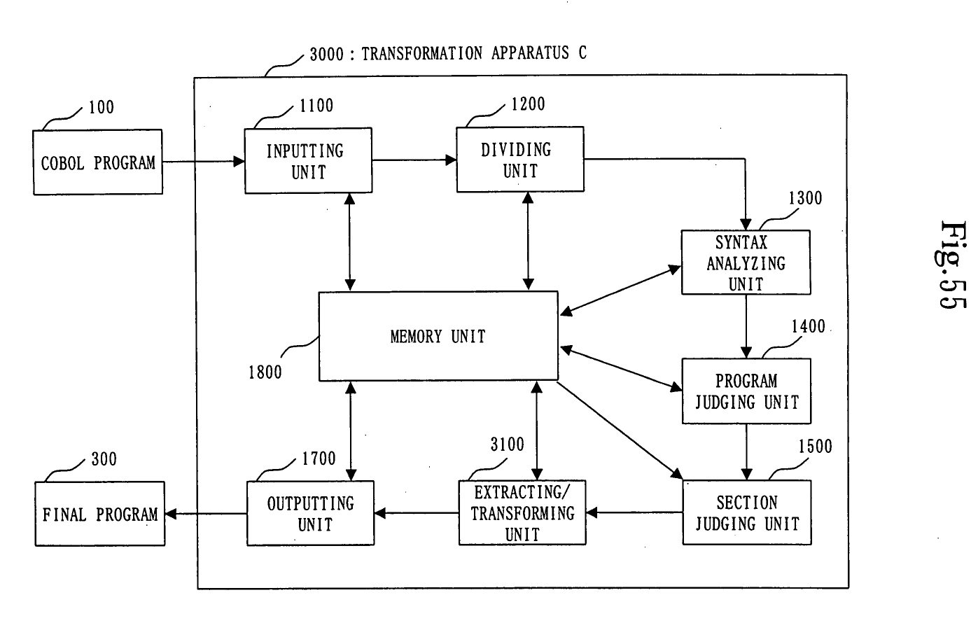

Configuration and operation of the transformation apparatus C 3000 will be explained. FIG. 55 shows an internal configuration of the transformation apparatus C 3000.

Compared with FIG. 4 showing the internal configuration of the transformation apparatus A 1000 of the first embodiment, the internal configuration itself is the same. However, the program output from the outputting unit 1700 is the final program 300, and a part of the operation of the extracting/transforming unit 3100 is different. Namely, while in the transformation apparatus A 1000, the extracting/transforming unit 1600 extracts/transforms the data to create the intermediate program 200, in the extracting/transforming unit 3100 of the present embodiment extracts/transforms the data to create the final program 300.

The inputting unit 1100 inputs the COBOL program 100 and stores in the memory unit 1800. The dividing unit 1200 divides the COBOL program 100 into plural blocks of programs, and the syntax analyzing unit 1300 analyzes the syntax of each of the divided programs. The program judging unit 1400 judges a role of each program, and the section judging unit 1500 judges contents and a role of sections of each program.

After these operations, the extracting/transforming unit 3100 extracts/transforms the data to create the final program 300, and as a result, the created final program 300 is output by the outputting unit 1700. In this case, the memory unit 1800 can be used as a storage area for the data if necessary, and if the final program 3000 does not include the memory unit 1800, the data can be stored in an outside storage device.

Consequently, according to the present embodiment, the final program 300 can be output directly from the COBOL program 100 without outputting the intermediate program 200, so that the transformation process can be performed in a high speed, and it is possible to easily obtain a program suitable to the distributed processing which collaborates with WEB or XML in a short time.

Compared the final program 300 with the intermediate program 200, the functions are the same, but inside the final program 300, the program has become a set of dividable components, and a new program to execute necessary operation can be easily created by adding only differences to the existing components. Accordingly, the program having a higher value as property can be obtained.

Further, the final program 300, the intermediate program 200 can be written using Java (registered trademark) language or C++ language.

In the above embodiments, the transformation program is generated based on the COBOL program; however, the program to be transformed does not always need to be the COBOL program, but it can be a program structured for the batch processing. Accordingly, the structured program can be transformed to the program suitable to the distributed processing by the above-mentioned transformation apparatuses.

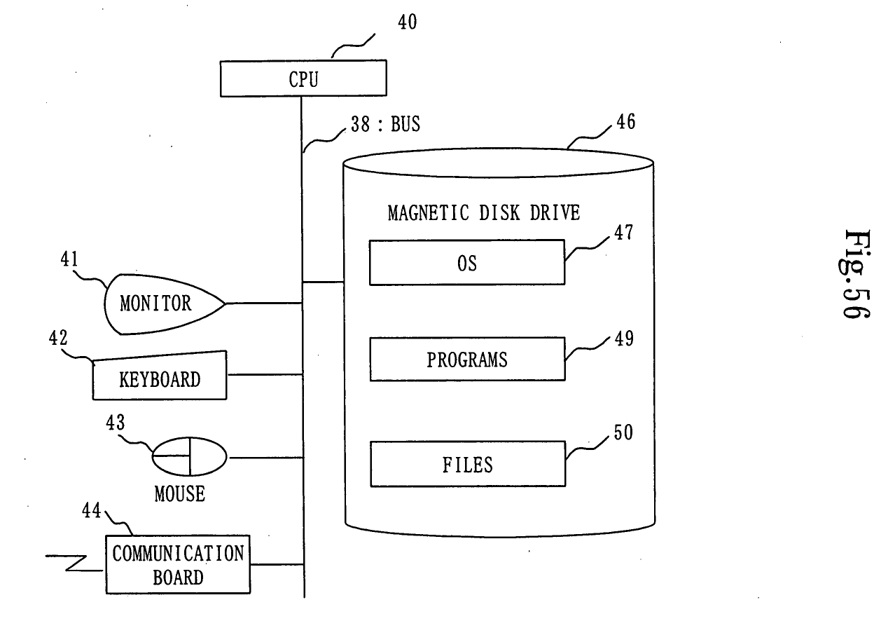

FIG. 56 shows a basic configuration of the computer for the transformation apparatus A, the transformation apparatus B, and the transformation apparatus C.

In FIG. 56, a CPU (Central Processing Unit) 40 which executes a program is connected to a monitor 41, a keyboard 42, a mouse 43, a communication board 44, a magnetic disk drive 46, and so on via a bus 38.

The magnetic disk drive 46 stores an operating system (OS) 47, a group of programs 49, and a group of files 50. However, a group of object-oriented programs 49, which is composed of the group of programs 49 and the group of files 50 as one unit, can be considered a form of one embodiment.

The group of programs 49 is executed by the CPU 40 and the operating system 47.

In each of the above embodiments, the transformation apparatus A, the transformation apparatus B, and the transformation apparatus C perform communication with devices connected through various kinds of networks using functions of the communication board 44.

In the above explanation, the terms such as “store” or “record” mean to store data in the recording medium.

In all of the embodiments, the operations of respective components relate each other, and the operations of respective components can be replaced with a series of operation, considering the relationship among the operations. Further, by such replacement, the embodiment for the transformation apparatus can be replaced by an embodiment for a transformation method.

Further, by replacing the operations of respective components with the processes of respective components, an embodiment for a transformation program can be made.

Further, by recording the transformation program in a computer readable recording medium, an embodiment for a computer readable recording medium storing the transformation program can be made.

All of the embodiments for the transformation program and for the computer readable recording medium storing the transformation program can be structured by a computer executable program.

Further, each process within the embodiment for the transformation program and the embodiment for the computer readable recording medium storing the transformation program is executed by the program. The program is recorded in the storage device, read from the storage device into the Central Processing Unit (CPU), and the operation written in the program is executed by the CPU.

Further, the software or the program discussed in the embodiments can be embodied by firmware recorded in ROM (READ ONLY MEMORY). In another way, each function of the above program can be embodied by a combination of software, firmware, and hardware.

### EXPERIMENTAL EXAMPLE

In the following, an application embodiment of the transformation method when applied to the COBOL program (legacy program) of the batch processing into a practical program will be explained. In this example, the explanation will be done using the same signs for the same or corresponding parts to the ones used in the above embodiments.

In the foregoing embodiments, a method for automatically transforming the COBOL legacy program for the batch processing into a program with a new form, in which the client/server model or Web technique is applied, has been explained. Namely, in the above embodiments, an algorithm for automatically transforming the COBOL program for the batch processing into the object-oriented COBOL program for the on-line real-time processing has been described. This algorithm has been applied to a COBOL program that is actually used in a company and the efficiency of the transformation method has been confirmed at some extent. In the following, the transformation method of the embodiment, the contents of the COBOL program that is used for the experiment, and the experimental result will be explained.

1. Introduction

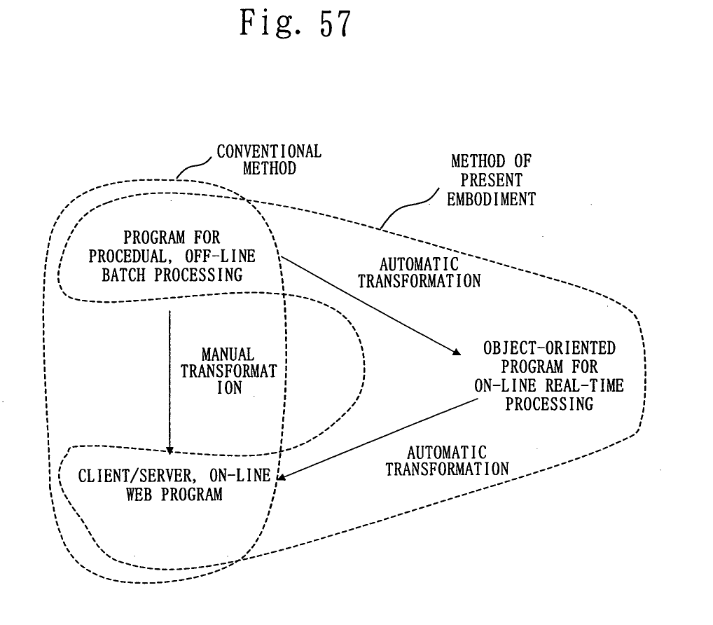

This experiment aims to establish a method for automatically transforming a program of the procedural language for on-line batch processing into an object-oriented program for on-line real-time processing, and further into a Web program that is workable in a client/server environment (FIG. 57).

In this experiment, a method for generating source code of an object-oriented COBOL (OO-COBOL) program having a structure including a client side and a server side, in which the client side is adaptive to MVC (Model, View, Controller) pattern and the server side is adaptive to a transaction processing model of EJB (EnterprizeJavaBeans (trademark)), based on source code of the COBOL program for the batch processing has been implemented.

In this experiment, for discussing transformation strategy and rules, etc., a sample program is cited from references for COBOL system (Hitachi Seisakusho: COBOL 85 Programming, 6190-3-724 (1995)). It has been examined if the transformation method is applicable to a COBOL program that is actually used in a company. This time, one company, System Integrator has offered a chance to experiment. In the following, the algorithm for transformation and the experiment, in which the practical program is used, will be explained.

2. Algorithm for Program Transformation Based on a Sample

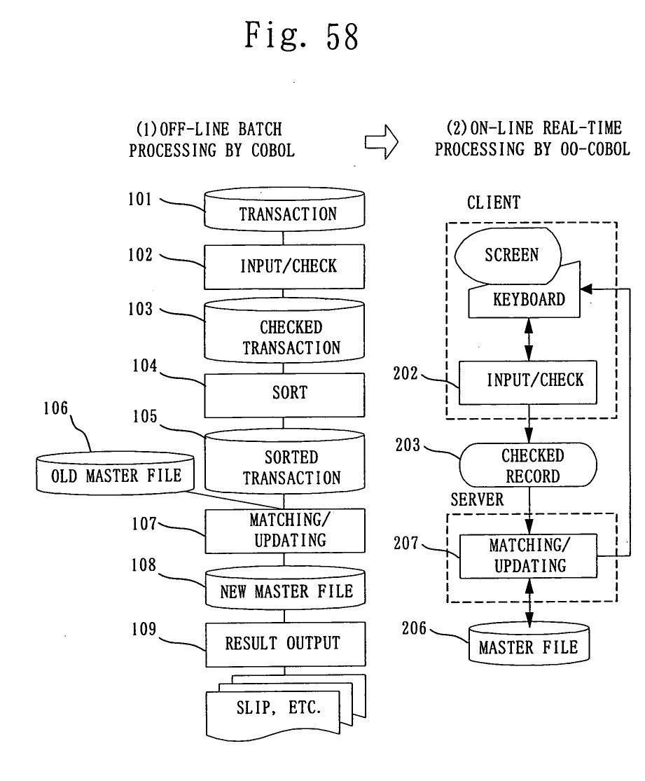

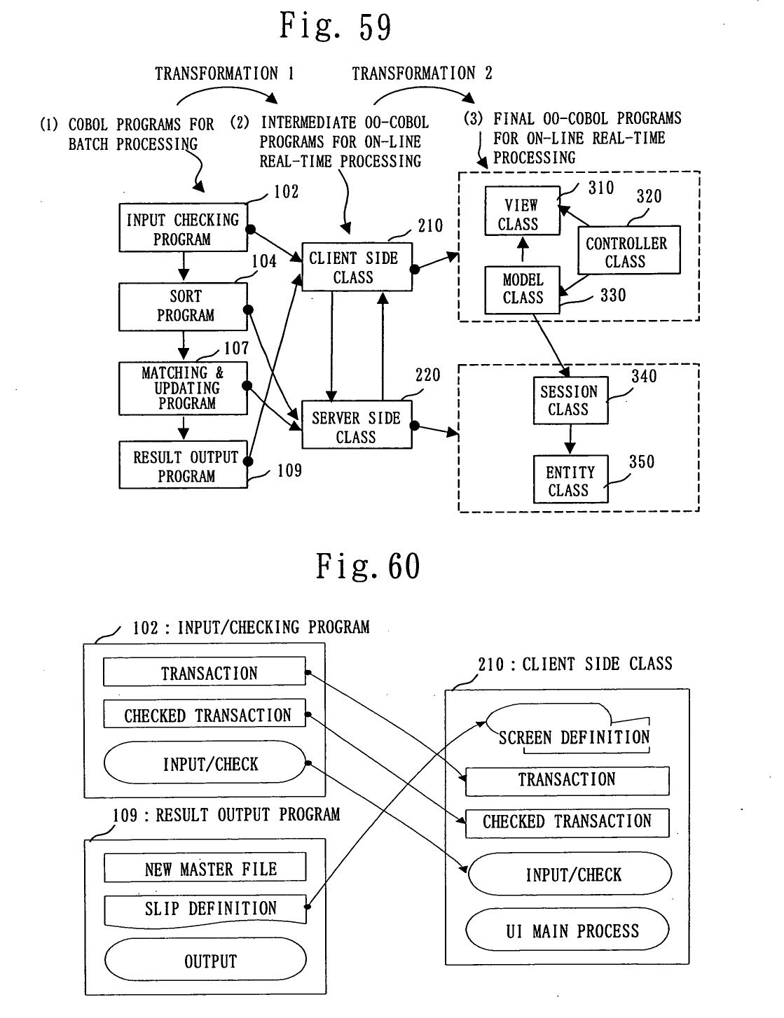

The transformation of the program is performed by two separate stages (FIGS. 58, 59). First, after preprocessing such as meaning assignment is finished, while a flow of the procedure is changed from the batch processing to the on-line real-time processing, the program is transformed into two kinds of class programs 210 and 220 for the client side and the server side (FIG. 58). This transformation program is referred to as Transformation 1 program (or, simply Transformation 1). Further, an environment of hardware and software for performing Transformation 1 program is referred to as the first transformation unit.

Next, the two kinds of class programs 210 and 220 are transformed into three kinds of MVC class programs 310, 320, and 330 in the client side, and into two kinds of class programs 340, 350, which are Session and Entity in the server side. Here, this transformation program is referred to as Transformation 2 program (or, simply Transformation 2). Further, an environment of hardware and software for performing Transformation 2 program is referred to as the second transformation unit. The first transformation unit and the second transformation unit can be implemented by the same computer.

(2-1) Automatic Meaning Assignment to Program by Transformation 1 Program

The meaning assignment means to check out a role of a program or a role of component such as declaration of data, a series of procedure, etc. that is played within a series of processes and to assign a label to show the role to the program or the components in the program.

The meaning assignment is necessary for preparing the following:

(1) To judge the role of the program, the data, or the procedure in order to transform the COBOL program by making a correspondence with the framework.

(2) To detect logic for the batch processing such as loop for transforming the program from the batch processing to the on-line real-time processing.

To each program, a semantic label is previously assigned, and the semantic label is also assigned to the data or the procedure. The meaning assignment becomes a clue for extracting the component in case of transformation.

Since it is not possible to check out the judgment of the role of the program or the data, or the determination of an component for a particular logic only by a pattern of syntax, the semantic assignment compensates for this.

This meaning assignment is implemented by a routine of a preprocessing program; that is, by referring to the definition of the data written in the source code of the program, automatically determining whether it is the definition of the master file or the definition of the transaction file, and automatically assigning the determination result in the source code of the program. The meaning assignment is executed in a front stage in Transformation 1 program.

(2-2) Transformation by Transformation 1 Program

Transformation 1 program transforms the four kinds of COBOL programs 102, 104, 107, and 109 into two kinds of OO-COBOL classes 210 and 220 of the client side and the server side. The client side class 210 has a function of a user interface such as inputting/outputting of the screen and checking the input data. The server side class 220 has a function of matching and updating the transaction.

In the transformation, templates having structures of two classes and skeleton of a necessary method are prepared previously, and information is extracted/transformed from the COBOL program.

a. Creation of the Client Side Class 210

The client side class 210 receives input data from the screen, etc., stores in the transaction record, checks the data, and if the data is correct, the checked data is stored in the checked transaction and transfers to the server side class 220. In order to create an attribute and a method within the class to perform this process, the components are extracted/transformed from the input checking program 102 and the result output program 109 (FIG. 60).

b. Creation of the Server Class 220

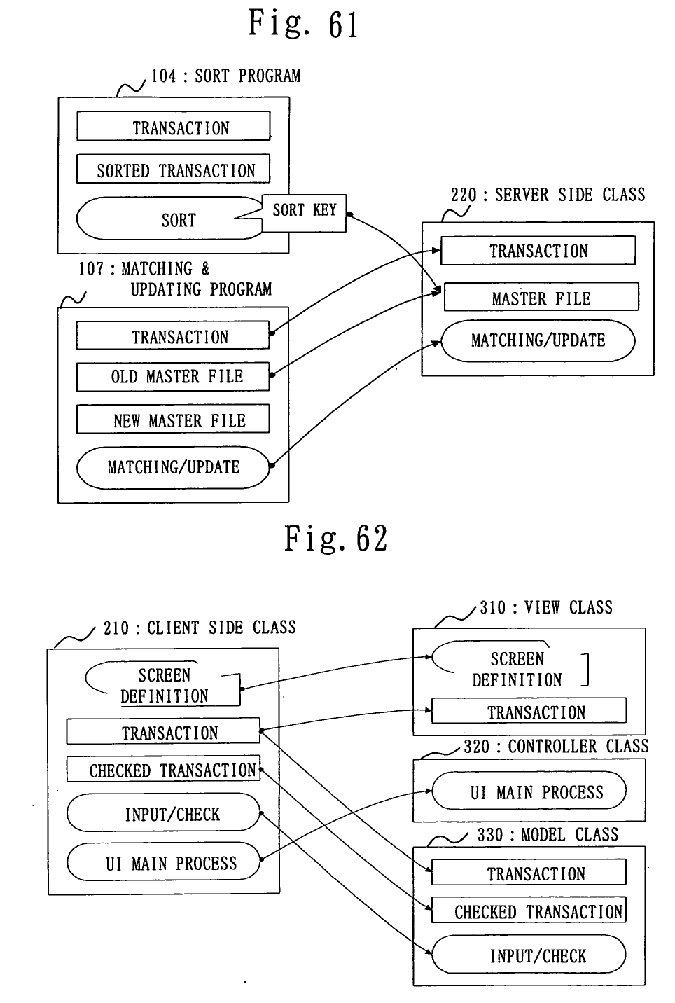

The server side class 220 receives the transaction record from the client side class 210, matches the record with the master record, and if the result is correct, performs a process such as addition, update, or deletion. The components are extracted/transformed from the sort program 104 and the matching and updating program 107 (FIG. 61).

(2-3) Transformation 2 Program

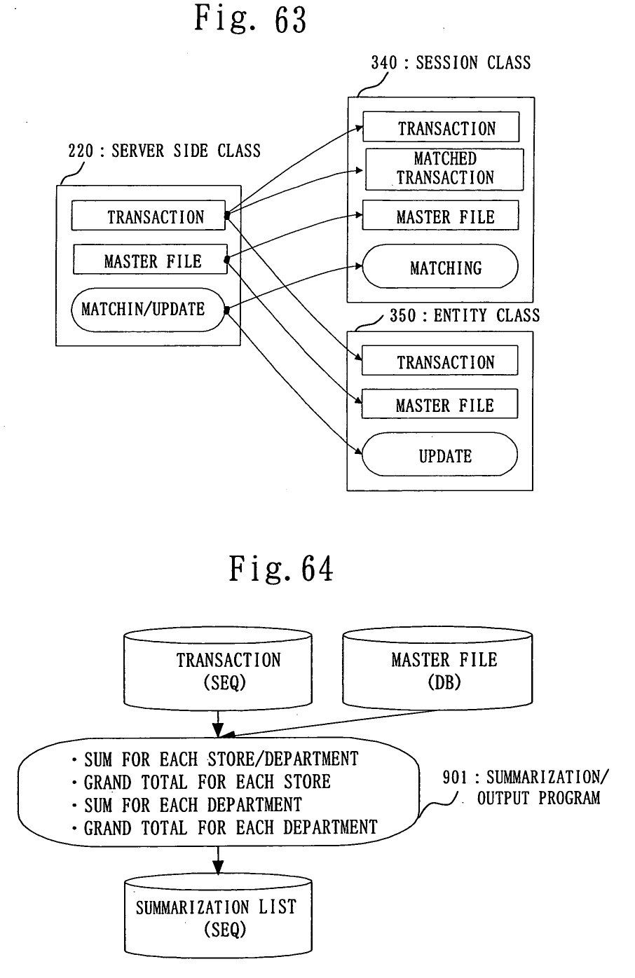

Transformation 2 program separates the client side class 210, which has been created by Transformation 1 program, into three kinds of classes 310, 320, and 330 corresponding to MVC pattern and separates the server side class 220 into two kinds of classes 340 and 350 corresponding EJB model (FIGS. 62 and 63).

As well as Transformation 1 program, Transformation 2 program previously prepares templates having frames for five classes, to which information extracted/transformed from the OO-COBOL classes 210 and 220 by Transformation 1 program are applied.

a. Separation of the Client Side Class 210 to MVC Class

Among the processes performed by the client side class 210, the screen displaying process and the input receiving process are assigned to View class, the checking process is to Model class, and a role to control the two classes is to Controller class (FIG. 62).

b. Separation of the Server Side Class 220 to Session Class 340 and Entity Class 350

Among the processes performed by the server side class 220, the matching process between the transaction record and the master record is assigned to Session class 340, and the updating process such as addition, update, deletion is to Entity class 350 (FIG. 63).

The above-mentioned processes are basic transformation method, which is a basis of the embodiment. An opportunity has been obtained to apply this method to an actual program, which is the COBOL program used in System Integrator, to evaluate. The following “3. Application Experiment to Practical Program” will explain about the experiment.

3. Application Experiment to Practical Program

Features of the input/output and procedures of three jobs having seventeen programs in total are analyzed and found to be separable to the following three types of batch processing.

(type 1) a process to input the transaction, determine a changing point of the keys, and output sum

(type 2) a process to input the transaction, change a form of the record such as addition of a new items, and output

(type 3) a process other than the above two types

Out of the above 17 programs, three typical programs respectively corresponding to the above (1), (2), and (3) are extracted. In the following, the strategy of the experiment and actual transformation for each program will be explained.

(3-1) Strategy of the Experiment

Purposes and procedures are set as follows:

(1) Purposes of the experiment

It is verified if the transformation algorithm can be applied to a practical program. Namely,

(Verification purpose 1): It is checked if a role of data within the program can be determined from the naming rule.

(Verification purpose 2): It is checked if a role of each component can be derived/determined from the calling relationship among sections and paragraphs in the procedure.

(Verification purpose 3): It is checked if it is possible to perform manipulations on components such as a manipulation to move definition of data, a manipulation to delete loop logic for repetition.

It should be verified if the above premises are applicable to the practical programs through trial transformation.

(2) Procedures of the experiment

a. Determination of the Strategy of the Experiment

It is discussed what kind of OO-COBOL program would be the final program as a result of the transformation. The strategy of the transformation is determined as for:

<1> change of input/output of data;

<2> change of procedure from batch processing to on-line real-time processing; and

<3> introduction of a new file, which combines pieces of data of the original program, if necessary.

b. Program Coding After the Transformation

According to the strategy decided, the transformed OO-COBOL program is manually written.

c. Analysis of the Transformation Rules

The rules for transforming the components within the original program are examined by comparing the original program and the transformed program written by the above “b. Program coding after the transformation.”

The above operation: “a. Determination of the strategy of the experiment,” “b. Program coding after the transformation,” and “c. Analysis of the transformation rules” are performed to create Transformation 1 program and Transformation 2 program, and it is not necessary to perform these operations once Transformation 1 program and Transformation 2 program have been created. However, the above “a. Determination of the strategy of the experiment,” “b. Program coding after the transformation,” and “c. Analysis of the transformation rules” are respectively performed for three batch processing programs, and as a result, for each of the batch processing programs, three kinds of Transformation 1 programs and Transformation 2 programs are created. Once three kinds of Transformation 1 programs and Transformation 2 programs have been created, by performing Transformation 1 program with input data of source code of a procedural program for performing centralized off-line batch processing, which belongs to the same kinds, and with input data of the naming rules of data and the coding rules of procedure, the procedural program can be automatically transformed into on-line real-time object-oriented program, and further by performing Transformation 2 program, it is automatically transformed into Web program that works in the client/server environment.

The most complicated manipulation is performed in Transformation 1 program. Transformation 1 program is a stage for changing the input/output of the original program and converting the procedure from batch processing to the on-line real-time processing. Here, details of the stage of Transformation 1 will be discussed.

(3-2) Change to On-line Real-time Processing

According to features of data and procedure, the following three batch processing programs are extracted.

(1) the first batch processing: “summarization/output program 901”

(2) the second batch processing: “record format change program 902”

(3) the third batch processing: “output data indication program 903”

The extracted three batch processing programs are transformed into on-line real-time processing as follows and used as one method. In the following,

a. contents of the current processing;

b. contents of the processing after transformation;

c. transformation of the procedures; and

d. transformation rules based on the above

will be described for each program of the three batch processing programs.

(1) The first batch processing: “summarization/output program 901”

a. Contents of the Current Processing

The transactions are sequentially read from the file, and if a department or a store is changed (if there is a break), batch processing is performed by computing/outputting subtotals and totals (FIG. 64). At this time, text information is obtained from the master DB and printed.

b. Contents of the Processing After Transformation

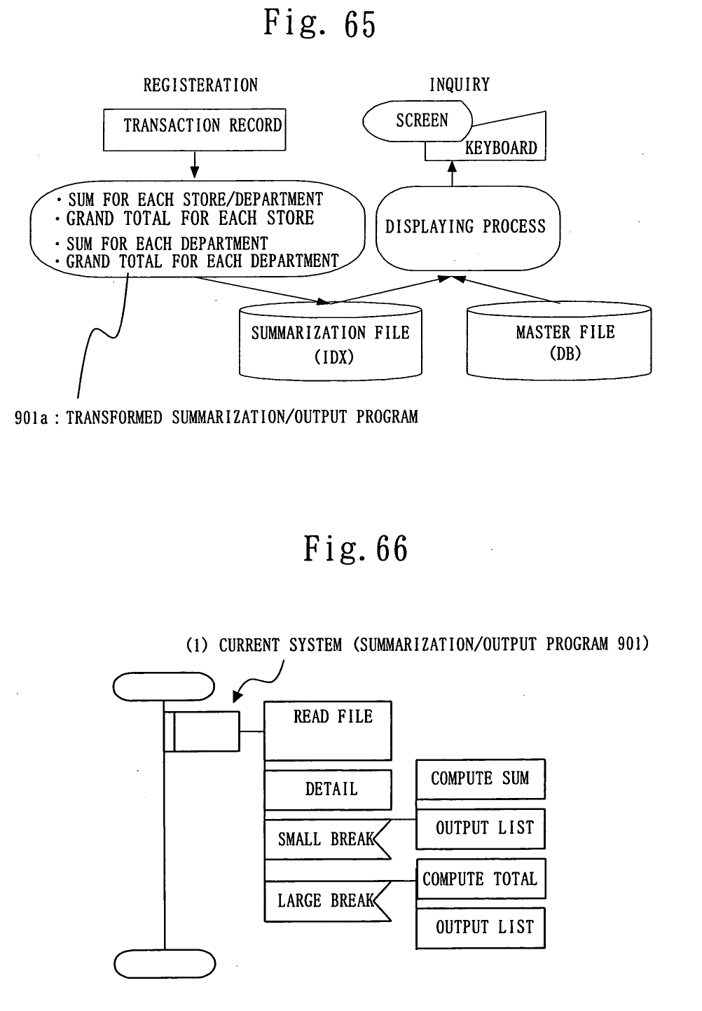

The transaction is received individually as a record, and subtotals and totals are computed individually as needed. The computing result is accumulated in a summarization file (index organization) to be newly created. In case of reference, data is output from this summarization file (FIG. 65).

c. Transformation of the Procedures

A flow of procedures for the current batch processing is as follows (FIG. 66).

<1> from the transaction file, one record is read;

<2> numeral values in detailed items are added to each subtotal;

<3> in case of a small break, the total of the subtotals is computed and output with each subtotal;

<4> in case of a large break, a grand total is computed and output with each total; and

<5> the above process is repeated until the transaction file ends.

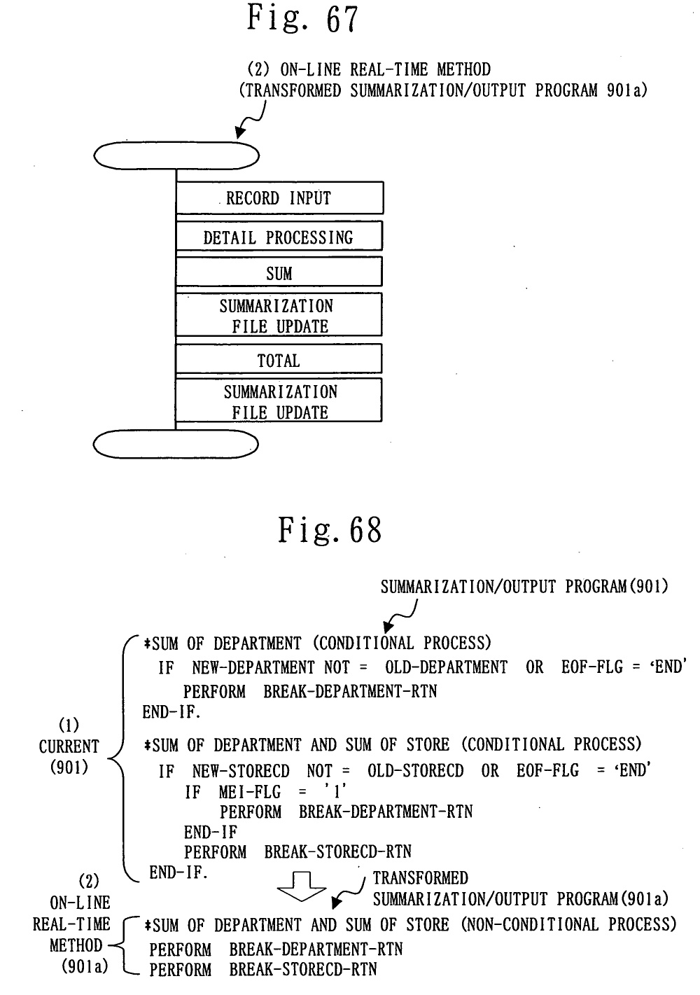

This procedure is transformed into the following flow of the on-line real-time processing according to the strategy of “b. Contents of the processing after transformation” (FIG. 67).

<1> one record is input as a parameter;

<2> numeral values in detailed items are added to each subtotal;

<3> the total of the subtotals are computed and a subtotal record in the summarization file is updated; and

<4> the grand total is computed and a total record in the summarization file is updated.

d. Analysis of Transformation Rules

The following changes are performed on the program.

<1> the loop instruction for repeating a series of the procedures is deleted;

<2> the definition of the transaction record is moved to a linkage section in the data division for making it a parameter;

<3> the check of the breaks is removed and the process for the break is to be performed every time (FIG. 68); namely, the check of change (the check of break) of department or store using IF-clause is deleted and PERFORM statement for computing the subtotal/total of each of the transaction record is performed unconditionally; and

<4> the part for the list outputting is changed to reading the corresponding record of the summarization file, sum-up the additional items, and file updating.

(2) The Second Batch Processing: “Record Format Change Program 902”

a. Contents of the Current Processing

The transaction is read sequentially from the file, and the batch processing is performed by changing into another record format and writing to the file.

b. Contents of the Processing After Transformation

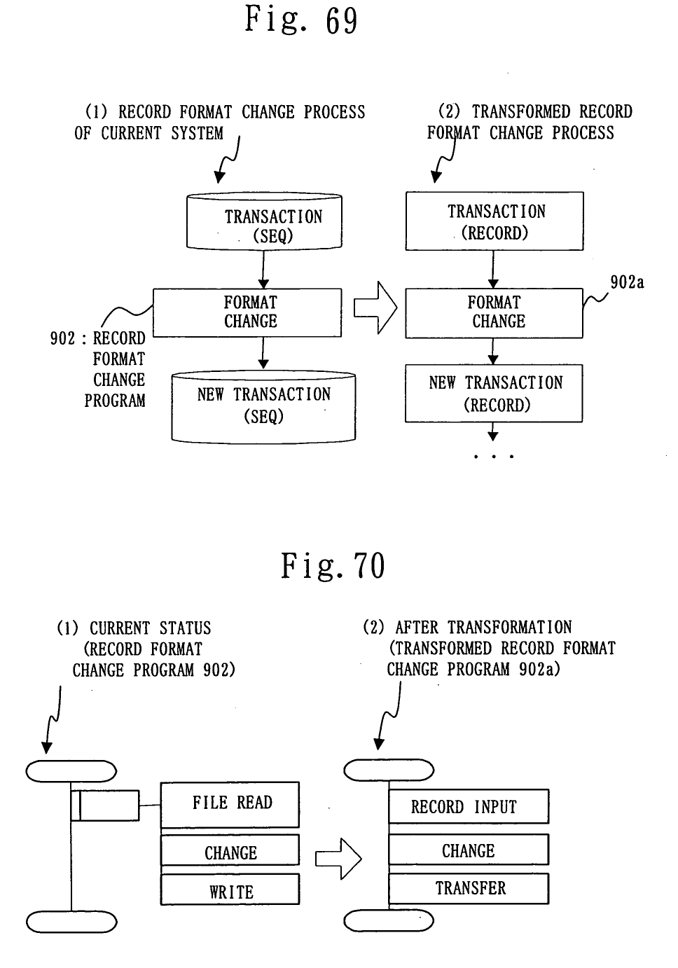

The transaction is received individually with a record format, changed into another record format, and transferred to a next processing as a parameter (FIG. 69).

c. Transformation of the Procedures

A flow of the procedures of the current batch processing is as follows (“(1) Current status” in FIG. 70):

<1> one record is read from the transaction file;

<2> a value of each item of the record is moved to a new record;

<3> the new record is written in a new file; and

<4> the above process is repeated until the transaction file ends.

This procedure is transformed into the following flow of the on-line real-time processing according to the strategy of “b. Contents of the processing after transformation” (“(2) After Transformation” in FIG. 70).

<1> one record is input as a parameter;

<2> a value of each item of the record is moved to a new record; and

<3> the new record is transferred as a parameter of the method for performing a next process.

d. Analysis of Transformation Rules

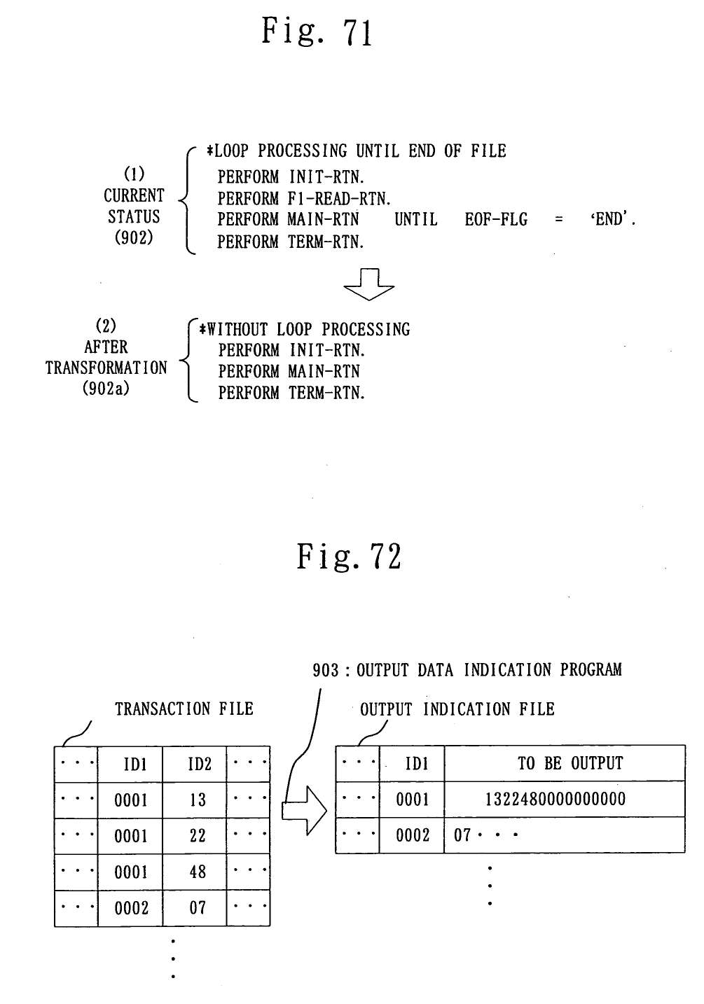

The following transformation is made on the program:

<1> the loop instruction for repeating a series of the procedures is removed (FIG. 71); namely, the loop processing by UNTIL-clause is deleted and only PERFORM statement is left;

<2> the definition of the transaction record is moved to the linkage section of the data division for making it as a parameter; and

<3> a part for writing the new record is changed to a calling for the method for performing the next process.

(3) The Third Batch Processing: “Output Data Indication Program 903”

<1>. Contents of the current processing

The transaction is read sequentially from the file, and the batch processing is performed by aligning IDs of lower degree that belong to the same ID and writing as output data assigned (FIG. 72).

<2>. Contents of the Processing After Transformation

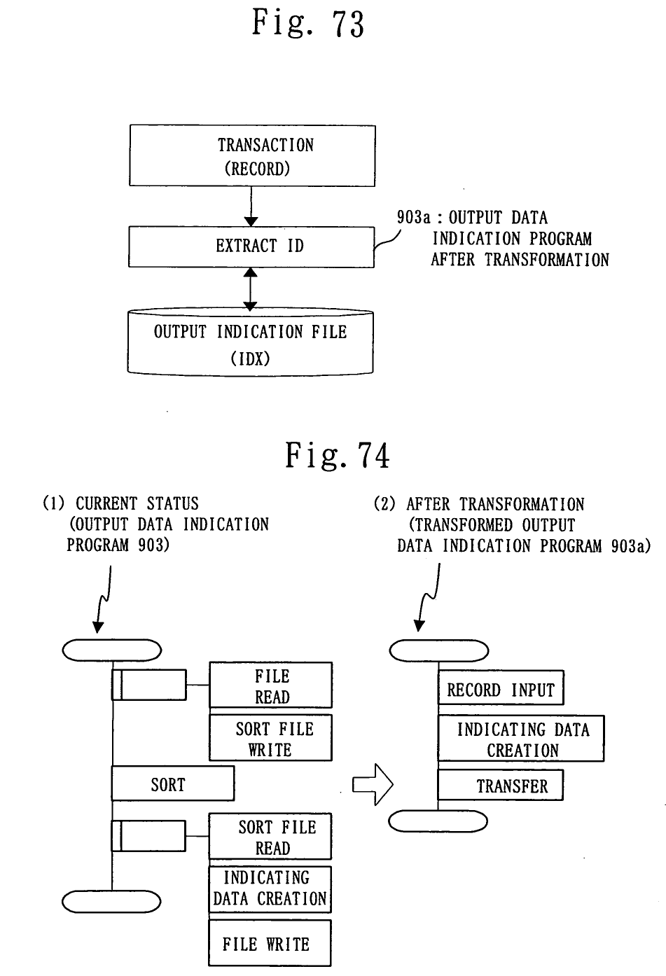

The transaction is received individually with a record format. The output data is stored in an index file which is updated for each transaction as needed (FIG. 73).

<3>. Transformation of the Procedures

A flow of the procedures of the current batch processing is as follows (“(1) Current status” in FIG. 74):

<1> one record is read from the transaction file;

<2> the record is written in a sort file;

<3> after all records have been written, a sort operation is performed;

<4> one record is read from the sort file;

<5> assigning data is moved in an array structure within the output record;

<6> output record is written; and

<7> the above process is repeated until the file is finished.

This procedure is transformed into the following flow of the on-line real-time processing according to the strategy of “b. Contents of the processing after transformation” (“(2) After Transformation” in FIG. 74).

<1> one record is input as a parameter;

<2> the assigning data is moved in the array structure within the output record; and

<3> in the output indication file, the corresponding record is updated.

d. Analysis of Transformation

The following transformation is made on the program.

<1> the definition of the sorting record is moved to the linkage section of the data division for making it as a parameter;

<2> from the sorting instructions, the calling instructions for the preprocessing of the sort and the post processing of the sort are extracted, they are replaced with calling by PERFORM statement, and the instructions concerning the sort is deleted;

<3> a part for writing the output record is replaced with updating the file of the output data assignment file.

As described, the strategy of the transformation based on the present transformation method is determined and the transformation of the procedures and determination of the transformation rules are performed.

(3-3) Separation to Client/Server (C/S) Classes

Among products, which is a form of the method 901a for the on-line real-time processing transformed from the program 901 for the batch processing, a part for changing the contents of the data by computing and moving is separated as the client side class 210, and a part for reading/writing the final result from/in the file is separated as the server side class 220 (transformation from FIG. 67 to FIG. 75). Based on the result of transformation to the on-line real-time method, separation to the client/server (C/S) classes is performed automatically. Logic for reading/writing of the server side class 220 is new, and a class for the C/S is created by allotting data name, etc to the template.

(3-4) Separation From the C/S class into Five Classes

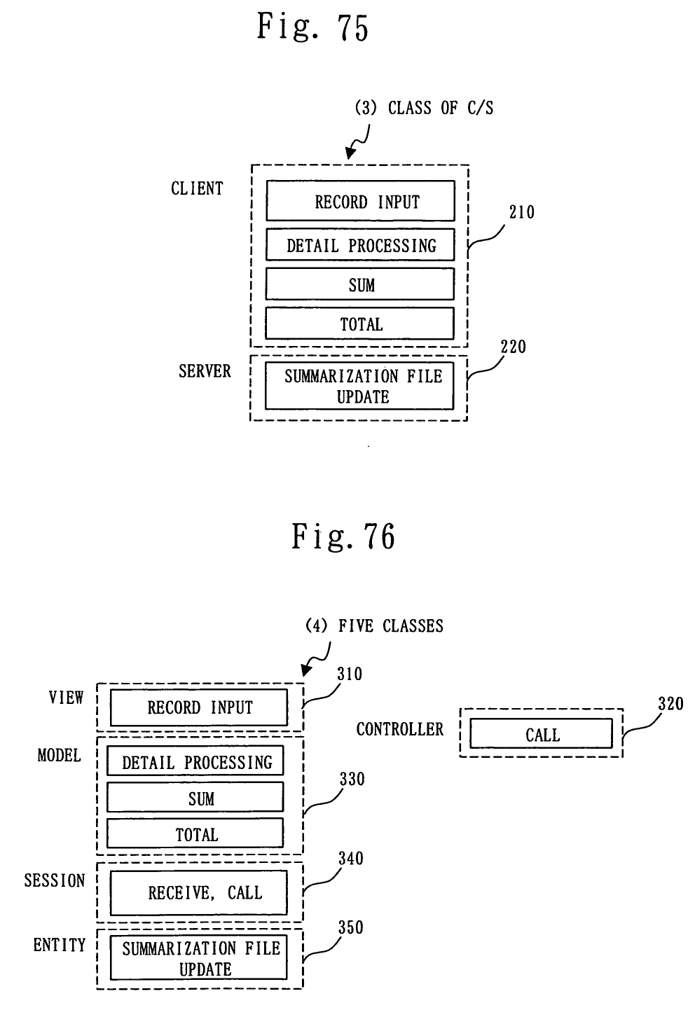

Most of the logics in the client side class 210 is included in the Module class 330, and the logic in the server side class 220 is included in the Entity class 350. The other classes transfers data without change or performs calling control for the method (transformation from FIG. 75 to FIG. 76). As well as the separation to the C/S classes, the five classes 310, 320, 330, 340, and 350 are created automatically. The use of the template at the time of the creation of the five classes is the same as the creation of the C/S classes.

4. Consideration

a. Practicability of the Algorithm

It has been verified that the present transformation method can be applied to the practical program, and that the followings which are described as purposes of the experiment can be performed:

(Verification purpose 1): determination of the role of the data within the program;

(Verification purpose 2): derivation/determination of the role of each component from the calling relationship of procedures and sections in the procedure; and

(Verification purpose 3): manipulation on components within the program. In many cases, a company does programming by setting the coding rules, so that these algorithms are applicable to a plurality of programs of the same kind.

On the other hand, the present transformation method has a problem that it is necessary to examine the strategy of the transformation by human power before the transformation, which takes an additional step and time.

b. Quantitative Change by the Transformation

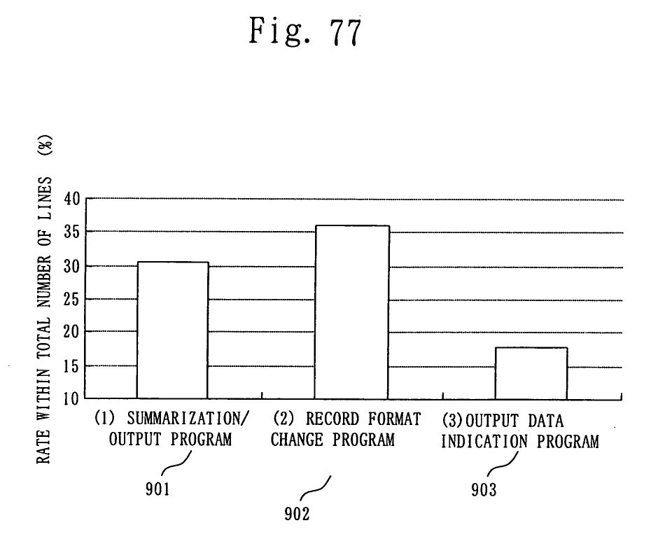

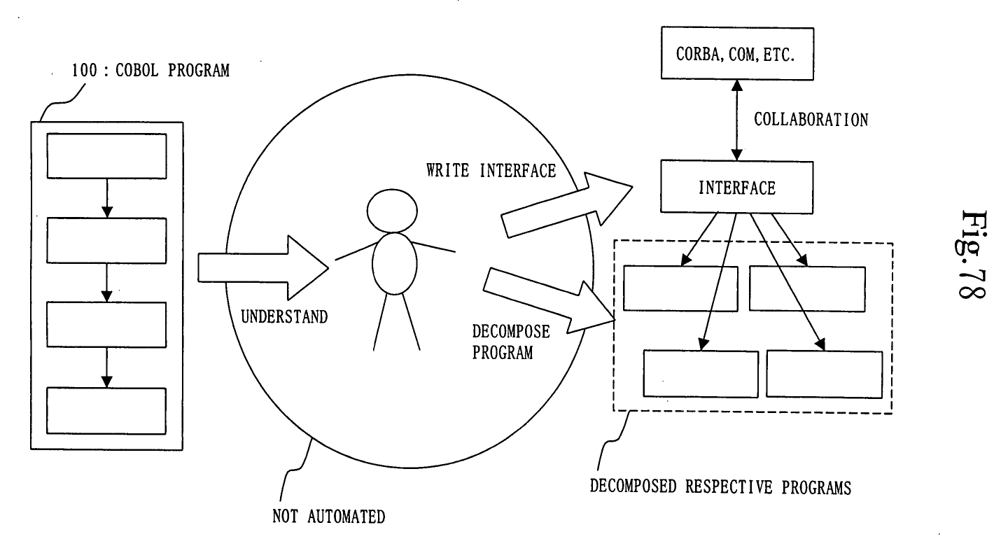

In the transformation process, the stage of changing the program for the batch processing into a form of the method for the on-line real-time processing changes the contents of the original program the most drastically. FIG. 77 shows a rate of the number of lines that are changed at this stage within the program. The reason why the rate of the change of the format change program is large is that the record having a lot of items is moved, while the processing is simple and the number of lines is small.

Further, after transforming the source code of the original program into the C/S classes, the number of lines of the source code of the program becomes about 1.4 times of the original program, and the number of lines of the source code of the final program with the five classes becomes 1.6 times of the original program.

### 5. CONCLUSION

As has been discussed, in the experimental example, it is proved that the transformation aiming the reuse of legacy program is applicable to the practices.

### INDUSTRIAL APPLICABILITY

According to the embodiment of the present invention, it is possible to transform the existing program resources into program resources adaptive to the distributed system.

Further, according to the embodiment of the present invention, it is possible to reuse business logic within the program, which has been conventionally coded.

Further, according to the embodiment of the present invention, it is possible to use the existing program resources to construct a new system.

Further, according to the embodiment of the present invention, it is possible to transform the existing program resources directly into the final program without transforming the intermediate program.

1. A transformation apparatus comprising:
a memory unit for storing a program for batch processing in a form of source code;
a section judging unit for dividing the source code of the program stored in the memory unit into at least one block of process, each block of process being identified as a section, and judging a role of the section as semantic information of each section; and
an extracting/transforming unit for extracting transformation information for source code transformation from the source code of the program stored in the memory unit based on the semantic information of each section judged by the section judging unit, and transforming the source code of the program into source code of a transformation result program including the source code of a transformation result program for a client and the source code of the transformation result program for a server based on the transformation information extracted.

2. The transformation apparatus of claim 1, wherein the extracting/transforming unit transforms the source codes of the two transformation result programs into source codes of an object-oriented program.

3. The transformation apparatus of claim 2, wherein the extracting/transforming unit creates plural templates of the object-oriented program, which correspond to plural classes having a predetermined data structure and procedure, extracts plural pieces of information including the predetermined data structure and procedure from the source codes of the two transformation result programs, and transforms the source codes of the two transformation result programs into the source codes of plural object-oriented programs by applying each of the plural pieces of information extracted to a corresponding part of the plural templates.

4. A transformation apparatus comprising:
a memory unit for storing a program for batch processing in a form of source code;
a section judging unit for dividing the source code of the program stored in the memory unit into at least one block of process, each block of process being identified as a section, and judging a role of each section as semantic information of each section, and
wherein the transformation apparatus creates plural templates of object-oriented programs, which correspond to plural classes, each of which having a predetermined data structure and procedure, extracts plural pieces information including the predetermined data structure and procedure from the source code of the program for batch processing stored in the memory unit based on the semantic information of each section judged by the section judging unit, and transforms the source code of the program stored in the memory unit by applying each of the plural pieces of information extracted to a corresponding part of the plural templates.

5. The transformation apparatus of claim 1 further comprising a program judging unit for judging a role of the source code of the program stored in the memory unit as semantic information of the program, and
wherein the extracting/transforming unit extracts transformation information for transforming the source code of the program from the source code of the program based on the semantic information of the program judged by the program judging unit and the semantic information of each section judged by the section judging unit.

6. The transformation apparatus of claim 1 further comprising a syntax analyzing unit for analyzing syntax of the program stored in the memory unit, and
wherein the section judging unit judges the semantic information of each section included in the program, the syntax of which is analyzed by the syntax analyzing unit.

7. The transformation apparatus of claim 1 transforms source code of a COBOL program for batch processing.

8. A transformation method comprising:
storing a program for batch processing in a form of source code;
dividing the source code of the program stored into at least one block of process, each block of process being identified as a section, and judging a role of each section as semantic information of each section; and
extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

9. A transformation program having a computer perform processes of:
storing a program for batch processing in a form of source code;
dividing the source code of the program stored into at least one block of process, each block of process being identified as a section, and judging a role of each section as semantic information of each section; and
extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

10. A computer readable recording medium storing a transformation program having a computer perform processes of:
storing a program for batch processing in a form of source code;
dividing the source code of the program stored into at least one block of process, each block of process being identified as a section, and judging a role of each section as semantic information of each section; and
extracting transformation information for source code transformation from the source code of the program stored based on the semantic information of each section judged, and transforming the source code of the program into source code of transformation result program including two source codes of a transformation result program for a client and of a transformation result program for a server based on the transformation information extracted.

11. A transformation apparatus comprising:
a first transformation unit for inputting program source code of a procedural off-line batch processing and transforming the program source code into a program for on-line real-time processing; and
a second transformation unit for further transforming the program for on-line real-time processing into a Web program which works in client/server environment.

12. The transformation apparatus of claim 11, wherein:
the first transformation unit inputs the program source code for the off-line batch processing, naming rules of data, and coding rules of procedures and transforms the program source code into two kinds of class programs including a client side class and a server side class for the on-line real-time processing; and
the second transformation unit inputs the two kinds of class programs and generates source program of an object-oriented program.

13. The transformation apparatus of claim 12, wherein the second transformation unit transforms the client side class into three kinds of class programs including a model class, a view class, and a controller class and transforms the server side class into two kinds of class programs including a session class and an entity class.

14. The transformation apparatus of claim 12, wherein the first transformation unit includes preprocessing of meaning assignment for referring to definition of data in the source code of the program, judging definition of a master file and definition of a transaction file, detecting a role of the program and roles of components of the program among a series of processes, and appending labels which show the roles of the program and the roles of the components of the program among a series of processes.

15. The transformation apparatus of claim 12, wherein
the first transformation unit executes a transformation 1 program, the second transformation unit executes a transformation 2 program,
the programs for the off-line batch processing is classified to plural categories,
the transformation 1 program and the transformation 2 program are generated corresponding to each of the plural categories of the program for the off-line batch processing, and
the first transformation unit and the second transformation unit respectively execute the transformation 1 program and the transformation 2 program generated corresponding to the each of the plural categories of the program for the off-line batch processing.

16. A transformation method comprising:
inputting program source code of a procedural off-line batch processing;
transforming the program source code into a program for on-line real-time processing; and
transforming the program for on-line real-time processing into a Web program which works in client/server environment.
